(19) United States
(12) Patent Application Publication
(10) Pub. No.: US 2022/0230125 A1
(43) Pub. Date: Jul. 21, 2022

(54) SYSTEM AND METHOD FOR OPTIMIZING MANAGEMENT OF MACHINE ASSET MAINTENANCE AND PRODUCTION OPERATIONS

(71) Applicant: TRACKIT SOLUTIONS FZ LLC, DUBAI (AE)

(72) Inventors: SOMASEKHAR VEDANTAM, DUBAI (AE); HUSAIN BADRUDDIN RAGIB, DUBAI (AE); SANDEEP VEDANTAM, DUBAI (AE); HEMVATI NANDAN PANDEY, HYDERABAD (IN)

(21) Appl. No.: 17/151,533

(22) Filed: Jan. 18, 2021

(51) Int. Cl. G06Q 10/06; G06Q 10/00; G06N 20/00

(52) U.S. Cl. CPC G06Q 10/063114; G06N 20/00; G06Q 10/20

(57) ABSTRACT

A system including an operations management engine (OME) and a method for optimizing management of maintenance and/or production operations performed on a machine asset, are provided. The OME receives work scope information (WSI) including parts information of the machine asset in a work order from multiple data sources. The OME generates a reusable tag linked to an order identifier for each part and assigns the reusable tag to each part. The OME, in communication with one or more tag readers, dynamically tracks each part, tasks performed thereon, and turnaround time through each stage of a cycle of operations in real time using the corresponding reusable tag and the WSI, and generates operational data therefrom. The OME dynamically generates one or more analytics reports accessible through one or more visualization components across the cycle to convey predictable and actionable insights of analytics performed on the operational data using artificial intelligence.

### BACKGROUND

### Technical Field

The embodiments herein, in general, relate to managing operations of machine assets, for example, aircrafts, aircraft engines, and associated parts and components. More particularly, the embodiments herein relate to optimizing management of operations associated with maintenance and/or production of a machine asset.

### Description of the Related Art

Maintenance and production of commercial vehicles, for example, aircrafts, require the coordination of multiple service providers, data providers, parts suppliers, and vendors. Operations associated with maintenance and production of machine assets, for example, aircrafts, aircraft engines, and associated parts and components, require up-to-date original equipment manufacturer (OEM) manuals, maintenance repair records, specialized equipment, parts, and a plethora of other resources, as well as optimal integration between data, systems, personnel, and processes. The logistics involved in deploying, warehousing, and maintaining and managing movement of inventories of repair parts at multiple service locations increases complexity in operations management, since parts must be procured from multiple suppliers and original equipment manufacturers (OEMs).

Operators of vehicle fleets typically perform maintenance either at their own maintenance facilities or by outsourcing their maintenance requirements to maintenance, repair, and overhaul (MRO) service providers. Due to unpredictability of customer demand and the complexity of machine assets, MRO service providers face several challenges in aligning operational efficiency with changing job requirements. Most often, MRO providers are unaware of the exact scope and specific requirements of each job including the necessary equipment, spare parts, materials, etc., until a given machine asset is disassembled and exit configuration is finalized based on unscheduled removals and scope changes. There is a need for increasing availability and visibility of meaningful and reliable workflow information associated with maintenance and production of machine assets and their movement and management in real time. To provide fast, reliable, and customized service to customers, while ensuring ongoing productivity and profitability, there is a need to equip MRO service providers with efficient MRO setups to operate efficiently and allocate resources and inventory to reduce operational costs effectively. An MRO setup is a capital-intensive setup in an aftermarket value chain. Maintenance and production operations are typically disrupted due to the increasing complexity of machine assets and the influx of OEMs in the aftermarket business. In the aircraft industry, for example, airline fleet sizes continue to grow and are projected to substantially increase the engine service load while more and more airlines are deliberating upon their core flying business rather than MRO operations, thereby creating a significant MRO capacity crunch. There is a need for MRO service providers to improve capacity utilization and aggregate part movement, identify and address revenue leakages, forecast operational efficiency and profitability targets, increase person-hour savings on tasks and parts movement, improve operating margins based, on average turnaround times, and plan with shorter maintenance and production turnaround times.

Moreover, there is a need for comprehensive operations management comprising work scope planning, work scope definition, tracking of work orders, task orders, repair orders, etc., tagging of parts, proactive reporting, scheduling, inbound and outbound inventory management, resource management, shop-wise monitoring, developing coherence in complex shop floor operations, quantification of delays, snags, and issues that impact ineffective turnaround and cause possible revenue and profitability leakages, etc., while forecasting work scope and engine performance post maintenance using artificial intelligence-based algorithms and factors affecting performance. Furthermore, there is a need for a digital, MRO and production operations management system that captures end-to-end part travel during maintenance and production operations and utilizes artificial intelligence, deep learning, and data sciences to provide a complete top-down and bottom-up view of MRO organizational throughput.

Hence, there is a long-felt need for a system and a method for optimizing management of operations associated with maintenance and/or production of a machine asset, while addressing the above-recited needs.

### SUMMARY

This summary is provided to introduce a selection of concepts in a simplified form that are further disclosed in the detailed description. This summary is not intended to determine the scope of the claimed subject matter.

The embodiments disclosed herein address the above-recited needs for a system and a method for optimizing management of operations associated with maintenance and/or production of a machine asset. The machine asset refers, for example, to an aircraft or an aircraft engine, landing gear, an auxiliary power unit, wheels, brakes, components, etc. In an embodiment, the system disclosed herein is implemented as a digital maintenance, repair, and overhaul (MRO) and production operations management system that captures end-to-end part travel during maintenance and production operations and executes artificial intelligence and deep learning algorithms with the implementation of data sciences to provide a complete top-down and bottom-up view of MRO organizational throughput. The system and the method disclosed herein address present and foreseen future challenges towards MRO efficiency, productivity, and utilization. The system and the method disclosed herein capture planned versus actual turnaround times and provide detailed, predictable and actionable insights and forecasts regarding operational aspects by providing a comprehensive view of the operations and efficiency for proactive management. Through various application programming interfaces (APIs), the system and the method disclosed herein capture and track parts, tasks, and activities in the MRO value chain, and process the data hence captured at multiple levels using deep learning and data science methodologies. The system and the method disclosed herein facilitate informed decision making for managing inventory, parts ordering, repairs, performance, and efficiency of a facility.

The system disclosed herein comprises a plurality of tag readers and an operations management engine. The tag readers are operable at a plurality of stages defined in a cycle of operations associated with maintenance and/or production of the machine asset. The operations associated with the maintenance of the machine asset comprise, for example, maintenance planning, scheduling, induction, disassembly, cleaning, non-destructive testing, inspection, repair, specialized processing, parts ordering, parts receiving, kitting, re-assembling, testing, and shipping of the machine asset. The operations associated with the production of the machine asset comprise, for example, production planning, parts ordering, parts receiving, kitting, equipping and erection, testing, and shipping of the machine asset. The operations management engine defines computer program instructions executable by at least one processor for optimizing management of operations associated with maintenance and/or production of the machine asset. The operations management engine receives work scope information comprising parts information of one or more of a plurality of parts of the machine asset in a work order from a plurality of data sources. The data sources comprise, for example, original equipment manufacturer (OEM) manuals, templates, checklists, enterprise resource planning (ERP) systems, documentation, and user definitions and configurations entered via graphical user interfaces rendered by the operations management engine on a computing device. Each of the parts is linked to an order identifier of the work order. The operations management engine generates a reusable tag linked to the order identifier for each part defined in the work scope information and assigns the reusable tag to each part. The reusable tag is, for example, a radio-frequency identification (RFID) tag or a wireless beacon tag such as a Bluetooth low energy (BLE) tag, free of the work scope information.

The operations management engine, in communication with one or more of the tag readers, dynamically tracks each part, tasks performed on each part, and turnaround time through each of the stages of the cycle of operations in real time using the corresponding reusable tag linked to the order identifier and the work scope information, and generates operational data therefrom. The operational data comprises, for example, a status of each part, type of tasks and operations performed, time of initiation and completion of the tasks, task execution time, person-hours, part history information, part induction information, part movement information, transactional information, machine asset data, schedules, plans, and audit logs. The operations management engine performs analytics on the operational data associated with each of the parts using artificial intelligence. In an embodiment, in performing the analytics on the operational data associated with each part, the operations management engine calculates shop operational efficiency and shop profitability based on induction type using spend data extracted from a database operably coupled to the operations management engine. In another embodiment, in performing the analytics on the operational data associated with each part, the operations management engine forecasts projections of a plurality of operational elements and generates predictable and actionable insights for each of the operational elements using artificial intelligence. The operational elements comprise, for example: (a) requirements for the parts; (b) productivity savings; (c) completion time; (d) work scope; (e) machine asset performance; and (f) prescriptive cost impact. In another embodiment, in performing the analytics on the operational data associated with each part, the operations management engine forecasts exhaust gas temperature gain for any incoming machine asset.

The operations management engine dynamically generates and renders one or more analytics reports accessible through one or more of a plurality of visualization components across the cycle of operations to convey predictable and actionable insights of the analytics for optimizing the management of the operations with enhanced visibility. The visualization components comprise, for example, real-time dashboards and notifications. One or more of the analytics reports accessible through the visualization components comprise at least one of: (a) parts and tag Mformation by date and user for the machine asset by a machine identifier; (b) a task status summary and estimated dates of completion per assembly, per sub-assembly, and per work order of the machine asset by the machine identifier; (c) transactions on each part by a part identifier; (d) a department-wise summary of transactions and completion of the work order within specified dates; (e) number of person-hours and work orders processed by department within specified dates and specific visits; (f) machine asset status configured to indicate a number of pre-inspection cards tagged compared to pre-inspection cards available by module; (g) machine asset status based on a number of job cards and tasks versus percentage completion by module and by the machine asset; (h) machine asset status based on a pre-inspection card deactivated by module and by the machine asset; (i) ontime processing and delayed processing by period, and by the machine asset; (j) external repair order status and new issues from stores to indicate completion percentage; (k) parts distribution by department and by the machine asset; (l) number of job cards processed and deployed across predefined planned time intervals; (m) yearly maintenance and/or production data and labor hours; and (n) statistical classification of a cumulative person-hour spread task-wise and part-wise.

In an embodiment, the operations management engine, in communication with a client application deployed on a computing device, deactivates the reusable tag of each part indicating a completion of the cycle of operations. In an embodiment, the computing device is a wireless communication-enabled mobile device, for example, an RFID-enabled mobile device, operably coupled to the tag readers. In an embodiment, the operations management engine monitors and renders status of the operations and status of the tag readers to resolve outages, delays, and bottlenecks in the system.

In an embodiment, the operations management engine facilitates transfer of the parts between the stages in the cycle of operations in accordance with a list of the tasks defined in job cards and updates locations of the parts during the transfer between the stages in at least one database operably coupled to the operations management engine. In an embodiment, the operations management engine tracks movement of the plurality of parts comprising incoming parts and outgoing parts in stores and determines requirements and availability of the parts. In an embodiment, the operations management engine determines and renders pending tasks across the cycle of operations; (b) renders a list of parts required for the operations; and (c) systematically renders the work scope information, on a computing device.

In an embodiment, the system disclosed herein further comprises a client application deployed on a computing device and configured to operate with the operations management engine for executing one or more of a plurality of operations management functions. The operations management functions comprise, for example, user authentication, generation and display of a list of tasks, tagging of the parts of the machine asset based on the work order, transfer of the parts between departments, indicating a start and an end of each of the tasks for scanned part tags, kitting verification, deactivation of each reusable tag, and querying of the parts. In this embodiment, the computing device is in operable communication with the tag readers. In another embodiment, the system disclosed herein further comprises a middleware application configured to operate with the operations management engine for executing one or more of a plurality of device management functions. The device management functions comprise, for example, managing the tag readers, managing locations of the tag readers, managing locations of the parts of the machine asset, and monitoring a network status of each of the tag readers.

The system and the method disclosed herein ensure a systematic availability of workflow information for improved control on a work order and process activities, and assists in the development of swift turnaround models by analyzing person-hour and maintenance time analytics for process optimization as well as vendor turnaround and inventory optimization. Moreover, the operations management engine assists in creating actionable business intelligence dashboards for improved decision making, information flow at various levels, and for calculation of a product lifecycle, supply chain reliability, and product reliability. The system and the method disclosed herein, therefore, optimize MRO and production operational costs and working capital while minimizing sunk costs, with minimum disruption to the defined processes and seamless alignment and integration with any existing enterprise resource planning (ERP) system.

In one or more embodiments, related systems comprise circuitry and/or programming for executing the methods disclosed herein. The circuitry and/or programming are any combination of hardware, software, andior firmware configured to execute the methods disclosed herein depending upon the design choices of a system designer. In an embodiment, various structural elements are employed depending on the design choices of the system designer.

### BRIEF DESCRIPTION OF THE DRAWINGS

The foregoing summary, as well as the following detailed description, is better understood when read in conjunction with the appended drawings. For illustrating the embodiments herein, exemplary constructions of the embodiments are shown in the drawings. However, the embodiments herein are not limited to the specific methods and components disclosed herein. The description of a method step or a component referenced by a numeral in a drawing is applicable to the description of that method step or component shown by that same numeral in any subsequent drawing herein.

FIG. 1 illustrates a method for optimizing management of operations associated with maintenance and/or production of a machine asset, according to an embodiment herein.

FIG. 2A illustrates a block diagram showing high-level stages of operations associated with maintenance of a machine asset, according to an embodiment herein.

FIG. 2B illustrates a block diagram showing high-level stages of operations associated with production of a machine asset, according to an embodiment herein.

FIG. 3 illustrates a flowchart of a workflow of typical maintenance operations performed on a machine asset and, tracked by an operations management engine for generating operational data, according to an embodiment herein.

FIG. 4 illustrates a system architecture for optimizing management of operations associated with maintenance and/or production of a machine asset, according to an embodiment herein.

FIG. 5 illustrates a block diagram of an application architecture comprising, an artificial intelligence (AI) & machine learning (ML) engine for optimizing management of operations associated with maintenance and/or production of a machine asset, according to an embodiment herein.

FIGS. 6A-6B illustrate a flowchart showing an exemplary implementation of the AI & ML engine for forecasting projections of multiple operational elements associated with maintenance and/or production of a machine asset and for generating predictable and actionable insights for each of the operational elements, according to an embodiment herein.

FIGS. 7A-7D exemplarily illustrate screenshots of graphical user interfaces rendered by the operations management engine for managing user accounts in the system for optimizing management of operations associated with maintenance and/or production of a machine asset, according to an embodiment herein.

FIG. 8 exemplarily illustrates a screenshot of a graphical user interface rendered by the operations management engine for accessing parts information, according to an embodiment herein.

FIG. 9 exemplarily illustrates a screenshot of a graphical user interface rendered by the operations management engine for optimizing the management of operations associated with maintenance and/or production of a machine asset with enhanced visibility, according to an embodiment herein.

FIG. 10 exemplarily illustrates a screenshot of a graphical user interface rendered by the operations management engine for accessing audit logs of operations associated with maintenance and/or production of a machine asset, according to an embodiment herein.

FIG. 11 exemplarily illustrates a screenshot of a graphical user interface rendered by the operations management engine for accessing imported data logs of operations associated with maintenance and/or production of a machine asset, according to an embodiment herein.

FIGS. 12A-12J exemplarily illustrate reports generated by the operations management engine for optimizing the management of operations associated with maintenance and/or production of a machine asset with enhanced visibility, according to an embodiment herein.

FIGS. 13A-13C exemplarily illustrate screenshots of graphical user interfaces rendered by the operations management engine for managing devices implemented in the system for optimizing management of operations associated with maintenance and/or production of a machine asset, according to an embodiment herein.

FIGS. 14A-14H exemplarily illustrate graphical user interfaces rendered by a mobile application deployed on a computing device implemented in the system for optimizing management of operations associated with maintenance and/or production of a machine asset, according to an embodiment herein.

FIGS. 15A-15M exemplarily illustrate screenshots of visibility dashboards rendered by the operations management engine for conveying predictable and actionable insights of the analytics performed for optimizing management of operations associated with maintenance and/or production of a machine asset, according to an embodiment herein.

FIGS. 16A-16I exemplarily illustrate tabular representations of data imported and processed by the operations management engine, in communication with a customer enterprise resource planning system, according to an embodiment herein.

FIG. 16J exemplarily illustrates a tabular representation of data processed by the AI & ML engine of the operations management engine, according to an embodiment herein.

FIG. 17 illustrates an architectural block diagram of an exemplary implementation of the system for optimizing management of operations associated with maintenance and/or production of a machine asset, according to an embodiment herein.

The specific features of the embodiments herein are shown in some drawings and not in others for convenience only as each feature may be combined with any or all of the other features in accordance with the embodiments herein.

### DETAILED DESCRIPTION

Various aspects of the present disclosure may be embodied as a system, a method, or a non-transitory, computer-readable storage medium having one or more computer-readable program codes stored thereon. Accordingly, various embodiments of the present disclosure may take the form of an entirely hardware embodiment, an entirely software embodiment comprising, for example, microcode, firmware, software, etc., or an embodiment combining software and hardware aspects that may be referred to herein as a “system”, a “module”, an “engine”, a “circuit”, or a “unit”. Various embodiments herein provide a method, a system, and subsystems that implement an operations management engine for optimizing management of operations associated with maintenance and/or production of a machine asset. As used herein, the term “machine asset” refers to parts and components that constitute a high value machine or that are associated with the high value machine, and that are susceptible to wear and failure over time. For example, machine assets comprise vehicle engines, industrial gas turbine engines, landing gear, auxiliary power units (APUs), wheels and brakes, etc., associated with high value machines such as defence vehicles, trains, airplanes, marine vessels, or other high value vehicles. In an embodiment, the machine asset is a high value machine such as an aircraft. The overall system comprising the operations management engine and associated hardware, software, devices, and network components for optimizing management of operations associated with maintenance and/or production of a machine asset, is herein also referred to as an “operations tracking system”.

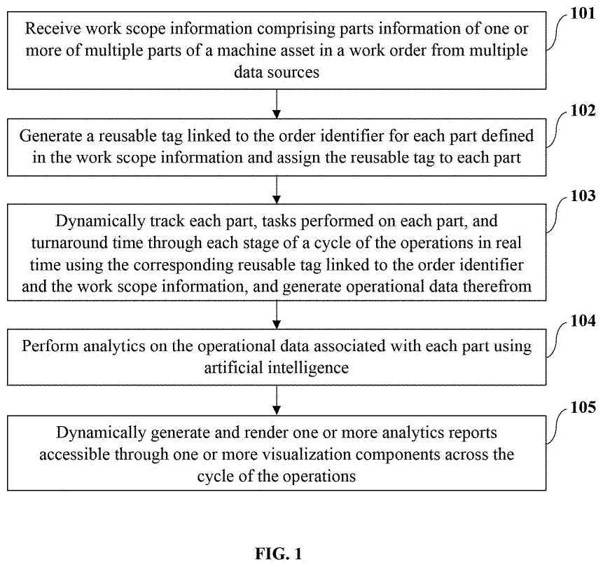

FIG. 1 illustrates a method for optimizing management of operations associated with maintenance and/or production of a machine asset, according to an embodiment herein. The method disclosed herein employs multiple tag readers operable at multiple stages defined in a cycle of operations associated with maintenance and/or production of the machine asset. The method disclosed herein also employs an operations management engine configured to define computer program instructions executable by at least one processor for optimizing management of operations associated with maintenance and/or production of the machine asset. The operations associated with the maintenance of the machine asset comprise, for example, maintenance planning, scheduling, induction, disassembly, cleaning, non-destructive testing, inspection, repair, specialized processing, parts ordering, parts receiving, kitting, re-assembling, testing, and shipping of the machine asset. The operations associated with the production of the machine asset comprise, for example, production planning, parts ordering, parts receiving, kitting, equipping and erection, testing, and shipping of the machine asset. Maintenance and/or production operations as disclosed above are herein referred to as “operations”.

In the method disclosed herein, the operations management engine receives 101 work scope information comprising parts information of one or more of multiple parts of the machine asset in a work order from multiple data sources. The data sources comprise, for example, original equipment manufacturer (OEM) manuals, templates, checklists, enterprise resource planning (ERP) systems, documentation, and user definitions and configurations entered via graphical user interfaces rendered by the operations management engine on a computing device. Each of the parts is linked to an order identifier of the work order. The operations management engine generates 102 a reusable tag linked to the order identifier for each part defined in the work scope information and assigns the reusable tag to each part. The reusable tag is, for example, a radio-frequency identification (RFID) tag or a wireless beacon tag such as a Bluetooth low energy (BLE) tag, free of the work scope information. The reusable tags are disposed on various types of active and passive tags, for example, in the form of inlays, Acrylonitrile-Butadiene-Styrene (ABS)-based hard tags, and specialized tags made of engineered polymer depending upon the deployment area and functional requirements. In an embodiment, inlays or hard tags are disposed on parts for store management and parts tracking, while specialized tags are disposed on parts requiring cleaning and non-destructive testing (NDT) or on, parts having exposure to a caustic and autoclave environment. BLE tags are sent along with the part to a vendor for repair. Once the part reaches the vendor, a wireless communication-enabled mobile device or a BLE-enabled tag reader installed at the facility captures the receipt, of parts at the vendor. When vendor completes the repair of the parts, the vendor sends the repaired parts along with the BLE tags. When the part is received at a client's store, these BLE tags are automatically read and registered as “now available” in the operations tracking system, thus saving time and the manual effort of ensuring that a part is available.

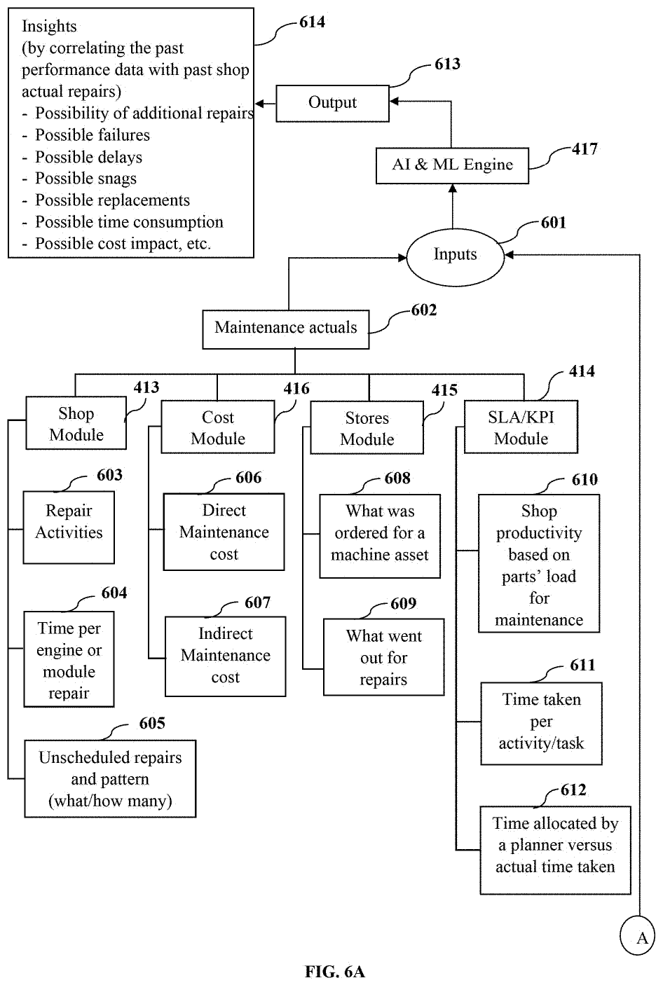

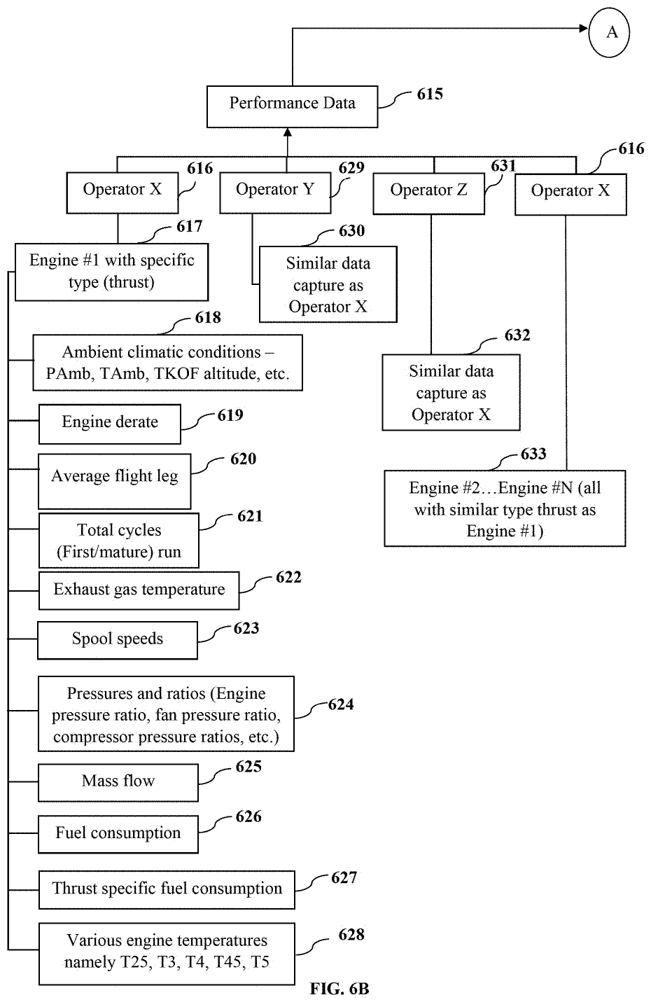

The operations management engine, in communication with one or more of the tag readers, dynamically tracks 103 each part, tasks performed on each part, and turnaround time through each of the stages of the cycle of operations in real time using the corresponding reusable tag, linked to the order identifier and the work scope information, and generates operational data therefrom. The operational data comprises, for example, a status of each part, type of tasks and operations performed, time of initiation and completion of the tasks, task execution time, person-hours, part history information, part induction information, part movement information, transactional information, machine asset data, schedules, plans, and audit logs. The operations management engine determines the person-hours based on the initial definition of the type of maintenance or repair that is defined in the operations tracking system that captures the number of hours required per step. The operations management engine performs 104 analytics on the operational data associated with each of the parts using artificial intelligence (AI). In an embodiment, in performing the analytics on the operational data associated with each part, the operations management engine calculates shop operational efficiency and shop profitability based on induction type using spend data extracted from a database operably coupled to the operations management engine as disclosed in the detailed descriptions of FIG. 5 and FIGS. 6A-6B. In another embodiment, in performing the analytics on the operational data associated with each part, the operations management engine forecasts projections of multiple operational elements and generates predictable and actionable insights for each of the operational elements using AI as disclosed in the detailed descriptions of FIG. 5 and FIGS. 6A-6B. The operational elements comprise, for example: (a) requirements for the parts; (b) productivity savings; (c) completion time; (d) work scope; (e) machine asset performance; and (f) prescriptive cost impact. In another embodiment, in performing the analytics on the operational data associated with each part, the operations management engine forecasts exhaust gas temperature gain for any incoming machine asset, for example, an aircraft engine also referred to as an aero engine, as disclosed in the detailed descriptions of FIG. 5 and FIGS. 6A-6B.

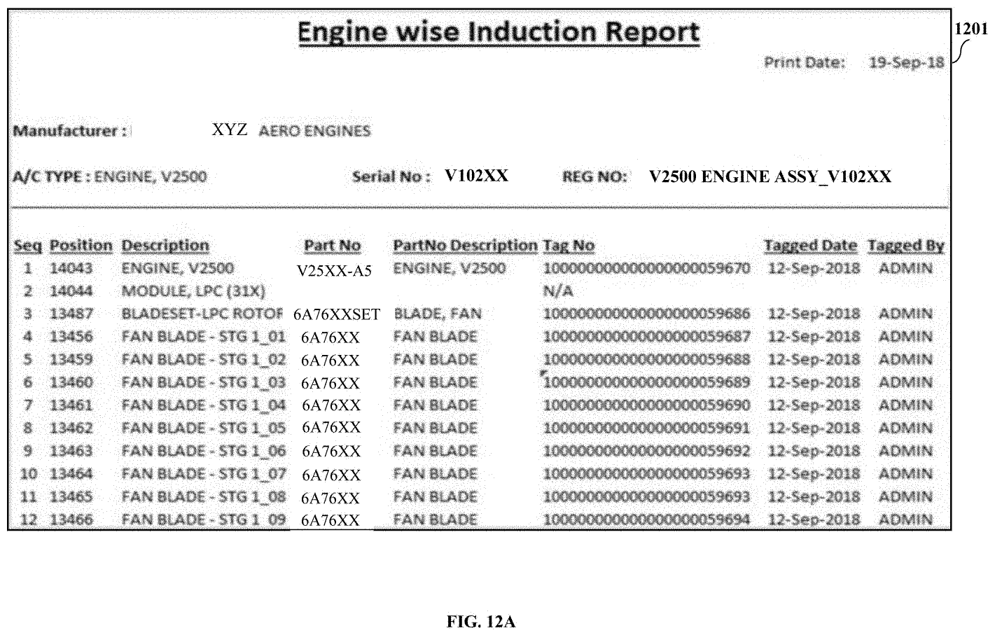

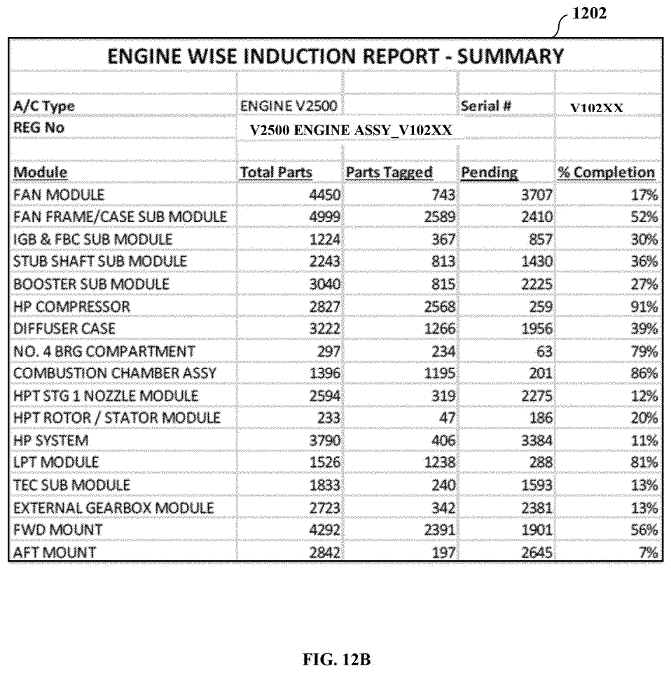

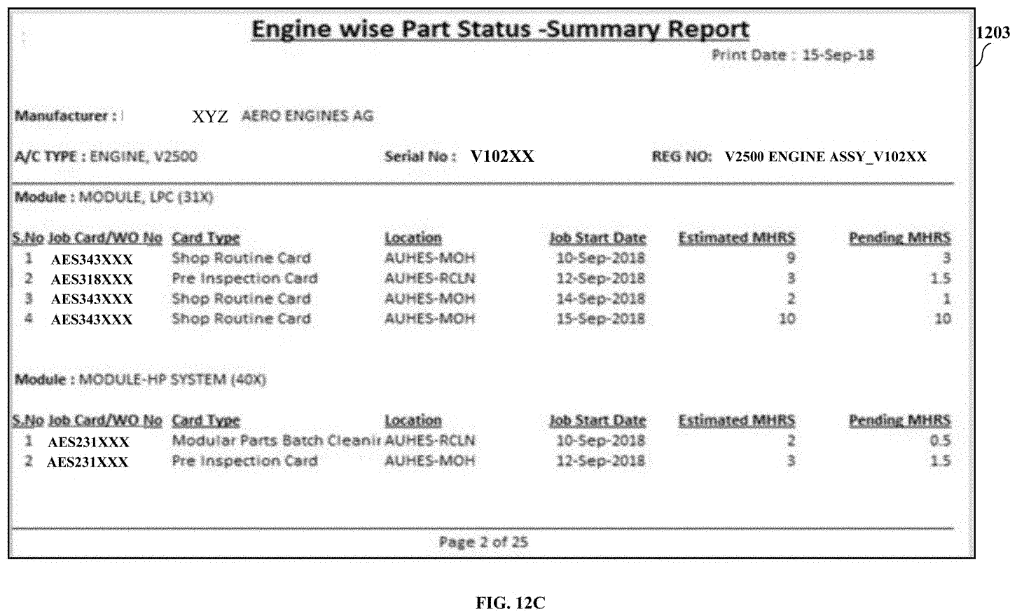

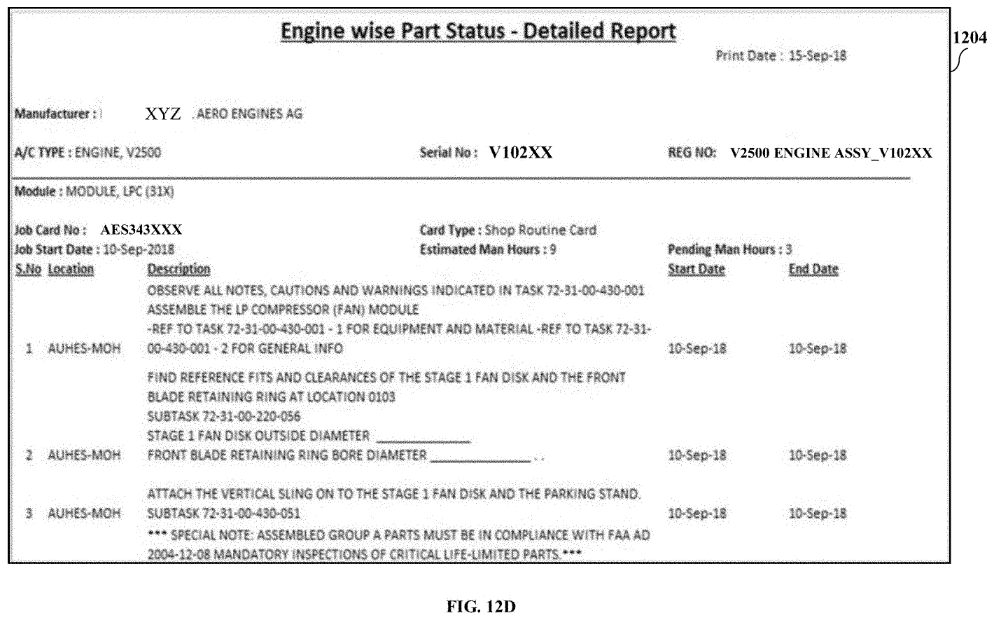

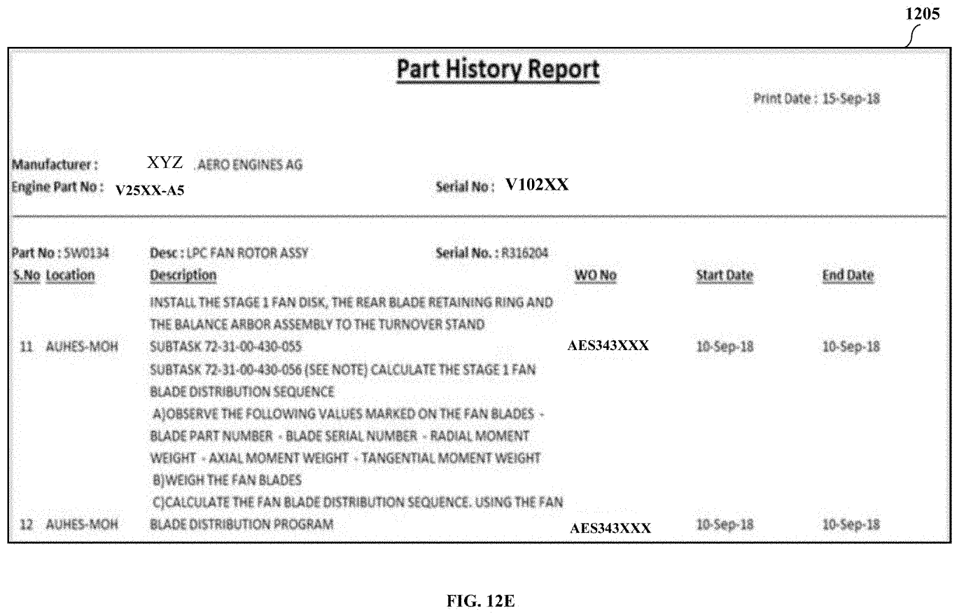

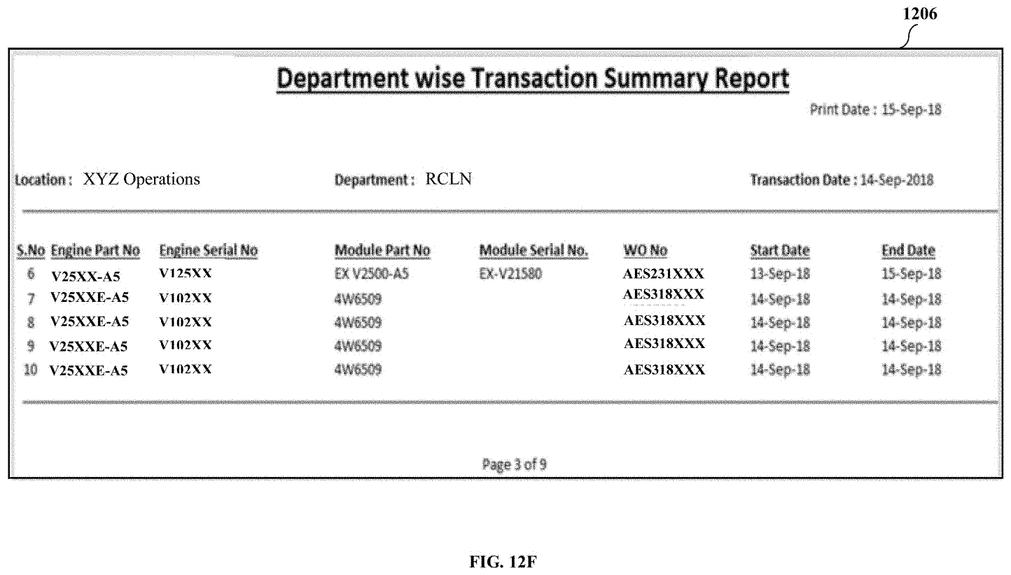

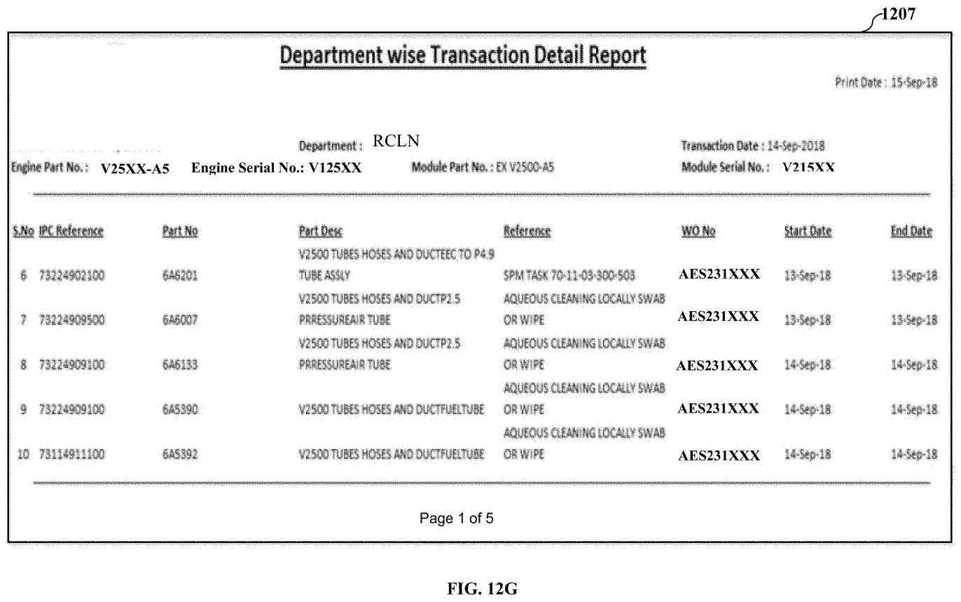

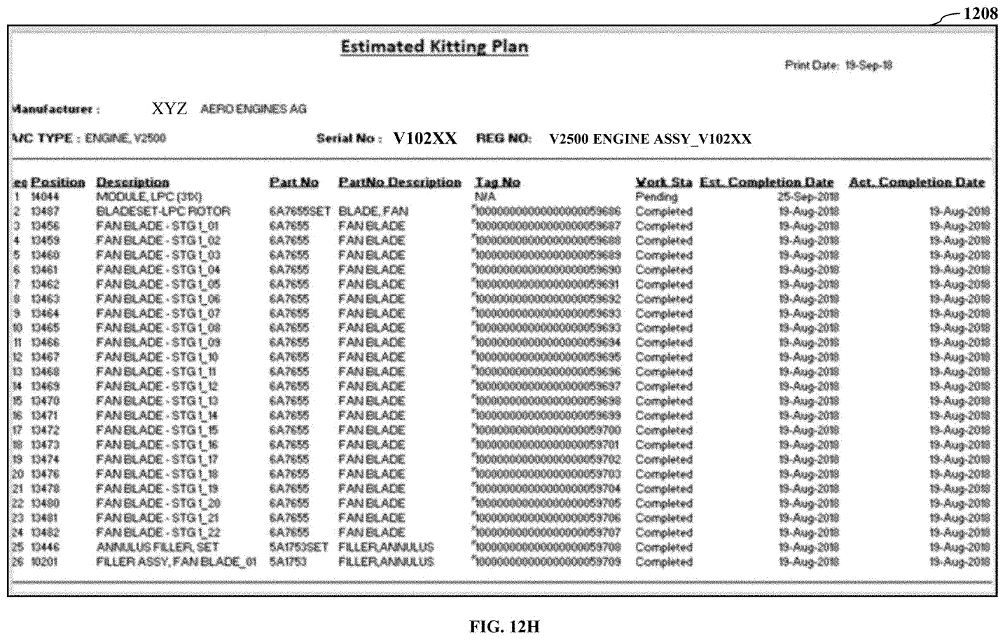

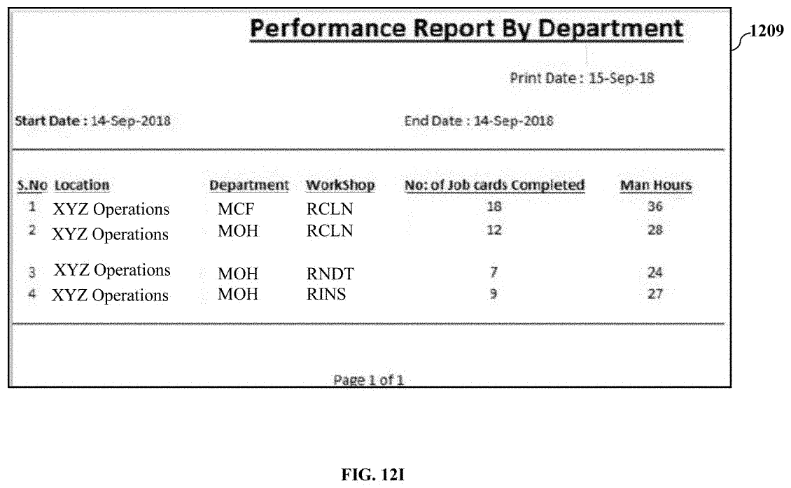

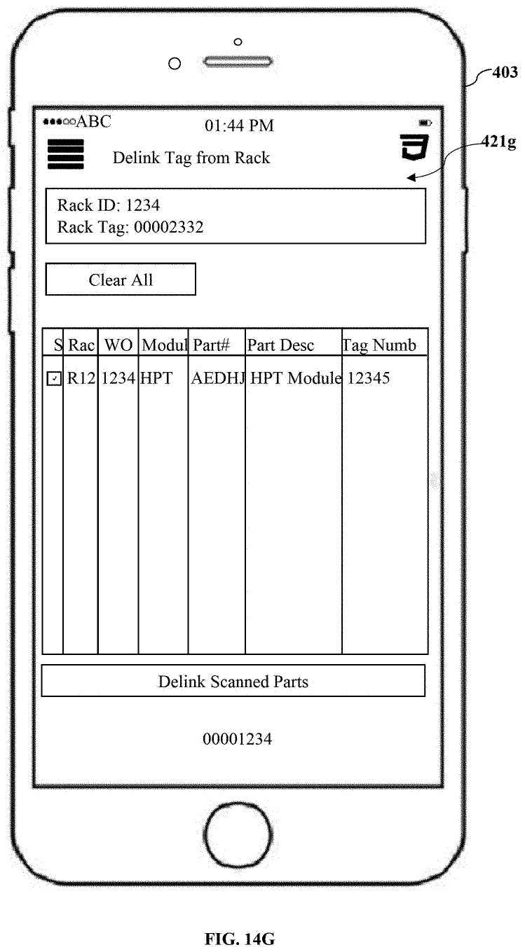

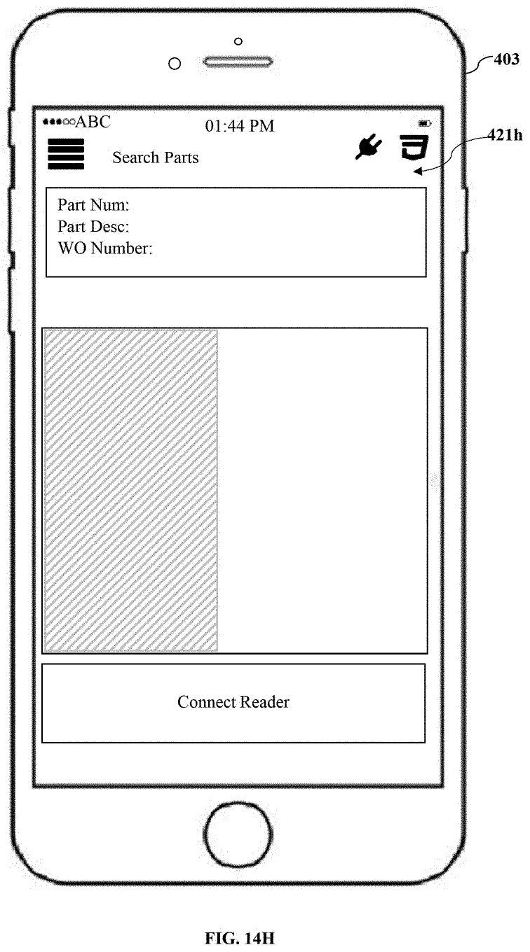

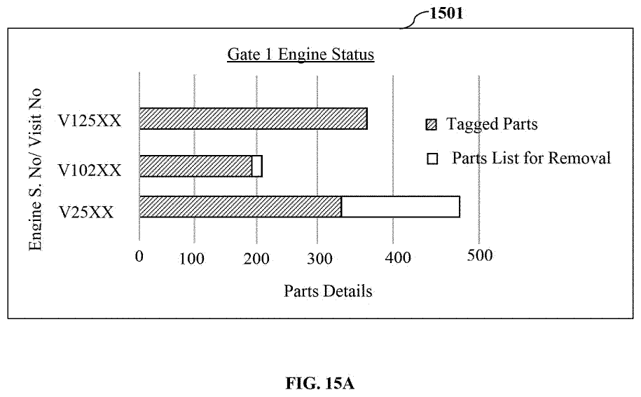

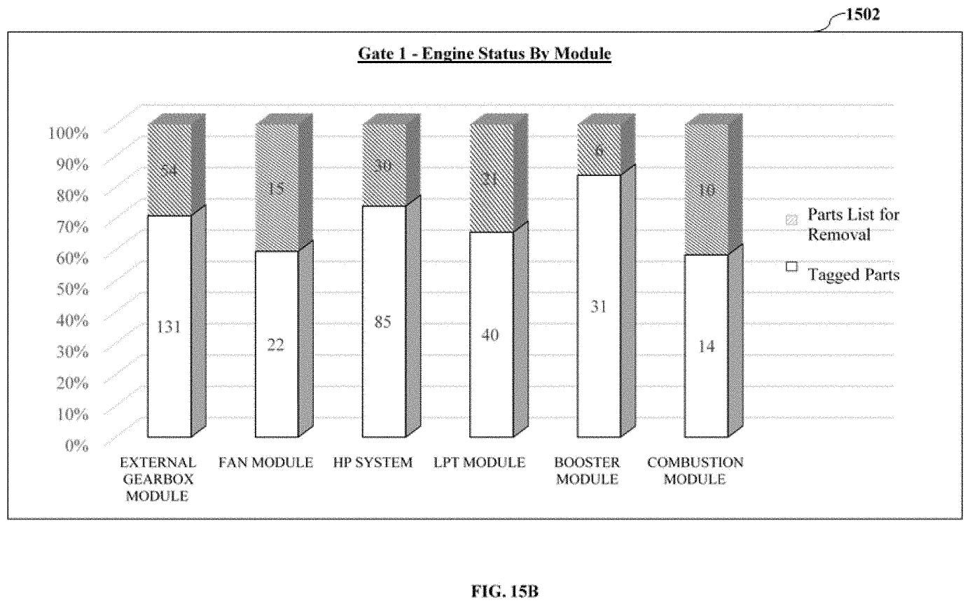

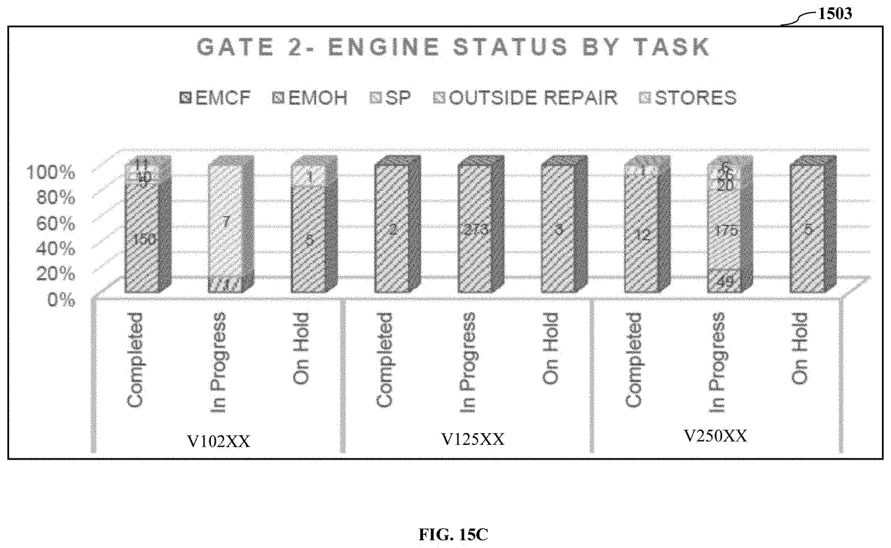

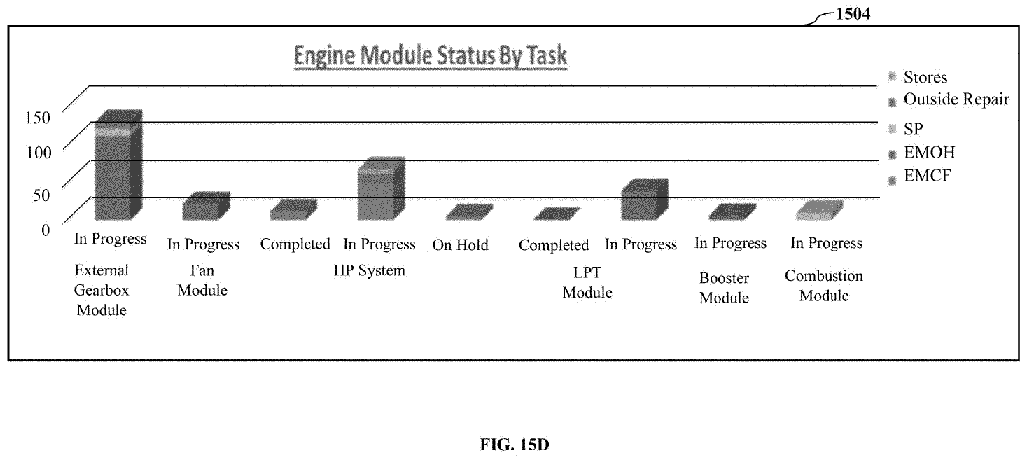

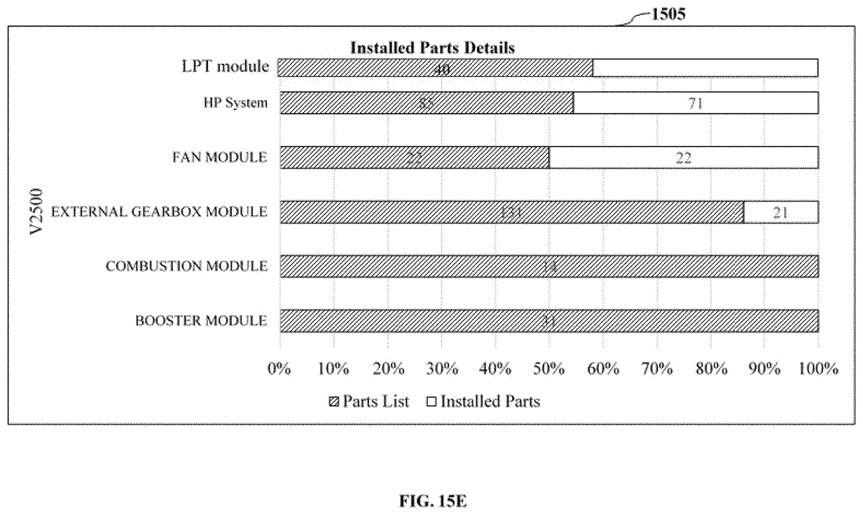

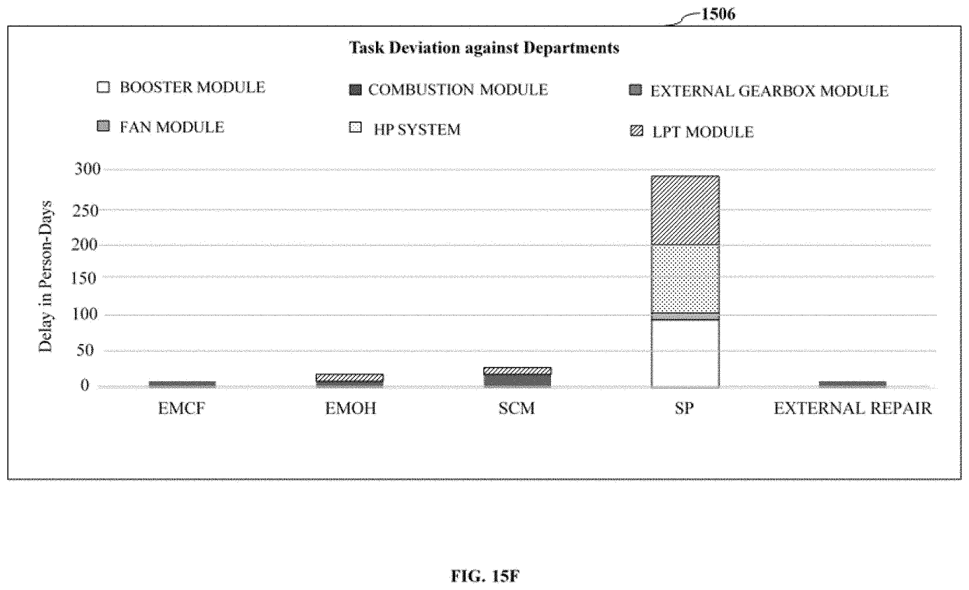

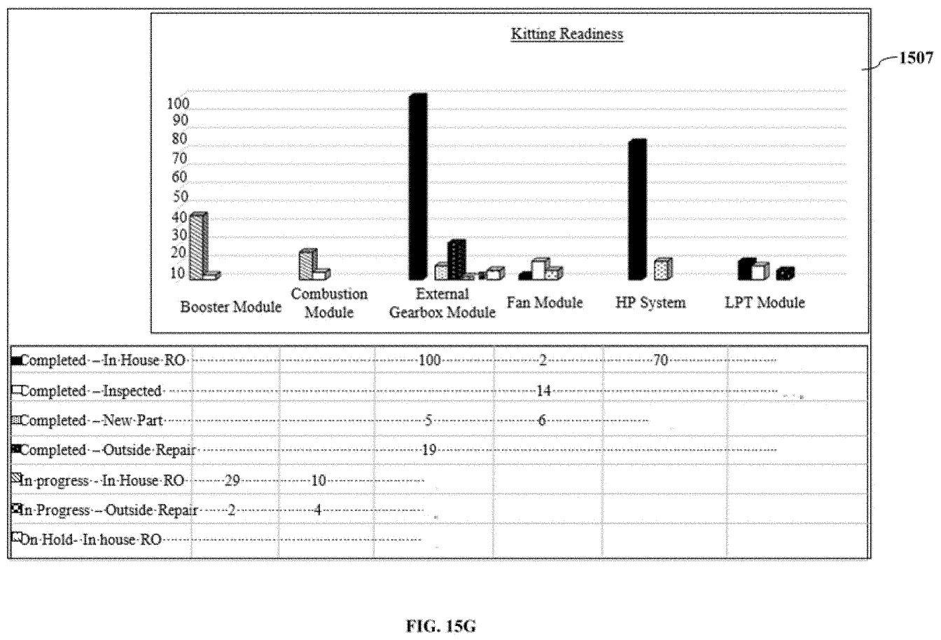

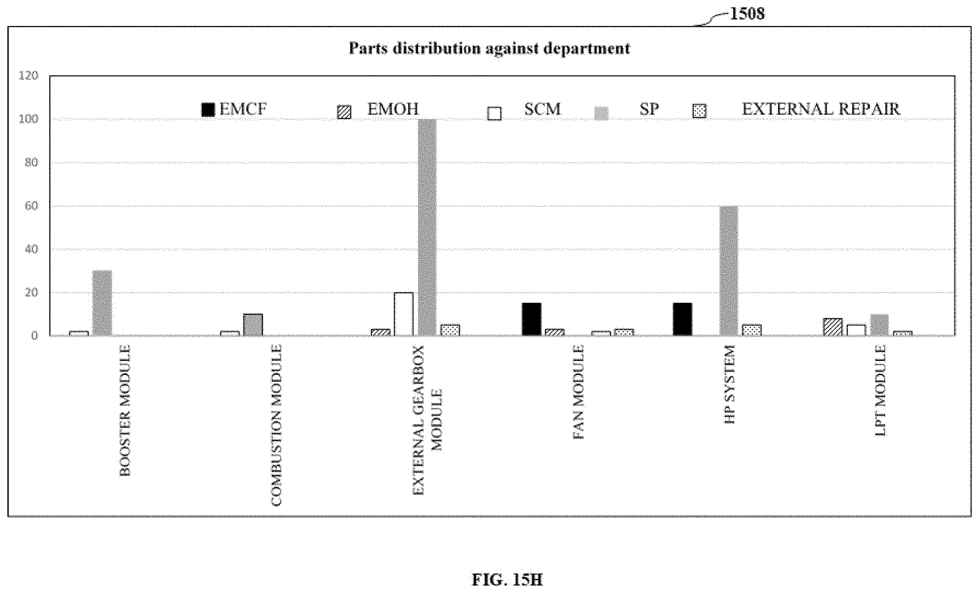

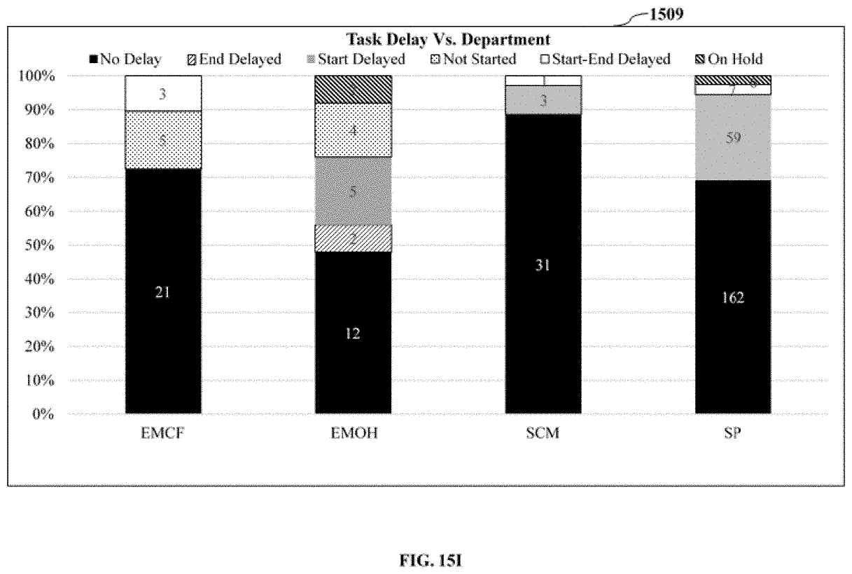

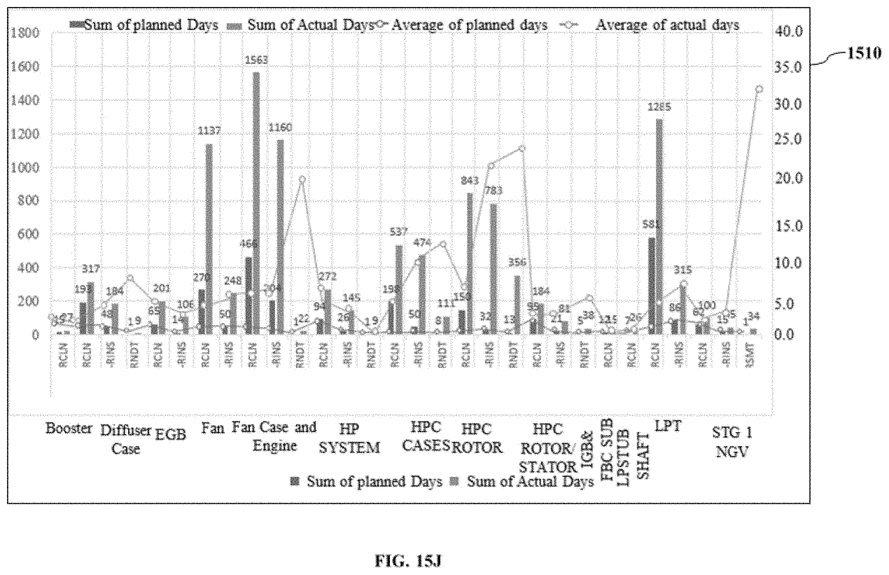

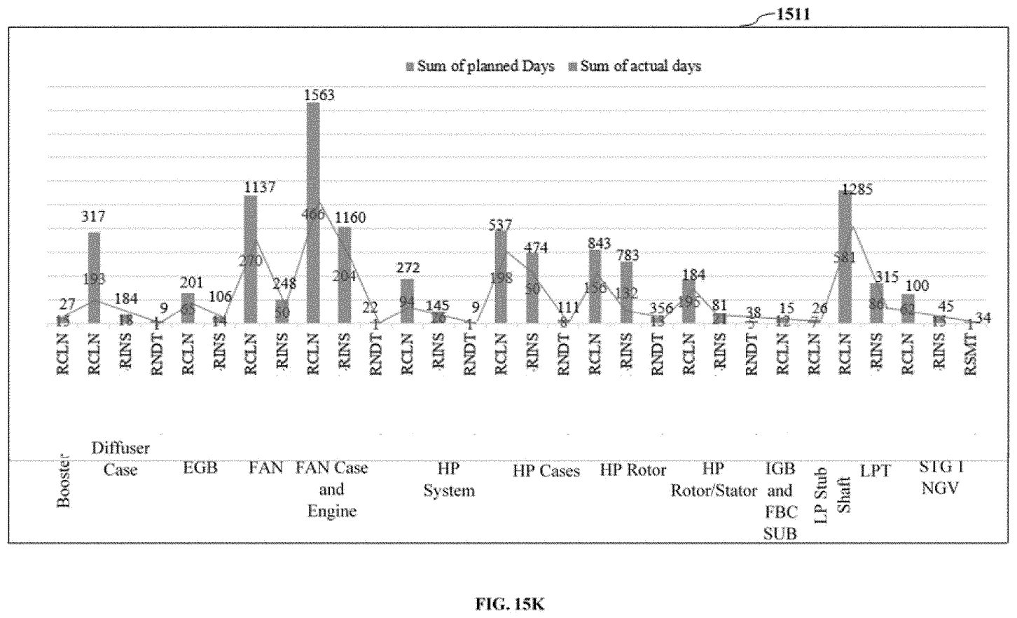

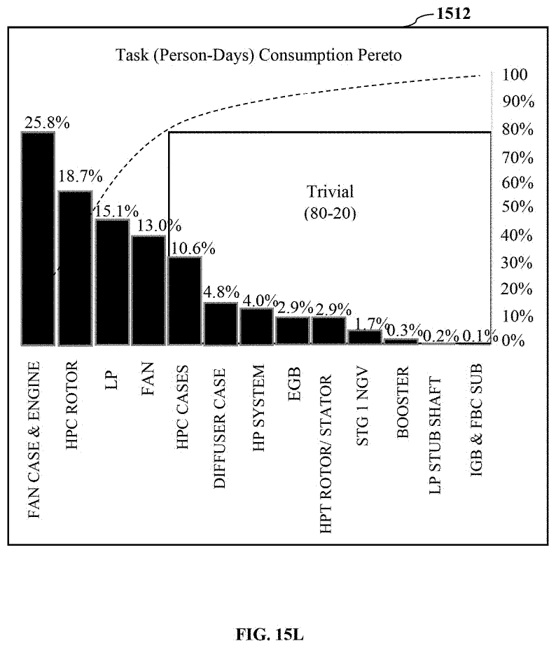

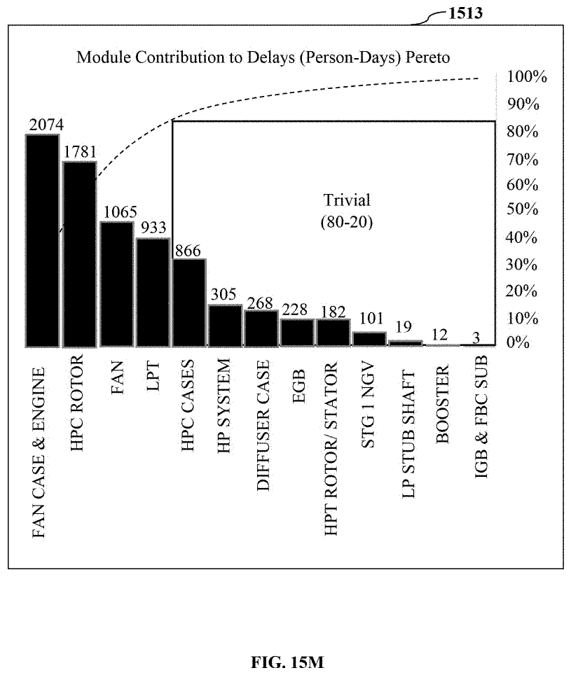

The operations management engine dynamically generates and renders 105 one or more analytics reports accessible through one or more of multiple visualization components across the cycle of operations to convey predictable and actionable insights of the analytics for optimizing the management of the operations with enhanced visibility as illustrated in FIGS 12A-12J and FIGS. 15A-15M. The visualization components comprise, for example, real-time dashboards and notifications. One or more of the analytics reports accessible through the visualization components comprise at least one of: (a) parts and tag information by date and user for the machine asset by a machine identifier; (b) a task status summary and estimated dates of completion per assembly, per sub-assembl,. and per work order of the machine asset by the machine identifier; (c) transactions on each part by a part identifier; (d) a department-wise summary of transactions and completion of the work order within specified dates; (e) number of person-hours and work orders processed by department within specified dates and specific visits; (f) machine asset status configured to indicate a number of pre-inspection cards tagged compared to pre-inspection cards available by module; (g) machine asset status based on a number of job cards and tasks versus percentage completion by module and by the machine asset; (h) machine asset status based on a pre-inspection card deactivated by module and by the machine asset; (i) ontime processing and delayed processing by period and by the machine asset; (j) external repair order status and new issues from stores to indicate completion percentage; (k) parts distribution by department and by the machine asset; (l) number of job cards processed and deployed across predefined planned time intervals; (m) yearly maintenance and/or production data and labor hours; and (n) statistical classification of a cumulative person-hour spread task-wise and part-wise. In an embodiment, the operations management engine automatically populates the visualization components, for example, the dashboards, with the results of the analytics performed.

In an embodiment, the operations management engine, in communication with a client application deployed on a computing device, deactivates the reusable tag of each part indicating a completion of the cycle of operations. In an embodiment, the computing device is a wireless communication-enabled mobile device, for example, an RFID-enabled mobile device, operably coupled to the tag readers. In an embodiment, the operations management engine monitors and renders status of the operations and status of the tag readers to resolve outages, delays, and bottlenecks in the operations tracking system.

In an embodiment, the operations management engine facilitates transfer of the parts between the stages in the cycle of operations in accordance with a list of the tasks defined in job cards and updates locations of the parts during the transfer between the stages in at least one database operably coupled to the operations management engine. In an embodiment, the operations management engine tracks movement of multiple parts comprising incoming parts and outgoing parts in stores and determines requirements and availability of the parts. In an embodiment, the operations management engine determines and renders pending tasks across the cycle of operations; (b) renders a list of parts required for the operations; and (c) systematically renders the work scope information, on a computing device.

In an embodiment, a client application configured, for example, as a mobile application, is deployed on a computing device and configured to operate with the operations management engine for executing one or more of multiple operations management functions. The operations management functions comprise, for example, user authentication, generation and display of a list of tasks, tagging of the parts of the machine asset based on the work order, transfer of the parts between departments, indicating a start and an end of each of the tasks for scanned part tags, kitting verification, deactivation of each reusable tag, and querying of the parts. In this embodiment, the computing device is in operable communication with the tag readers. In another embodiment, a middleware application is configured to operate with the operations management engine for executing one or more of multiple device management functions. The device management functions comprise, for example, managing the tag readers, managing locations of the tag readers, managing locations of the parts of the machine asset, and monitoring a network status of each of the tag readers.

In the method disclosed herein, the operations tracking system does not store data on the reusable tags but uses the reusable tags as unique identifiers. The tags are reusable and serve as a link between a job card or a task card and a part under maintenance via middleware of the operations tracking system. When a task is completed, the operations management engine updates the database automatically and facilitates removal of the reusable tags from the parts before the parts are assembled back into the machine asset. The operations tracking system captures the turnaround time or task execution time inside a maintenance, repair, and overhaul (MRO) facility and tracks and updates the operational data in the database automatically. The operations management engine records the turnaround time for specific repair activities defined in the job card or the task card for a part. The operations management engine tracks the parts during the repair operation. The operations management engine facilitates maintenance execution and analysis of maintenance time in the MRO facility at part level. The operational data is generated through a link created between the part under maintenance and the job card or the task card received from the ERP system(s). The operations tracking system uses a reusable tag on each part of a machine asset and after disassembly of the machine asset and arrival at an MRO facility, tracks the reusable tag throughout the maintenance execution process and removes the reusable tags when the machine asset is assembled after overhaul for shipping back to the customer.

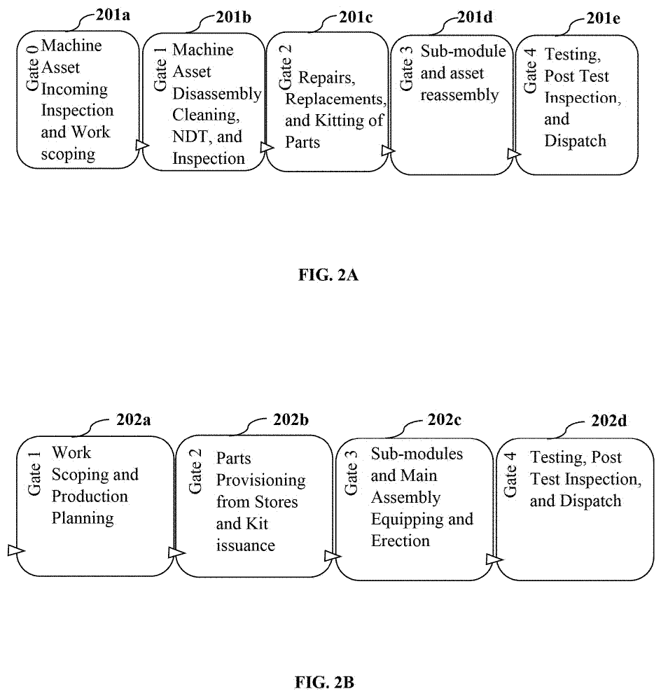

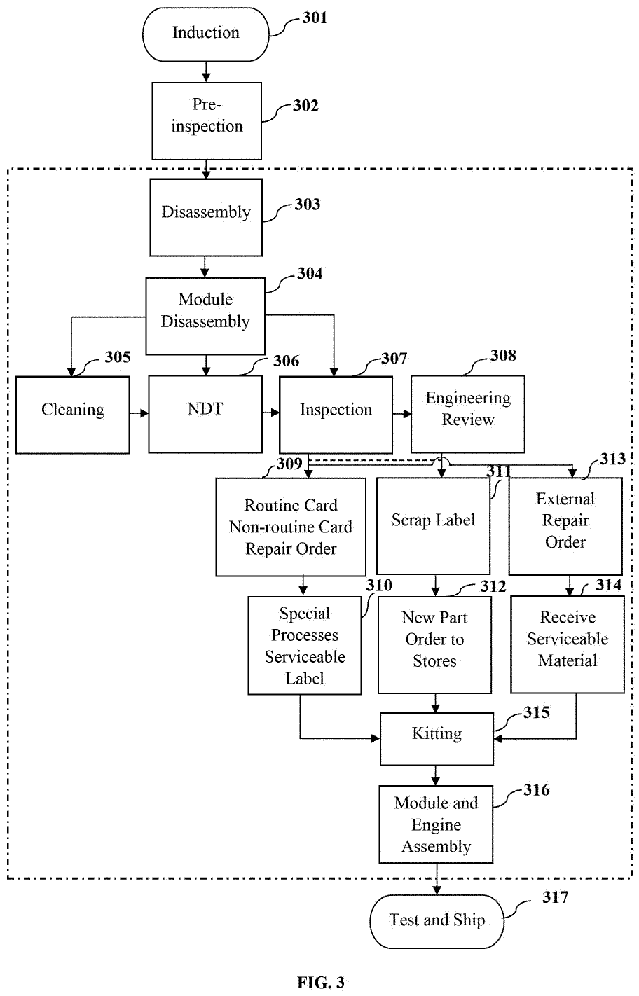

FIG. 2A illustrates a block diagram showing high-level stages of operations associated with maintenance of a machine asset, according to an embodiment herein. Consider an example where the operations management engine is configured to optimize management of maintenance, repair, and overhaul (MRO) operations associated with a vehicle engine such as an aircraft engine. For purposes of illustration, the detailed description refers to the machine asset being a vehicle engine; however, the scope of the system and the method disclosed herein is not limited to the machine asset being a vehicle engine but may be extended to include any machine asset of a high value machine or functionally equivalent structure. The process steps or operations involved in any MRO process for mechanical and structural repairs comprise, for example, dismantling of parts, cleaning, inspection, and relevant repairs as per the original equipment manufacturer (OEM)-supplied maintenance and repair manuals. The cycle of operations in an MRO process for a vehicle engine comprises multiple stages, also referred to as “gates”, namely, Gate 0, Gate 1, Gate 2, Gate 3, and Gate 4 as exemplarily illustrated in FIG. 2A. For example: Gate 0 is associated with induction, inspection, and work scoping 201a of the vehicle engine; Gate 1 is associated with disassembly, cleaning, non-destructive testing (NDT), and inspection 201b of the vehicle engine and modules of the vehicle engine; Gate 2 is associated with, repairs, replacements, and kitting 201c of parts of the vehicle engine; Gate 3 is associated with reassembly 201d of the vehicle engine and the sub-modules of the vehicle engine; and Gate 4 is associated with testing, post-test inspection, and dispatch 201e of the vehicle engine to a customer. The operations management engine executes multiple functions at one or more stages or gates of the MRO process. For example: At Gate 0, the operations management engine generates and assigns tags to the parts of the vehicle engine during initiation of a part maintenance operation; at Gate 1, the operations management engine tracks the parts through the disassembly, cleaning, NDT, and inspection operations using the tags; at Gate 2, the operations management engine tracks the parts through internal and external repair shops, receiving stores, and final kitting using the tags; and at Gate 3, the operations management engine deactivates the tags during reassembly of the vehicle engine, thereby indicating the completion of the full cycle of operations.

FIG. 2B illusftates a block diagram showing high-level stages of operations associated with production of a machine asset, according to an embodiment herein. Consider an example where the operations management engine is configured to optimize management of production operations associated with a vehicle engine such as an aircraft engine. The process steps or operations involved in any production process comprise, for example, production planning, parts ordering, parts receiving, kitting, equipping and erection, testing. and shipping. The cycle of operations in a production process for a vehicle engine comprises multiple stages, also referred to as “gates”, namely, Gate 1, Gate 2, Gate 3, and Gate 4 as exemplarily illustrated in FIG. 2B. For example: Gate 1 is associated with work scoping and production planning 202a of the vehicle engine; Gate 2 is associated with provisioning 202b of parts of the vehicle engine from stores and issuance of kits; Gate 3 is associated with equipping and erection 202c of sub-modules and the main assembly of the vehicle engine; and Gate 4 is associated with testing, post-test inspection, and dispatch 202d of the vehicle engine to a customer. The operations management engine executes multiple functions at one or more stages or gates of the production process.

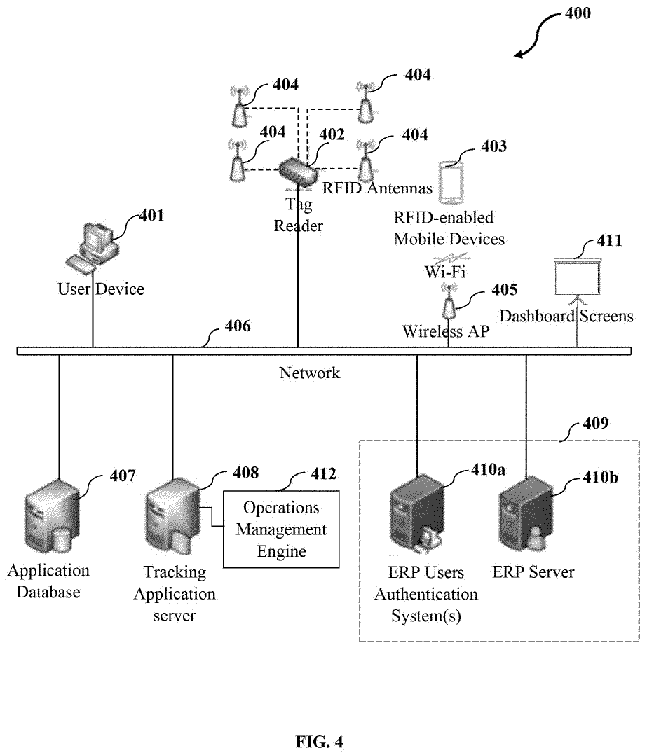

FIG. 3 illustrates a flowchart of a workflow of typical maintenance operations performed on a machine asset and tracked by the operations management engine for generating operational data, according to an embodiment herein. Consider an example where the operations management engine is configured to optimize management of maintenance, repair, and overhaul (MRO) operations associated with a vehicle engine such as an aircraft engine. Parts of the vehicle engine typically undergo the MRO operations exemplarily illustrated in FIG. 3, For example, after induction 301 of the vehicle engine, the vehicle engine undergoes pre-inspection 302. During induction 301 of the vehicle engine, the operations management engine receives the work scope information from a computing device of a customer and generates pre-inspection cards in a customer enterprise resource planning (ERP) system for each part or batch of parts. The pre-inspection cards are printed and issued to an engine shop to initiate disassembly of the vehicle engine based on the level of repair. The vehicle engine is then disassembled 303 into multiple modules. Each of the modules of the vehicle engine is then disassembled 304 into multiple parts. The operations management engine generates a reusable tag, for example, a radio-frequency identification (RFID) tag, linked to an order identifier, for example, a job order number, for each part defined in the work scope information and assigns the reusable tag to each part. The parts are tagged to the job order number and the job card is sent along with the part to each of the MRO operations. Each part of each module undergoes MRO operations comprising, for example, cleaning 305, non-destructive testing (NDT) 306, and inspection 307.

During inspection 307, the operations management engine gathers and processes data from routine cards, non-routine cards, and repair orders 309. The operations management engine also gathers and processes data from external repair orders 313 through which serviceable material is received 314. After inspection 307, each part undergoes an engineering review 308. After a part is declared and labelled serviceable 310, the part is delivered to a kitting unit for execution of a kitting operation 315, where the part awaits the rest of the parts before the final assembly 316 of the module and the vehicle engine. The kitting operation 315 comprises accumulating all parts required to rebuild a module into a kit in a kitting department. Once the kit is ready, the production planning department schedules a build process. The operations management engine allows a kitting team to monitor the status and location of each part in the repair process. At steps 311 and 312, parts that do not meet the required tolerances are scrapped and replaced before being marshalled and reassembled. The assembled vehicle engine is then tested and shipped 317 to the customer.

The operations management engine tracks and generates operational data as each of the parts undergoes the MRO operations. The operations management engine tracks each part or batch of parts as the parts move through the different MRO operations by reading or scanning the tags using the tag readers, for example, RFID-enabled fixed readers, handheld mobile readers, or handheld terminal (HHT) devices. The operations management engine updates the location of each tag to a database as the tag is read or scanned at each stage. The tag readers are used to scan the tags and identify the job cards associated with the tags. Each of the tag readers are operably coupled to a computing device, for example, an RFID-enabled mobile device, through which a user can select an operation being initiated and scan the tag again at the end of the job, thereby allowing the operations management engine, in operable communication with the tag readers and/or the RFID-enabled mobile device, to capture and track a current status of each part and determine whether an operation or a task was finished in the allocated time. The operations management engine deactivates the tags during reassembly of the vehicle engine, thereby indicating the completion of the full cycle of operations. The operations management engine stores and facilitates reporting and dashboarding of the data of the current status of the part and the location, along with the time spent, in the database and provides access to this operational data via visibility components to provide multiple levels of visibility to multiple employees or users at different levels within an organization.

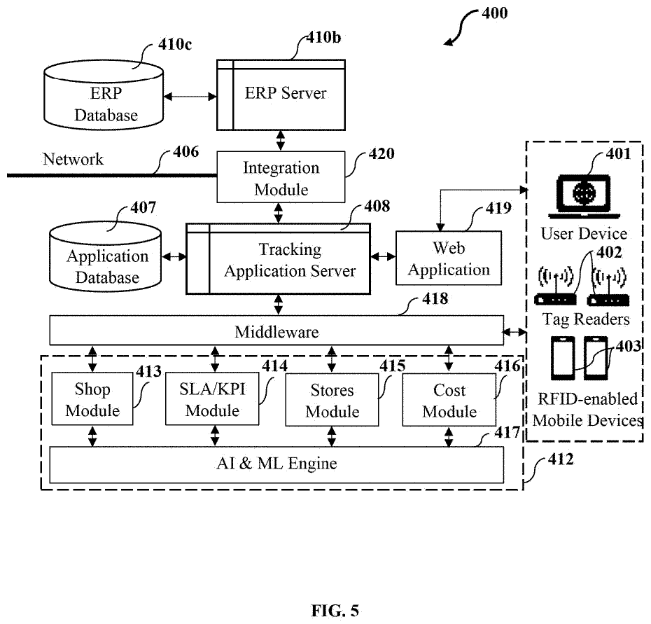

FIG. 4 illustrates a system architecture for optimizing management of operations associated with maintenance and/or production of a machine asset, according to an embodiment herein. In an exemplarily implementation of the system 400 disclosed herein, the system architecture comprises databases, servers, and equipment installed to collect data and display operational data and analytics data through visibility components such as portal screens and dashboard screens 411 at predetermined locations across the cycle of operations. The system architecture comprises one or more user devices 401, multiple tag readers 402, and wireless communication-enabled mobile devices 403 configured to operably communicate with servers and subsystems, for example, 407, 408, and 409, via a network 406 as exemplarily illustrated in FIG. 4. The network 406 is, for example, a wireless communication network, a wired network, or a combination thereof. The tag readers 402 are, for example, RFID-enabled fixed readers, handheld mobile readers, handheld scanners, handheld terminal (HHT) devices, etc. In an embodiment, the tag readers 402 and the wireless communication-enabled mobile devices 403 connect to the network 406 via a wireless communication network. The wireless communication-enabled mobile devices 403 are, for example, RFID-enabled devices developed on, an Android® operating system of Google, Inc. The system 400 disclosed herein further comprises a client application, for example, a mobile application configured as an operations tracking application and deployed on the wireless communication-enabled mobile device(s) 403 for registering, recording, processing, and displaying data associated with the operations performed at a facility, for example, a maintenance, repair, and overhaul (MRO) facility or a production facility. In an embodiment, the wireless communication-enabled mobile device(s) 403 communicates with the user device 401 via the network 406. The user device 401 is, for example, a personal computer, a workstation, or a tablet computing device with a browser application that allows an operator or an administrator of the facility, to register, record, process, and display data associated with the operations performed at the facility.

The servers and subsystems comprise an application database(s) 407, for example, a structure query language (SQL) database(s) and a tracking application server 408 associated with the operations management engine 412. In an embodiment, the tracking application server 408 is a computing device that hosts the operations management engine 412 as exemplarily illustrated in FIG. 17. The mobile application on the wireless communication-enabled mobile device 403 communicates with the tracking application server 408 via the network 406 for executing tracking and processing functions involved in optimizing management of operations associated with maintenance and/or production of a machine asset. In an embodiment, one or more portions of the operations management engine 412 are distributed across the servers and subsystems for optimizing, management of operations associated with maintenance and/or production of a machine asset. The servers and subsystems further comprise an enterprise resource planning (ERP) system 409 constituted, for example, by an ERP user authentication system(s) 410a and a customer ERP server(s) 410b configured to allow the operations management engine 412 to retrieve and record information comprising, for example, parts information, statuses of various jobs, scrap and serviceable labels, repair orders placed on external vendors, etc. The operations management engine 412 gathers and processes data collected on shop floors of one or more facilities, for example, MRO facilities that execute the operations associated with maintenance and/or production of a machine asset, for tracking the location and progress of tasks in the facilities. The operations management engine 412 communicates with the tag readers 402 and/or the wireless communication-enabled mobile devices 403 via the network 406 for receiving the data collected on shop floors of the facility.

The tag readers 402, for example, RFID-enabled fixed readers, are operably coupled to antennas 404, for example, RFID antennas, as exemplarily illustrated in FIG. 4. In an exemplary implementation of the system 400 disclosed herein, each of the tag readers 402 is operably coupled to four antennas 404 mounted on two sides of each tag reader 402 with two antennas 404 each. The coverage area of the tag readers 402 spans between the antennas 404, for example, up to a distance of about 2.5 meters. The tag readers 402 and the antennas 404 are installed at entry/exit areas of a facility, for example, an MRO facility, to be monitored by the operations management engine 412. In an embodiment, the tag readers 402, whether fixed or handheld, scan all the tags, for example, RFID tags, coupled to the parts, herein also referred to as “parts tags”, passing through the facility, by scanning a tag assigned to a rack on which the parts are stored. The system 400 allows an operator at the facility to register the parts tags against the rack on which the parts are stored using the user device 401 and/or the wireless communication-enabled mobile device 403. When the tag reader 402 reads the tag of the rack, the system 400 processes all tags of the parts associated with the rack. In an embodiment, the system 400 allows the parts that are removed from the rack during transfer of the pans to other departments of the facility for execution of other operations, to be delinked from the rack by scanning and delinking the parts tag.

In an embodiment, the tag readers 402 are configured to operate in two modes, for example, a semi-automatic in/out mode and an automatic in out mode. In the semi-automatic in/out mode, each tag reader 402 scans the tags of the parts and the tags of the racks on which the parts are stored, as the parts pass through the entry/exit areas of the facility. In an embodiment, each tag reader 402 is configured to generate and render a complete list of the tags scanned on a portal screen. In an embodiment, the portal screen is displayed on the user device 401 and/or the wireless communication-enabled mobile device 403 for viewing by the operator. In another embodiment, the tag reader 402 comprises a portal screen for displaying the complete list of the scanned tags. The system 400 allows the operator to check-in or check out the scanned tags by clicking on interface elements, for example, buttons, configured on the tag reader 402 or the wireless communication-enabled mobile device 403. For example, the user may click on a green button to check-in (IN) a scanned tag and a red button to check-out (OUT) the scanned tag. In the automatic in/out mode, each tag reader 402 is configured to scan the parts as the parts pass through the entry/exit areas of the facility and toggle a status of each part from IN to OUT and OUT to IN on the portal screen. If a tag is read multiple times within a configurable time period, for example, 20 seconds, then the system 400 processes those reads or scans as duplicates and does not allow the duplicates to change the status of the parts tags. If there is a mismatch in the IN or OUT status of a parts tag and the parts tag is detected in a subsequent automatic detection area, then the system 400 updates the location of the part to a new site with the status as checked-in (IN).

In an embodiment where the tag reader 402 is configured as a handheld scanner, for example, an RFID and barcode scanner, the tag reader 402 is operably coupled to the wireless communication-enabled mobile device 403. In this embodiment, the tag reader 402 and the wireless communication-enabled mobile device 403 are paired using a wireless communication protocol, for example, a Bluetooth® communication protocol of Bluetooth Sig, Inc. In this embodiment, the tag reader 402 and the wireless communication-enabled mobile device 403 operate as an integrated RFID and barcode scanner. The wireless communication-enabled mobile device 403 comprises a touch-enabled display screen running, for example, on an Android® operating system. The wireless communication-enabled mobile device 403 hosts the mobile application to allow a user to perform transactions that are communicated to the tracking application server 408 and the customer ERP server(s) 410b via the network 406. The wireless communication-enabled mobile device 403 communicates with the tracking application server 408 and the customer ERP server(s) 410b through a wireless access point (AP) 405, for example, a Wi-Fi® access point that implements a communication protocol of Wi-Fi Alliance Corporation. The wireless AP 405 provides access of the tracking application server 408 and the customer ERP server(s) 410b to the wireless communication-enabled mobile device 403 via the network 406.

In an embodiment, the visibility components of the system 400 disclosed herein comprise dashboard screens 411. In an embodiment, the dashboard screens 411 are display screens running, for example, on the Windows® operating system of Microsoft Corporation. The dashboard screens 411 are configured to multiple profiles depending on locations where the dashboard screens 411 are installed. In an embodiment, the dashboard screens 411 are configured, for example, as artificial intelligence (AI) & machine learning (ML)-based prescriptive dashboard screens. The AI & ML-based prescriptive dashboard screens are user-customizable and render requested data in a quick and easy-to-understand format to allow business users to act on non-compliant parts as disclosed in the detailed description of FIGS. 15A-15M. The dashboard screens 411 display the real-time dashboards generated by the operations management engine 412, indicating the status of jobs and providing a high-level and detailed visibility to staff of departments where the dashboard screens 411 are mounted.

FIG. 5 illustrates a block diagram of an application architecture comprising an artificial intelligence (AI) & machine learning (ML) engine 417 for optimizing management of operations associated with maintenance and/or production of a machine asset, according to an embodiment herein. In an exemplarily implementation of the system 400 disclosed herein, the application architecture comprises the tracking application server 408, middleware 418 accessible via a middleware application, a mobile application deployed on wireless communication-enabled mobile devices 403, and an integration module 420. In an embodiment, the tracking application server 408 hosts the operations management engine 412. The tracking application server 408 is operably coupled to an application database 407, for example, a structure query language (SQL) database. In an embodiment as illustrated in FIG. 5, the tracking application server 408 is in operable communication with the enterprise resource planning (ERP) server 410b via the network 406. The ERP server 410b is operably coupled to an ERP database 410c. The operations management engine 412 is deployed on the tracking application server 408. In an embodiment, the operations management engine 412 is accessible via a web application 419 such as a web browser, deployed on a user device 401 on the network 406, using ERP user credentials managed by the ERP server 410b.

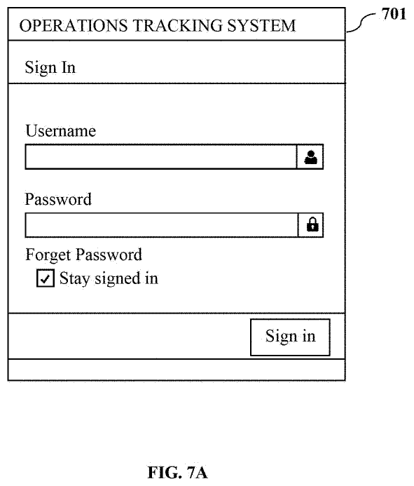

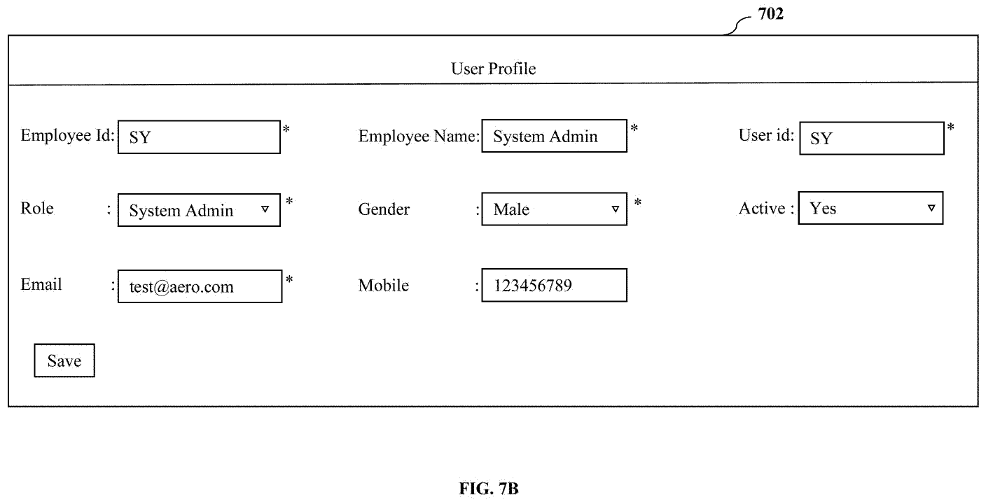

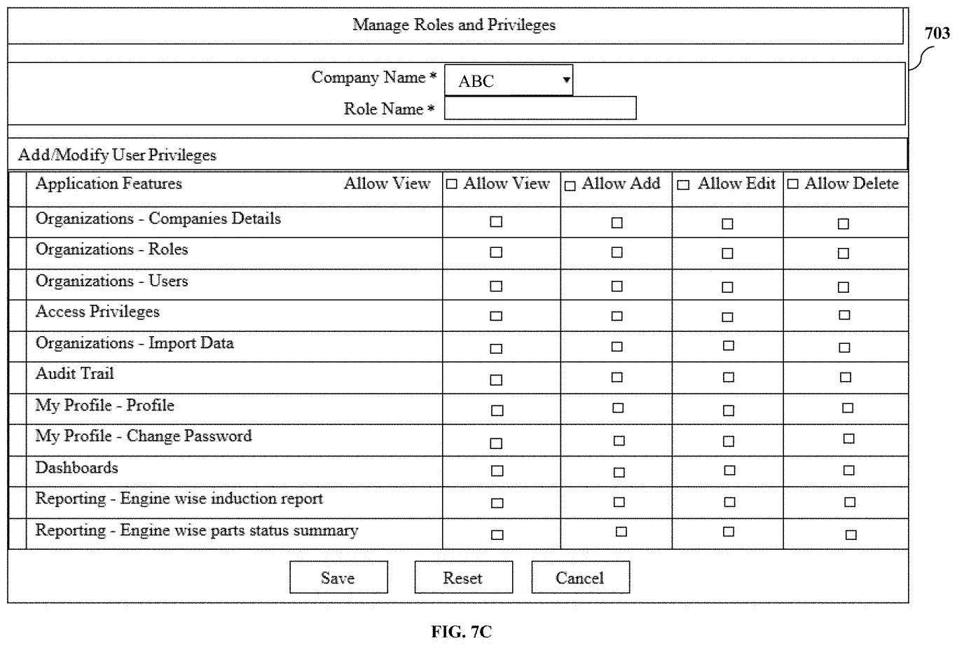

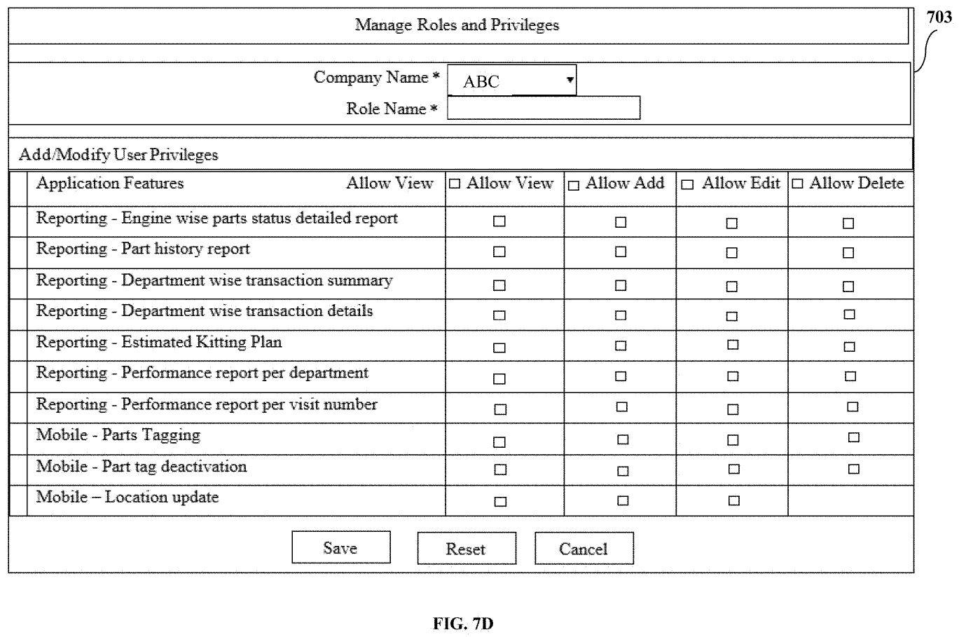

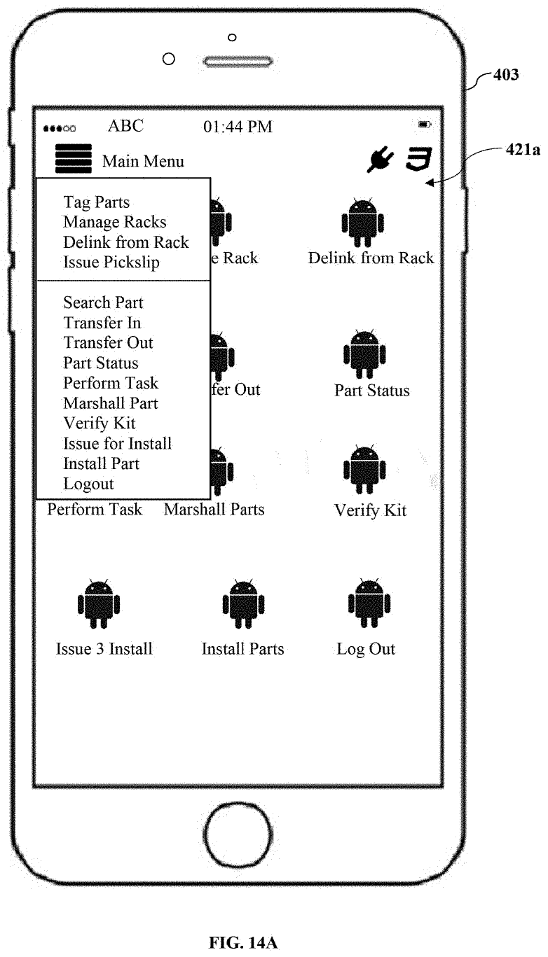

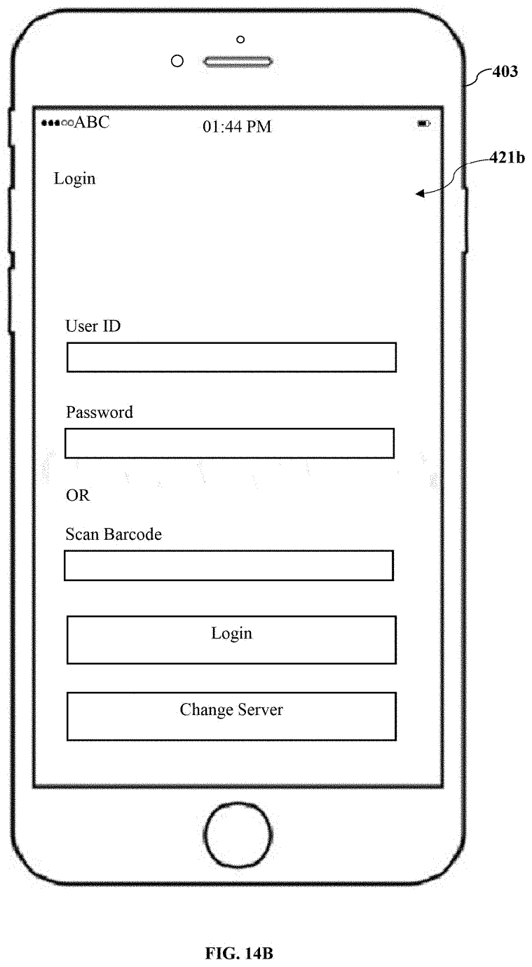

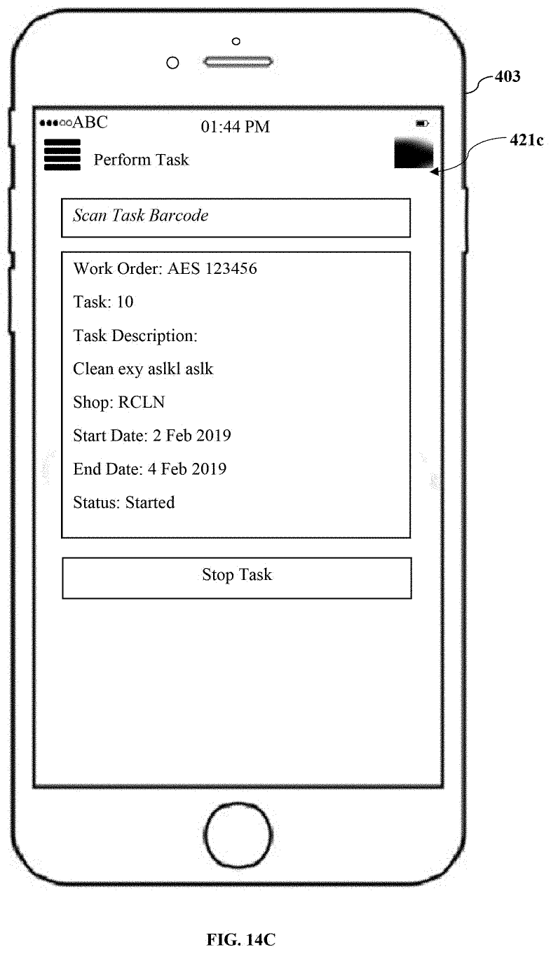

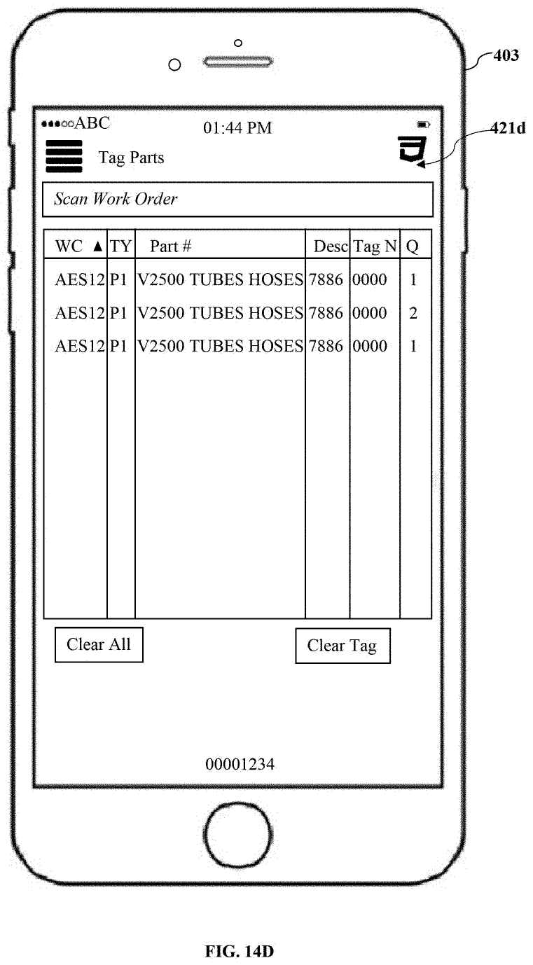

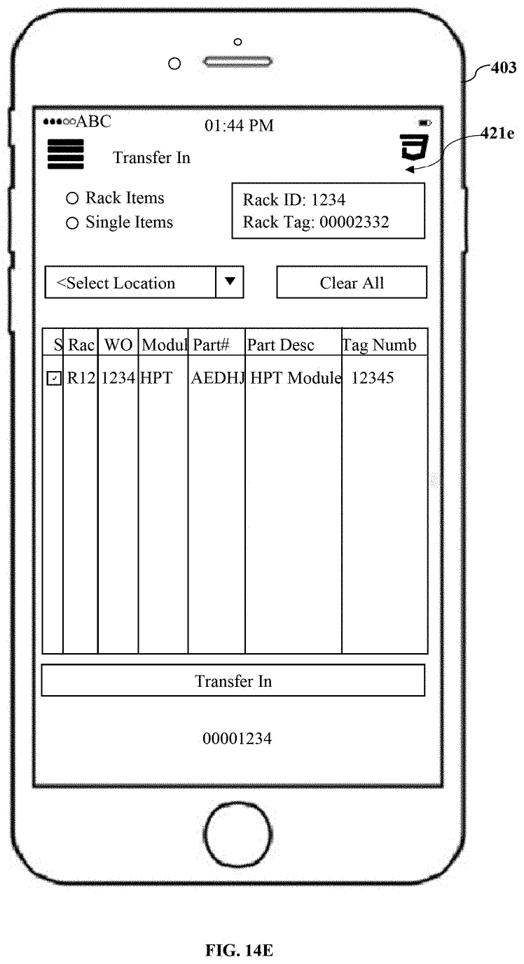

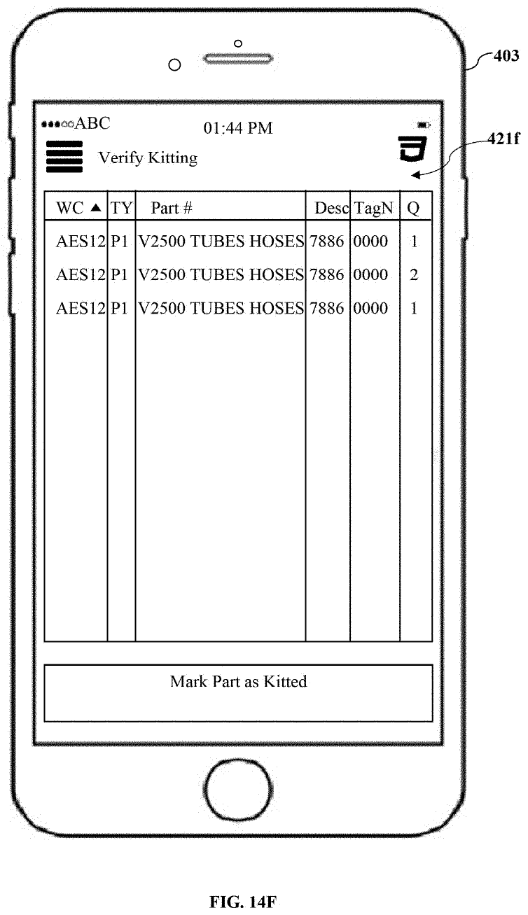

In an embodiment, the tracking application server 408 is installed along with a web server. The tracking application server 408 communicates and provides connectivity between the user device 401, the wireless communication-enabled mobile device 403, the fixed or mobile tag readers 402, and the integration module 420 through a user interface accessible via the web application 419, for example, the web browser. The components of the web application 419 are disclosed in the detailed description of FIGS. 7A-12J. In another embodiment, the system 400 allows a user to access a portion of the data collection functionality of the operations management engine 412 through the mobile application deployed on the wireless communication-enabled mobile device 403 or on a mobile tag reader or scanner. The functionality of the mobile application is disclosed in the detailed description of FIGS. 14A-14H. In another embodiment, the system 400 allows a user to access a portion of the data collection functionality of the operations management engine 412 through the middleware application installed on the tag reader(s) 402. The middleware 418 executes data connectivity and device management functions of the operations management engine 412 for managing the fixed and mobile tag reader(s) 402. The middleware 418 collects, massages, and processes the data generated by the middleware application installed on the tag reader(s) 402 and the mobile application and applies business rules depending on the part scanned, the location, and the user. The middleware 418 allows users to define the tag readers 402, collect reads or scans from the tag readers 402, and monitor the status of each tag reader 402 defined in the system 400. The middleware 418 receives data from multiple sources, for example, the fixed tag readers that indicate whether a part is being checked in or out and at which department. The data received from mobile tag readers indicate other types of transactions, for example, forming a kit of the items or parts that are scanned. The middleware 418 receives and processes this data by applying business logic as well as updating the status of tasks, parts, and their current locations. The tracking application server 408 receives data collected from the middleware application, the mobile application, and the web application 419, and stores the collected data in a database of the tracking application server 408 and/or the application database 407.

The integration module 420 configures an interface between the tracking application server 408 and customer ERP systems. The integration module 420 pulls data from staging tables in the ERP server 410b and processes the data to update the tracking application server 408 at frequent intervals. The ERP server 410b communicates master data to the tracking application server 408. The operations management engine 412 generates definitions of the tags for tracking the parts stripped from a machine asset. The tracking details of any tagged parts are stored in the database of the tracking, application server 408 and/or the application database 407. Based on the hierarchy of information shared by the ERP server 410b, the tracking application server 408 allows retrieval of parts tracking information at any level in the machine asset from the database of the tracking application server 408 and/or the application database 407.

In an embodiment, the operations management engine 412 comprises multiple modules for optimizing management of operations associated with maintenance and/or production of a machine asset. In an exemplary implementation of the operations management engine 412, the modules of the operations management engine 412 comprise a shop module 413, a service-level agreement (SLA)/key performance indicator (KPI) module 414, a stores module 415, and a cost module 416, operably coupled to the AI & ML engine 417. The tracking application server 408 comprises at least one processor configured to execute the modules 413, 414, 415, 416, and 417 of the operations management engine 412.

The shop module 413 is the central component or heart of the operations management engine 412. The shop module 413 integrates the stores module 415, the SLA/KPI module 414, and the cost module 416, in operable communication with the AI & ML engine 417, for executing specifically designed module functions disclosed herein. The shop module 413 implements shop management functions comprising, for example, work scope planning, work scope definition, tracking of work orders, tagging of parts, tracking of task orders, repair orders, shop routine cards, shop job cards, pre-inspection cards, etc., management of the middleware 418, webpage, and handheld terminal (HHT) applications, reports, scheduling, stores, inventory, extended supply-chain, etc. The SLA/KPI module 414 implements shop-wise monitoring for internal and external work scopes at task and machine asset levels. The SLA/KPI module 414 monitors internal work scope as each task that is completed is tracked to completion by scanning the part at each department once the task is completed. In an embodiment, the SLA/KPI module 414 monitors external work scope not at a task level, but only from a completion perspective unless vendor systems are integrated and report completion of tasks at their end. In an embodiment, the SLA/KPI module 414 is configured as a productivity and cost avoidance module based on six-sigma principles and creates a time definition for various shop SLAs and internal and external KPIs. The SLA/KPI module 414 quantifies delays, snags, and issues that impact ineffective turnaround and cause possible revenue or profitability leakages. The SLA/KPI module 414 renders this quantification on a dashboard, at a station level and a shop level, thereby providing predictable and actionable insights and classifications using tools such as tools implementing the Pareto principle, causal diagrams such as Ishikawa diagrams, tools implementing Kaizen principles, mistake proofing, trending, etc. The SLA/KPI module 414 operates in conjunction with the shop module 413, the stores module 415, the cost module 416, in communication with the AI & ML engine 417, for forecasting productivity savings and performing a time-to-complete analysis.

The stores module 415 implements complete inbound and outboard inventory management functions. In an embodiment, the stores module 415 is a customized requirement-based module configured to capture and track all the part movements in stores of an organization, for example, a maintenance, repair, and overhaul (MRO) organization, and movements of incoming and outgoing inventory or issued parts. The stores module 415 plugs-in to the main shop module 413 and to the other associated sub-modules 414 and 416 to render a present time requirement versus availability view to the management. The stores module 415 determines availability based on the total number of finished parts available on a shop floor. The stores module 415 determines the present time requirement, for example, from demands placed by different shops for parts required to either repair the part or replace non-repairable parts. The stores module 415 determines the availability from an inventory system that indicates the current stock of all parts available at the store. The requirement versus availability view comprises any parts procured against a requirement categorized and binned with suitable tags and aids management and planning against work scopes and associated hardware and implementation services. Based on part dispositions extracted out of the shop module 413, the operations management engine 412 tracks any repair plan issued for an outside vendor to fulfillment even when the part moves out of MRO premises. In an embodiment, the operations management engine 412 implements a wireless tracking technology, for example, Bluetooth low energy (BLE)-based tracking technology, for recording and tracing locations of the parts and availability for kitting on their arrival back from vendor repair shops. In an embodiment, the stores module 415 is used in forecasting part requirement projections in conjunction with the AI & ML engine 417. The stores module 415 operates with associated hardware and implementation services of the operations management engine 412. The data collected by the stores module 415 is further utilized in the AI & ML engine 417 for generated AI & ML-based predictable and actionable insights for each machine asset and all associated parts thereof.

In an embodiment, the cost module 416 is configured as an actual cost and profitability module for plugging revenue leakages and managing spend data relating to direct or indirect costs associated with each shop induction such as labor, material, inventory, in-house repairs, outside vendor (OV) repairs, time value associated with delays, sales, general, admin, travel, purchases, training, finance, common costs, recruitment, rent, annual maintenance contracts (AMCs), other miscellaneous costs, etc. The cost module 416 develops a holistic view of actual earnings and profitability of a business based on various contract types. The cost module 416 receives multiple inputs, for example, effort involved and parts and material required to repair a part; cost of repair from an external vendor based on bill from the vendor, etc. The cost module 416 calculates the profitability of each machine asset based on costs incurred and the profitability targets for the machine asset in accordance with goals of a facility. Operational efficiency is related to the work being done versus resources available versus if the work is being completed on time based on a planned schedule. The cost module 416 operates with the shop module 413 and the SLA/KPI module 414, in communication with the AI & ML engine 417, for forecasting operational efficiency and profitability targets based on induction type.

In an embodiment, the AI & ML engine 417 is configured as an AI & ML-enabled forecasting module configured to forecast work scope and machine asset performance post maintenance based on self-learning algorithms and factors affecting performance. In an embodiment, the AI & ML engine 417 implements a self-learning correlation between a historical exhaust gas temperature (EGT) margin deterioration trend from the field and posts overhaul historical margin gain. The AI & ML engine 417 implements an inbuilt deterioration model with rolling average trending and multivariate analysis at an asset high power performance band, that is, takeoff (TO) thrust of a machine asset, for example, an aircraft engine or an aero engine. The AI & ML engine 417 utilizes the inbuilt deterioration model for predicting EGT margin gain for any incoming machine asset in the type rating.

In another embodiment, the AI & ML engine 417 is configured as an AI & ML-enabled business management module configured to perform prescriptive cost impact analysis including cost savings achieved. The AI & ML engine 417 executes prescriptive analytics and self-learning algorithms. The AI & ML engine 417 gathers current and historical data from the modules of the operations management engine 412, for example, the shop module 413, the SLA/KPI module 414, the stores module 415, and the cost module 416 for generating correlations and carrying out impact calculations from past actions. Being prescriptive, the AI & ML engine 417 generates the best and alternate solutions for a similar problem in the past using a multivariate analysis that predicts cost and time impact.

The AI & ML engine 417 correlates and creates relationships from the operational data generated by dynamically tracking each part of the machine asset, tasks performed on each part, and turnaround time through each stage of the cycle of operations in real time using the corresponding reusable tag linked to the order identifier and the work scope information. In the method disclosed herein. AI is used in creating relationships from the operational data history. These relationships are in the form of curves that are read at various points, for example, effect of outside air temperature (OAT) on a thrust and exhaust gas temperature (EGT) margin during take-off from a particular pressure altitude. In an embodiment, AI is used in work scope forecasting. There are various levels of maintenance and production operations, for example, a minimum level, a performance level, and full overhaul. For performance level work scope, the operations management engine 412 analyzes flight data and MROs test cell ship set data of the operators for past performance gain in terms of similar work scopes. If the predicted gain from the model is less than the desired EGT margin, then a full overhaul is recommended. The operations management engine 412 considers the following factors affecting performance of a machine asset, for example, an aircraft engine: (1) hardware distress due to particle accumulation, increased tip clearances, seal leakages, airfoil erosion, etc.; (2) flight operations and environments where aircrafts are operated such as hot/desert, temperate, corrosive climate, etc., where a harsher environment results in higher deterioration and loss of performance; (3) thrust rating/derate where a derated machine asset offers more EGT margin and extended revenue operations; (4) flight leg, where a longer flight leg has lower deterioration with respect to EGT; and (5) aircraft engine age, that is, first run or mature run, as a new aircraft engine deteriorates slower than older engines.

In an embodiment, the AI & ML engine 417 implements an AI-based deterioration model. Deterioration of a machine asset, for example, an aircraft engine, is indicated by the EGT margin, loss which is reflective of hardware distress. Whenever an aircraft engine is planned for maintenance, its operations history is first fed into this AI-based deterioration model which already has similar data from other engines. The history comprises, for example, the last 50-100 cycles of performance readings, where one cycle is from take-off and landing. The performance readings comprise, for example, thrust, derate, engine pressure ratio, bleeds environmental control system (ECS), fuel flow rate, compressor pressure ratios, temperatures at various stations, mass flow, etc. These performance readings are segregated in various power bands from high power, that is, take-off, to low power, that is, flight idle. The AI-based deterioration model compares similar deterioration profile engines and trends the data and EGT recovery to predict EGT gain that can be achieved.

The operations management engine 412 executes multiple steps for performing estimations and predictions for machine asset maintenance and production operations. In an embodiment, the operations management engine 412 executes the steps comprising: (1) gathering data from multiple data sources; (2) preparing data; (3) modelling data; (4) training; (5) evaluation; (6) parameter tuning; (7) prediction and alert generation; and (8) continuous improvement. In step (1), the operations management engine 412 gathers data from multiple data sources, for example, ERP systems, manufacturer and regulator sources, airline operators, and the fixed and mobile tag readers of the system 400 disclosed herein. For example, the operations management engine 412 gathers data related to scheduling, planning, inventory, vendors, contracts, and maintenance data from the ERP systems; data related to airworthiness (AW) directives, service bulletins, etc., from the manufacturer and regulator sources: flight data with cycles and sectors, past maintenance work documents, etc., from airline operators; and real-time data from shop floors via the fixed and mobile tag readers. In step (2), the operations management engine 412 transforms, cleans, consolidates, and prepares the gathered data for loading into the AI & ML engine 417.

In step (3), the AI & ML engine 417 executes a model, for example, a regression model for machine learning. The AI & ML engine 417 segments the data for training and evaluation of quality of prediction. In an embodiment, by executing a single or multiple linear regression model, the AI & ML engine 417 performs statistical regression analysis for determining causal relationships between descriptive, independent variables—x and the described, dependent variable—y. In multivariable linear regression analysis, the relationship between variables is represented by the following formula:

y=β₀+β₁x₁+β₂x₂+. . . +βₖxₖε

where y, x₁, x₂, . . . , xₖ represent observable values; βⱼ represents the regression coefficients where j=0, 1, . . . k; βₖ represents an expected change in “y” for unit changes in xₖS; and ε represents an error.

To estimate the regression coefficients βⱼs, in an embodiment, the AI & ML engine 417 implements a least squares method that minimizes a sum of squares due to error terms using the following formula:

Min Σε²=Min Σ(y−(β₀+β₁x₁+β₂x₂+. . . +βₖxₖ))²

After minimizing the sum of squares due to error terms, the AI & ML engine 417 obtains the regression coefficients using the following formula:

\hat{β}=(X′,X)⁻¹X′y

In step (4), the AI & ML engine 417 uses training data for training the model with input data comprising, for example, the condition of the parts, number of hours, usage data, etc. The training data further comprises expected output data, for example, associated with components that need repair, type of repairs and replacement parts required, etc. In step (5), the AI & ML engine 417 evaluates the output of the trained model, that is, the predicted values against actual values. The AI & ML engine 417 then uses the difference or delta between the predicted values and the actual values for changing weights in the step of parameter tuning. Measuring accuracy of the trained model depends on how close the prediction values are to the actual values observed. If the trained model is successful in predicting the actual values, the prediction error is relatively low. The accuracy of the trained model is determined using different methods. In an embodiment, the accuracy of the trained model is determined using an R² determination coefficient computed as follows:

$${R}^{2} = 1 - \frac{{\sum }_{i = 1}^{n} {( {y}_{i} - {x}_{i} )}^{2}}{{\sum }_{i = 1}^{n} {( {y}_{i} - {\overline{y}}_{i} )}^{2}}$$

where “n” refers to the number of observations; “y” refers to the actual values; “x” refers to the predicted values; and “y̅” refers to an average actual value.

In another embodiment, the accuracy of the trained model is determined using a mean absolute percentage error (MAPE) computed as follows:

$${R}^{2} = \frac{{\sum }_{i = 1}^{n} ( \frac{\vert {e}_{t} \vert}{{y}_{t}} )}{n} \times 100 ( \% )$$

where eₜ=yₜ−xₜ; yₜ refers to an actual observation value; xₜ refers to a prediction value; “n” refers to number of observations in a prediction period; and eₜ refers to a prediction error in “t” period.

In step (6), the AI & ML engine 417 performs parameter tuning by adjusting the weights of each node in the trained model to minimize the error between the predicted values and the actual values. In step (7), the AI & ML engine 417 deploys the trained model in production for ingesting data for incoming parts and generating predictions based on interactions with individual modules, for example, the shop module 413, the SLA/KPI module 414, the stores module 415, and the cost module 416 of the operations management engine 412 as disclosed below. The operations management engine 412 triggers alerts based on business requirements and thresholds set for the individual modules, for example, 413, 414, 415, and 416 in the system 400. Alerts are generated based on anomalies in machine asset data. Every machine asset comprises sensors that collect data and this data is available for incoming machine assets. Additional data on where the machine asset has travelled and for how long is available with the operators who operate the machine asset. The operations management engine 412 imports this machine asset data from the operators in a digital format. Once the machine asset data is imported and once data from previous machine assets that came in is available for training the model, the AI & ML engine 417 uses the current incoming machine asset parameters, for example, EGT margin, number of cycles, conditions in which the machine asset was operated and at what level, and speed, to then model the type and extent of repair that is necessary. Additional repair may be necessary once the machine asset is dismantled. The AI & ML engine 417 captures this additional repair requirement and the delta of additional work that was done to continuously improve the prediction model. In step (8), the operations management engine 412 matches the suggested repairs for the parts of the machine asset and captures actual data during the actual repair process which is fed into the AI & ML engine 417 as a feedback loop to further optimize the prediction of repairs and costs.

In an, embodiment, the AI & ML engine 417, in operable communication with the shop module 413, analyzes real-time movement of each part of a machine asset, for example, an aircraft engine, at each stage of the cycle of the operations associated with the maintenance and/or the production of the machine asset and measures the real-time movement against the planned turnaround time received from a planning department or planner. In an embodiment, by executing a regression model, the AI & ML engine 417, in operable communication with the shop module 413, implements a work scoping method by creating correlation, for example, between operator geography, flight leg (FL), flight cycles (FC), life-limited parts (LLP) cycles, engine Berate (ED), take-off exhaust gas temperature margin (EGTM), etc. The AI & ML engine 417, in operable communication with the shop module 413, performs an evaluation of historic unscheduled removals using the following formula:

$${\sum }_{S V = 1}^{n} U S {R}_{P N} = R U P {N}_{S V}$$

where USR refers to unscheduled removal; RUPN refers to replaced unique part number; CSLR refers to cycles since last replacement; and CSN refers to cycles since new.

In another embodiment, the AI & ML engine 417, in operable communication with the shop module 413, performs an evaluation of historic unscheduled removals per cycle of a unique part number using the following formula:

$$R {R}_{P N} = \frac{C S N}{\sum replacements}$$

where RR refers to a rate of replacement.

In another embodiment, the AI & ML engine 417, in operable communication with the shop module 413, calculates probability of an unscheduled removal for a unique part number using a Bayesian hypothesis as follows:

$$P ( USR \vert cycles ) = \frac{P ( cycles \vert USR ) \cdot P ( USR )}{P ( cycles )}$$

In another embodiment, the AI & ML engine 417, in operable communication with the shop module 413, implements a scope creep probability method as follows:

If present ‘cycles’>‘RR’, SC=W0+(RR_{PN1}+RR_{PN}+. . . +RR_{PNn})

where SC refers to scope creep and WO refers to initial planned scope.

In another embodiment, the AI & ML engine 417, in operable communication with the shop module 413, performs an evaluation of critical part unscheduled removals and performs delay mapping as follows:

$${\sum }_{Part = 1}^{n} {Delay}_{part} = {OV}_{part} + {IH}_{{ }^{part}} + {NP}_{part} + {WS}_{part}$$

where OV refers to vendor repair time; IH refers to inhouse repair time; NP refers to new procurement time; and WS refers to new work scope consent.

In another embodiment, the AI & ML engine 417, in operable communication with the shop module 413, performs an evaluation of real-time task delay as follows:

Σₚₐᵣₜ₌₁ⁿRTPD=Delayₚₐᵣₜ+(β₀+β₁(parm)₁+. . . +βₖ(parm)ₖ+ε)

where RTDP refers to real-time part delay and the parameters (parm) comprise a task fulfillment time (TF), a task start time (TS), and a task assigned time (TA).

$$Total RT delay = {\sum }_{asset}^{n} {RTPD}_{asset}$$

In another embodiment, the AI & ML engine 417, in operable communication with the shop module 413, forecasts exhaust gas temperature (EGT) gain for any incoming machine asset using an EGT prediction method comprising operational deterioration and computation of post-maintenance performance gain. Consider an example where the AI & ML engine 417 receives take-off (TKOF) performance EGT values for a data sample size (n) of 1000 from an airline engine health management (EHM) database, while excluding data with reported surge, hot start, and fuel flow snags. In this example, the level of significance is taken as <0.02 or a confidence interval >98% with the following operational data utilization pattern: 70% train, 20% test, and 10% validation.

EGT_{predicted}=β₀+β₁(parm)₁+β₂(parm)₂+. . . +βₖ(parm)ₖ+ε

where ε refers to an error and the parameters (parm) comprise spool speeds (N), thrust derate (TD), outside air temperature (T0), maximum take-off thrust (MTKOF), take-off EGT measured, gross take-off weight (GTOW), life-limited part's cycles (LLPC), and cycles since last overhaul (CSO).

The AI & ML engine 417, in operable communication with the shop module 413, models CSO wise EGT deterioration for prediction and validates the CSO wise EGT deterioration with the actual EGT measured. The AI & ML engine 417 then uses the resulting, predicted EGT for the airline operator in predicting the future deterioration levels from the operational cycles and in predicting the next shop visit. Consider an example where the AI & ML engine 417 receives TKOF performance EGT values for a data sample size (n) of 50 for an aero-engine type at a test cell for overhauled engines, from the airline EHM database. In an embodiment, the AI & ML engine 417 models the measured EGT as linear regression for performance retention (PR) at level-1 using the following formula:

Σ_{PR=1}ⁿEGT_{PR}=β₀+β₁(parm)₁+β₂(Parm)₂+β₃(Parm)₃+β₄(Parm)₄+ε

In another embodiment, the AI & ML engine 417 models the measured EGT as a linear regression for life-limited parts (LLP) replacement (overhauled/OH) at level-2 using the following formula:

Σ_{OH=1}ⁿEGT_{OH}=β₀+β₁(parm)₁+β₂(parm)₂+β₃(parm)₃+β₄(parm)₄+ε

where ε refers to an error and the parameters (parm) comprise a fan and low-pressure compressor (FAN±LPC), a core (high-pressure compressor, combustor, high-pressure turbine), a low-pressure turbine (LPT), and an accessory gear box (AGB).

In an embodiment, the AI & ML engine 417, in operable communication with the shop module 413, computes EGT gain and the predicted EGT margin as follows:

EGT_{gain}=EGT(TKOF)_{OH or PR}−EGT(TKOF)_{OPS}; and EGT_{Pred.margin}=EGTMβx(TKOF)_{mfr}−EGT(TKOF)_{OH or PR}

wherein “mfr” refers to manufacturer; OPS refers to operations; and EGTMax refers to the corner point EGT at TKOF thrust.

In an embodiment, the AI & ML engine 417, in operable communication with the SLA/IPI module 414, receives data from job/task cards issued, loaded, and completed throughout the maintenance or production operations and calculates shop operational efficiency, for example, on a quarterly moving average or selected period, on the parameters below.

$${η}_{load} = \frac{{Σ}_{i = 0}^{n} Task Card {Loaded}_{i}}{{Σ}_{i = 0}^{n} Task Card {Assigned}_{i}}$$

where the task card assigned is [>or =] task card loaded.

$${η}_{delivery} = \frac{{Σ}_{i = 0}^{n} Task Card {Completed}_{i}}{{Σ}_{i = 0}^{n} Tasks Card {Loaded}_{i}}$$

where the task card completed is [<or =] task card loaded, and where the cumulative moving average (CMA) and the cumulative quarterly moving average (CQMA) for SLA/KPI are computed as follows:

$${CMA}_{n} = \frac{{x}_{1} + {x}_{2} + ⋯ + {x}_{n}}{n} ; and$$

$${CQMA}_{n + 1} = \frac{{x}_{n + 1} + n \cdot {CMA}_{n}}{n + 1}$$

The cost module 416 of the operations management engine 412 captures data, for example, customer data and contract details with service-level agreements (SLAs). The cost module 416 categorizes contracts, for example, in power by the hour (PBTH), pay as you go/time and material (T&M) pricing, and volume-based categories. The cost module 416 determines direct maintenance costs (DMCs) for each type of contract as follows:

DMC=ƒ(workscope)

In an embodiment, the cost module 416 computes direct maintenance cost (DMC) for performance retention (PR) scope using the following formula:

$${\sum }_{SV = 1}^{n} {DMC ( PR )}_{SV} = {\sum }_{SV = 1}^{n} {L}_{SV} + {M}_{SV} + {R}_{SV}$$

where L refers to labor; M refers to material; and R refers to repairs.

In another embodiment, the cost module 416 computes direct maintenance cost (DMC) for life-limited parrs cycle (LLPC) replacement/overhaul (OH).

$${\sum }_{SV = 1}^{n} {DMC ( OH )}_{SV} = {\sum }_{SV = 1}^{n} {L}_{SV} + {M}_{SV} + {R}_{SV}$$

where L refers to labor; M refers to material; and R refers to repairs.

In another embodiment, the cost module 416 computes direct maintenance cost for minimum level (ML)

$${\sum }_{SV = 1}^{n} {DMC ( ML )}_{SV} = {\sum }_{SV = 1}^{n} {L}_{SV} + {M}_{SV} + {R}_{SV}$$

where L refers to labor; M refers to material; and R refers to repairs.

After determining the direct maintenance costs, in an embodiment, the cost module 416 determines indirect maintenance cost/common costs with the common cost (CC) apportionment as follows:

$$C C = f ( SV Capacity ) ;$$

$${\sum }_{M 1}^{12} CC = {\sum }_{M = 1}^{12} {FC}_{M} + {Ovr}_{M} + {Adm}_{M} + {MR}_{M} ; and$$

$${CC}_{SV} = {\sum }_{M 1}^{12} \frac{CC}{SV}$$

where SV refers to shop visits; FC refers to facilities; Ovr refers to overheads; Adm refers to administration; and. MR refers to maintenance reserves—spare assets.

In an embodiment, the cost module 416 performs profitability algorithm calculations using the following formulas:

$${\sum }_{SV = 1}^{n} {TC}_{SV} = {DMC}_{SV} + {CC}_{SV} ; and$$

$${OPM ( \% )}_{SV} = \frac{{Rev}_{SV} - {TC}_{SV}}{{Rev}_{SV}} \times 100$$

where TC refers to total cost and Rev refers to revenue.

In an, embodiment, the AI & ML engine 417, in operable communication with the cost module 416, implements training and correction by updating and correcting the model if any changes are made to the input variables, and predicts most profitable contract types and customers.

The stores module 415 of the operations management engine 412 generates and assigns a tag, for example, a radio-frequency identification (RFID) tag to each part or inventory item for identification in the system 400. The stores module 415 also generates and assigns a tag to associated racks and bins in stores to indicate the locations of the parts in the corresponding stores. The stores module 415 then groups each part or inventory item, for example: by type of machine asset for which the part is used; by class of inventory such as replaceable items, bulk parts, standard replacement kits, etc.; by customer based on customer contract, as long-term maintenance contracts with different inventory approaches versus short-term contracts; by value and volume of the inventory, that is, high value-low volume to low value-high volume; and by status, that is, serviceable, unserviceable, scrap, awaiting disposition, etc., and quantified as blocked capital, for example, in “S” terms.

In an embodiment, the AI & ML engine 417, in operable communication with the stores module 415, achieves high service levels at the lowest cost of inventory holding and stores management as follows. The AI & ML engine 417, in operable communication with the stores module 415, determines the right service levels for the inventory based on shop loading using the following formula:

$$Service Level ( fill rate ) = \frac{Total Throughput}{Total Shop Load}$$

The AI & ML engine 417, in operable communication with the stores module 415, then predicts a “just-in-time” buying time, for example, based on the consumption, fill rate, scrap rate, and replenishment lead time (RLT) pattern using the following formulas:

$$Service Factor = 1.64 at 95 \% Service Level ( From staistical CDF tables ) ;$$

$$Safety Stock = Std . Dev \times Service Factor \times Lead Time Factor ;$$

$$Lead Time Factor = \sqrt{\frac{Lead Time}{Forecast Period}} ;$$

$$LT Demand = DD \times RLT ; and$$

$$Re \text{-} order Point = LT Demand + Safety Stock$$

where RLT refers to replenishment lead time from the vendor and DD refers to daily demand based on usage data.

The AI & ML engine 417, in operable communication with the stores module 415, then determines work-in-progress (WIP) support inventory levels, that is, the minimum inventory to take up the maintenance work using the following formulas:

$$Total Inventory = WIP ( work \text{-} in \text{-} progress ) + {\sum }_{x = 1}^{n} Store Stock x ; and$$

$$WIP = \frac{Removals per day or period}{Total days or period} \times TAT$$

The AI & ML engine 417, in operable communication with the stores module 415, then forecasts what and how much to be procured and computes an economic order quantity (EOQ) for the work scope contracts in hand using the following formula:

$$EQQ = \sqrt{\frac{2 X Annual Demand \times Order Cost}{Holding Cost \% \times Cost Per Unit}}$$

The AI & ML engine 417 performs training and correction of all the statistical data points gathered above periodically. For example, if a change/variation in inventory usage is detected, the AI & ML engine 417 self-corrects the trained AI & ML model for accommodating the changed variables and recreates the forecast. The operations management engine 412 generates a visualization of critical data points through visualization components, for example, statistical box charts, trend charts, bar/column charts, etc. The operations management engine 412 also generates and renders messages and alerts from one or more of the individual modules 413, 414, 415, and 416. For example, the operations management engine 412 generates and renders messages and alerts from the stores module 415 as service levels go down or a re-order point is reached.

FIGS. 6A-6B illustrate a flowchart showing, an exemplary implementation of the artificial intelligence (AI) & machine learning (ML) engine 417 for forecasting projections of multiple operational elements associated with maintenance and/or production of a machine asset, for example, an aircraft engine, and for generating predictable and actionable insights 614 for each of the operational elements, according to an embodiment herein. The AI & ML engine 417 receives inputs 601 associated with maintenance actuals 602 and performance data 615 from individual modules comprising the shop module 413, the stores module 415, the cost module 416, and the service-level agreement (SLA)/key performance indicator (KPI) module 414 of the operations management engine and from different operators 616, 629, and 631 respectively as illustrated in FIGS. 6A-6B. The maintenance actuals 602 and performance data 615 are also herein referred to as “operational data”. The individual modules of the operations management engine communicate the following maintenance actuals 602 to the AI & ML engine 417. The shop module 413 determines and communicates repair activities 603, time per engine or module repair 604, type and number of unscheduled repairs and their pattern 605 to the AI & ML engine 417. The cost module 416 computes and communicates direct maintenance costs 606 and indirect maintenance costs 607 to the AI & ML engine 417. The stores module 415 determines and communicates what was ordered for the machine asset 608 and what went, out for repairs 609 to the AI & ML engine 417. The SLA/KPI module 414 determines and communicates shop productivity based on parts' load for maintenance 610, time taken per activity/task 611, and time allocated by a planner versus actual time taken 612 to the AI & ML engine 417.

The operators, for example, operator X 616, operator Y 629, and operator Z 631, generate and communicate performance data 615 to the AI & ML engine 417 as follows. For example, operator X 616 communicates performance data associated with a machine asset, for example, aircraft engine 1 with specific type or thrust 617; ambient climatic conditions 618 such as ambient pressure (PAmb), ambient temperature (TAmb), take-off (TKOF) altitude, etc.; engine derate 619; average flight leg 620; total cycles (first/mature) run 621; exhaust gas temperature (EGT) 622; spool speeds 623; pressures and ratios 624 such as engine pressure ratio, fan pressure ratio, compressor pressure ratios, etc.; mass flow 625; fuel consumption 626; thrust specific fuel consumption 627; various engine temperatures 628 namely T25, 13, T4, T45,15, etc., to the AI & ML engine 417. The AI & ML engine 417 receives similar data 630 and 632 as that communicated by operator X 616, from operator Y 629 and operator Z 631. Operator X 616 continues to communicate engine data 633 of other engines, for example, engine 2, engine 3, . . . , engine N, having similar type thrust as engine 1 to the AI & ML engine 417. The AI & ML engine 417 processes the received maintenance actuals 602 and performance data 615 as disclosed in the detailed description of FIG. 5, performs a correlation of past performance data with past shop actual repairs, and generates output data 613. The output data 613 conveys multiple predictable and actionable insights 614, for example, possibility of additional repairs, possible failures, possible delays, possible snags, possible replacements, possible time consumption, possible cost impact, etc., for facilitating informed decision making for managing inventory, parts ordering, repairs, performance, and efficiency of a facility, thereby optimizing management of operations associated with maintenance and/or production of a machine asset.

FIGS. 7A-7D exemplarily illustrate screenshots of graphical user interfaces (GUIs) 701, 702, and 703 rendered by the operations management engine for managing user accounts in the system, also referred to as the “operations tracking system”, for optimizing management of operations associated with maintenance and/or production of a machine asset, according to an embodiment herein. As disclosed in the detailed description of FIG. 5, in an embodiment, the operations management engine is accessible via a web application such as a web browser, deployed on a user device on the network illustrated in FIG. 4, using enterprise resource planning (ERP) user credentials. In an embodiment, the web application manages functions comprising, for example, user authentication, user dashboards, user and role management, parts workbench management, scheduling, audit logging, and reporting of the operations tracking system. The web application allows a user, for example, an administrator, to log into the operations tracking system and access the operations management engine using an ERP user authentication system 410a illustrated in FIG. 4. FIG. 7A exemplarily illustrates a screenshot of the GUI 701 rendered by the operations management engine for logging into the operations tracking system. The operations tracking system creates a system administration (admin) user and an administrator account automatically with full access when the operations tracking system is installed. The operations tracking system, accessible via the web application, allows the administrator to create new user roles and user accounts via the GUIs 702 and 703 exemplarily illustrated in FIGS. 7B-7D. The operations tracking system allows the administrator to create user accounts in the operations tracking system for assigning roles and permissions within the operations tracking system. The operations tracking system integrates user creation with ERP users. The operations tracking system allows the system admin user to create a new user by specifying a username and a role to be assigned to the user on the GUI 702 exemplarily illustrated in FIG. 7B, and then registers the new user. In an embodiment, the operations tracking system associates each new user with an employee identifier or number, that is printable on an employee identification (ID) card as a barcode. The barcode allows the user to quickly login onto a tag reader or a mobile terminal by scanning the barcode.

The operations tracking system supports the creation of new roles with a combination of predefined access levels to each of the individual modules, for example, the shop module, the stores module, the service-level agreement (SLA)/key performance indicator (KPI) module, and the cost module of the operations management engine. The operations tracking system allows addition of different permissions or privileges to a role via the GUIs 703 exemplarily illustrated in FIGS. 7C-7D. The permissions comprise, for example, addition, editing, and deletion of an organization; addition, editing, deletion, and changing password of a user; addition, editing, and deletion of a role; viewing of import logs; viewing of audit logs; viewing reports; individual report permission; viewing of dashboards; mobile permissions; parts tagging; part tag deactivation; updating location; etc. During login, the ERP user authentication system authenticates password and validity of the user accounts of ERP users and then applies the roles and the permissions from the operations tracking system. In an embodiment, any user deactivated in the ERP user authentication system is automatically deactivated in the operations tracking system. In an embodiment, the operations management engine configures dashboards as per a user's role. The operations management engine adds multiple dashboard pages to a user's profile. In an embodiment, by default, each role is associated with the dashboard configuration, which is customizable by each user.

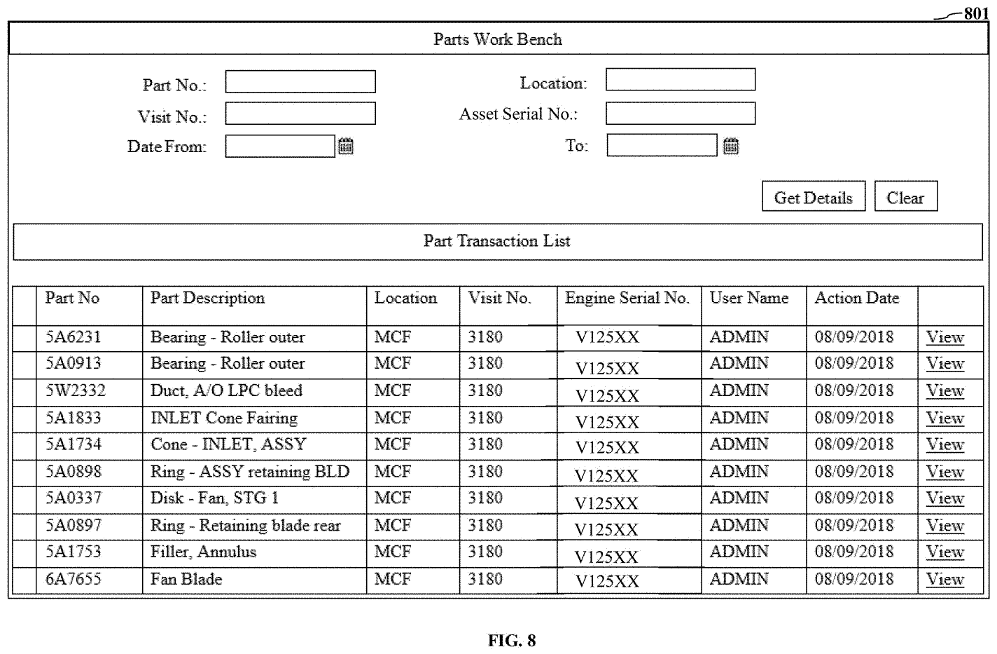

FIG. 8 exemplarily illustrates a screenshot of a graphical user interface (GUI) 801 rendered by the operations management engine for accessing parts information, according to an embodiment herein. The operations management engine, via the GUI 801, allows a user to query and view parts information and check the status of each part of a machine asset by querying multiple parameters comprising, for example, visit number, part number, asset serial number, location, status of each part, etc. The operations management engine, via the GUI 801, also allows the user to query and view job cards by multiple criteria such as tag number, job number, module or part, serial number, visit number, etc., and by status and departments. The operations management engine, via the GUI 801, allows the user to view parts history leading to a current status, for example, part induction information, parts movement, and last transactions on each part by drilling down on search results rendered on the GUI 801.

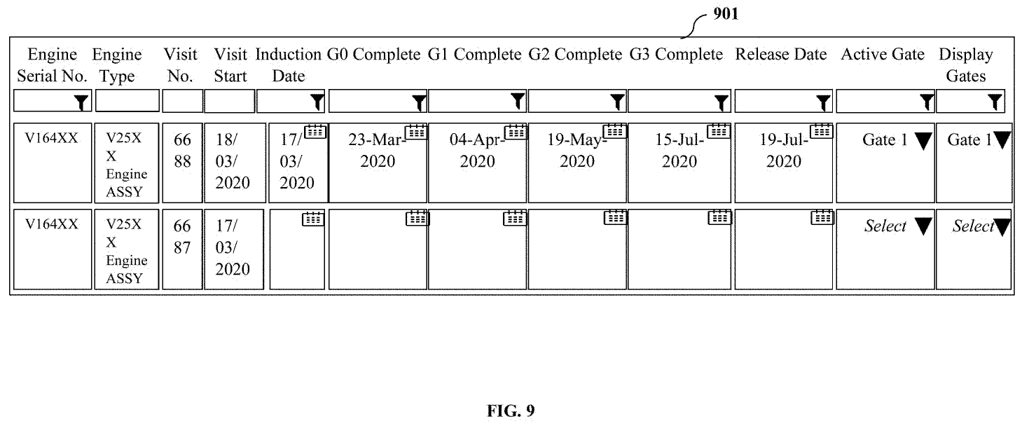

FIG. 9 exemplarily illustrates a screenshot of a graphical user interface (GUI) 901 rendered by the operations management engine for optimizing the management of operations associated with maintenance and/or production of a machine asset with enhanced visibility, according to an embodiment herein. In an embodiment, the operations management engine executes an import or upload function for allowing one or more users, for example, a production planning team or an administrator to upload machine asset-related information that is not stored in, the enterprise resource planning (ERP) system. The operations management engine allows the user to upload electronic documents, for example, spreadsheet files of a specified format, for example, a Microsoft® Excel® format of Microsoft Corporation, containing operational data to the operations tracking system to facilitate generation of reports and dashboards that allow planning and provide visibility of the status of a machine asset. In an embodiment, the operations management engine stores the operational data in the application database.

In an embodiment, the operations management engine allows the user to upload machine asset schedules by modules from stripping or disassembly to reassembly and by tasks comprising, for example, stripping, dispositions, internal and external repair, etc., linked to data generated in the ERP system. The tasks are linked, for example, to job cards, routine cards, non-routine cards, external repair orders (ROs), or disposition in the operations tracking system. The operations management engine renders a template for uploading the machine asset schedule configured, for example, in the form of a streamer schedule. In an embodiment, the template for uploading the machine asset schedule does not include coordination meetings, customer or internal approvals, or any tasks that cannot be directly linked to a card or a status within the ERP system. In an embodiment, the machine asset schedule links to job cards and schedules for each gate and module of the machine asset. En another embodiment, the machine asset schedule is derived from a manufacturer's documentation as a one-time process for each type of machine asset. The machine asset schedule forms the basis for modules, their break down, and all parts in the modules and sub-modules.

In another embodiment, the operations management engine allows the user to upload a strip plan comprising a schedule and an order of stripping parts of a machine asset by a module that is linked to a pre-inspection card. The operations management engine renders a template for uploading the strip plan. All job cards linked to a machine asset visit number, for example, an engine visit number, referenced in the strip plan are assigned expected start and end dates based on a module of the machine asset. The name of the module on the strip plan is configured to be the same as that defined in the ERP system to establish a link between the pre inspection card and the schedule defined in the strip plan. In an embodiment, the strip plan is derived from a third party work scope system or is created in the operations tracking system based on maintenance templates that a user can customize before uploading or assigning the strip plan to an incoming machine asset. The strip plan minimizes the time required to create numerous repair steps as pick and choose based on work scope received from a customer. For each machine asset, the operations management engine displays information of a visit, for example, visit number, visit start date, etc., induction date, completion dates of the stages represented as “gates” in the cycle of maintenance and/or production operations, release dates, active gates, and display gates on the GUI 901 as illustrated in FIG. 9. The information displayed by the operations management engine on the GUI 901 allows monitoring of the maintenance and/or production operations to resolve outages, delays, and bottlenecks in the system.

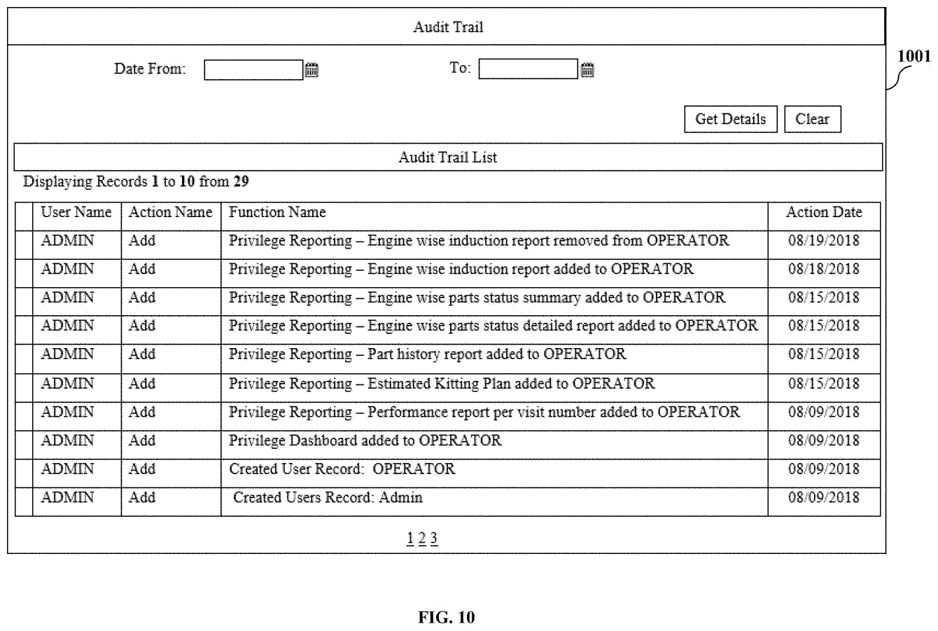

FIG. 10 exemplarily illustrates a screenshot of a graphical user interface (GUI) 1001 rendered by the operations management engine for accessing audit logs of operations associated with maintenance and/or production of a machine asset, according to an embodiment herein. The operations management engine allows a system administration (admin) user to query and drill down on actions and user activities in the operations tracking system via audit logs rendered on the GUI 1001 to determine transactions performed in the operations tracking system, including any integration related transactions. The audit logs rendered by the operations management engine on the GUI 1001 comprise, for example, date, time, user, module, and any errors, if available, on the transactions performed in the operations tracking system. In an embodiment, the operations management engine purges or deletes the audit logs after a predefined time period or moves the audit logs to an offline archive.

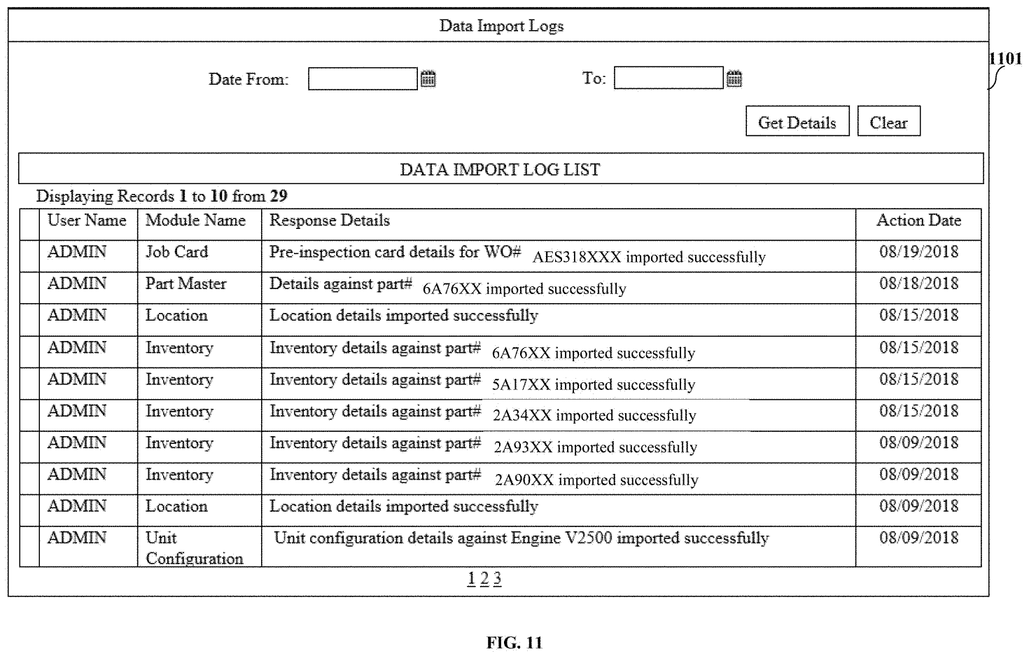

FIG. 11 exemplarily illustrates a screenshot of a graphical user interface (GUI) 1101 rendered by the operations management engine for accessing imported data logs of operations associated with maintenance and/or production of a machine asset, according to an embodiment herein. The GUI 1101 displays data import logs comprising, for example, username, module name, response details, and action date associated with data imported into the operations tracking system.

FIGS. 12A-12J exemplarily illustrate reports generated by the operations management engine for optimizing the management of operations associated with maintenance and/or production of a machine asset with enhanced visibility, according to an embodiment herein. In an embodiment, the operations management engine generates reports comprising one or more pieces of data imported or uploaded by a user to the operations tracking system. In another embodiment, the operations management engine generates reports comprising operational data generated by dynamically tracking each part of the machine asset, tasks performed on each part, and turnaround time through each stage of the cycle of operations in real time using the corresponding reusable tag linked to the order identifier and the work scope information. In another embodiment, the operations management engine generates analytics reports accessible through one or more of multiple visualization components, for example, real-time dashboards, across the cycle of operations to convey predictable and actionable insights of the analytics for optimizing the management of the operations with enhanced visibility.

In an embodiment, the operations management engine renders the generated reports based on templates preconfigured in the operations tracking system. For example, the operations management engine generates an engine-wise induction report 1201 as illustrated in FIG. 12A, an engine-wise induction summary report 1202 as illustrated in FIG. 12B, an engine-wise part status summary report 1203 as illustrated in FIG. 12C, an engine-wise part status detailed report 1204 as illustrated in FIG. 12D, a part history report 1205 as illustrated in FIG. 12E, a department-wise transaction summary report 1206 as illustrated in FIG. 12F, a department-wise transaction detail report 1207 as illustrated in FIG. 12G, an estimated kitting plan 1208 as illustrated in FIG. 12H, and performance reports 1209 and 1210 as illustrated in FIGS. 12I-12J.

The engine-wise induction report 1201 comprises, for example, parts and tag information tagged by date and user for a specific machine asset, for example, an aircraft engine, by engine serial number as exemplarily illustrated in FIG. 12A. The engine-wise induction summary report 1202 comprises, for example, parts information of each module of the machine asset, and status and percentage of task completion as exemplarily illustrated in FIG. 12B. The engine-wise part status summary report 1203 comprises, for example, the statuses of all job cards as a summary and estimated dates per module, where available, for a specific machine asset, for example, an aircraft engine, by engine serial number as exemplarily illustrated in FIG. 12C. The engine-wise part status detailed report 1204 comprises, for example, the statuses of all parts of each module and estimated dates per card, where available, for a specific machine asset by engine serial number as exemplarily illustrated in FIG. 12D.

The part history report 1205 comprises, for example, all transactions performed on a specific part by part number and serial number as exemplarily illustrated in FIG. 12E. The department-wise transaction summary report 1206 comprises a department-wise summary of transactions and job card completion within specified dates as exemplarily illustrated in FIG. 12F. The department-wise transaction detail report 1207 comprises comprehensive details of department-wise transactions and job card completion within specified dates as exemplarily illustrated in FIG. 12G. The operations management engine generates an estimated kitting plan 1208 as exemplarily illustrated in FIG. 12H, based on unit configuration, The estimated kitting plan 1208 comprises estimated and actual dates for kitting by modules. The performance report 1209 comprises number of person-hours and job cards processed by department within specified dates as exemplarily illustrated in FIG. 12I. The performance report 1210 comprises number of person-hours and job cards processed by a department for a specific visit number as illustrated in FIG. 12J. In an embodiment, the operations management engine is operably coupled to a report server for configuring and generating customized reports. The operations management engine allows a system administration (admin) user to add these customized reports to a reports list stored in the report server. In an embodiment, the operations management engine allows a user to add new report templates from the report server for reporting imported data, operational data, and analytics data.

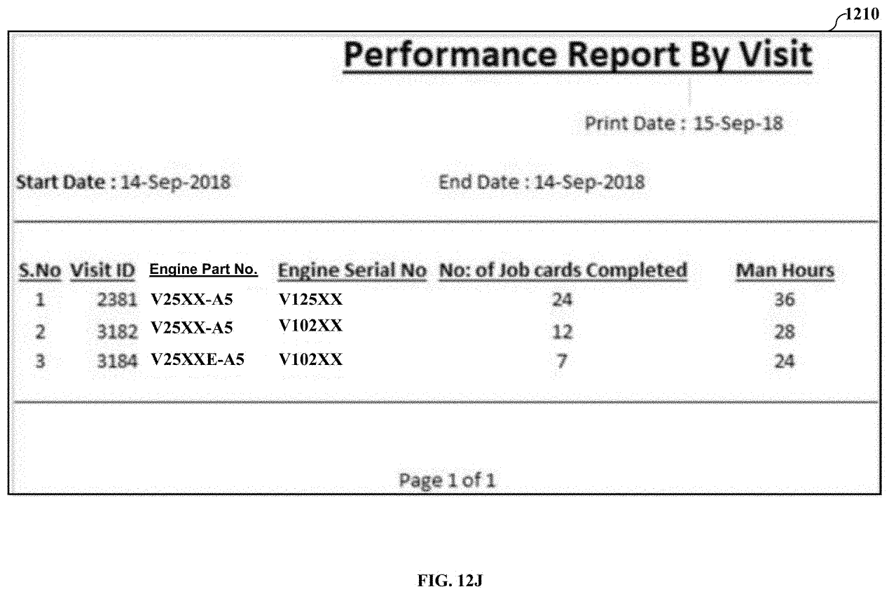

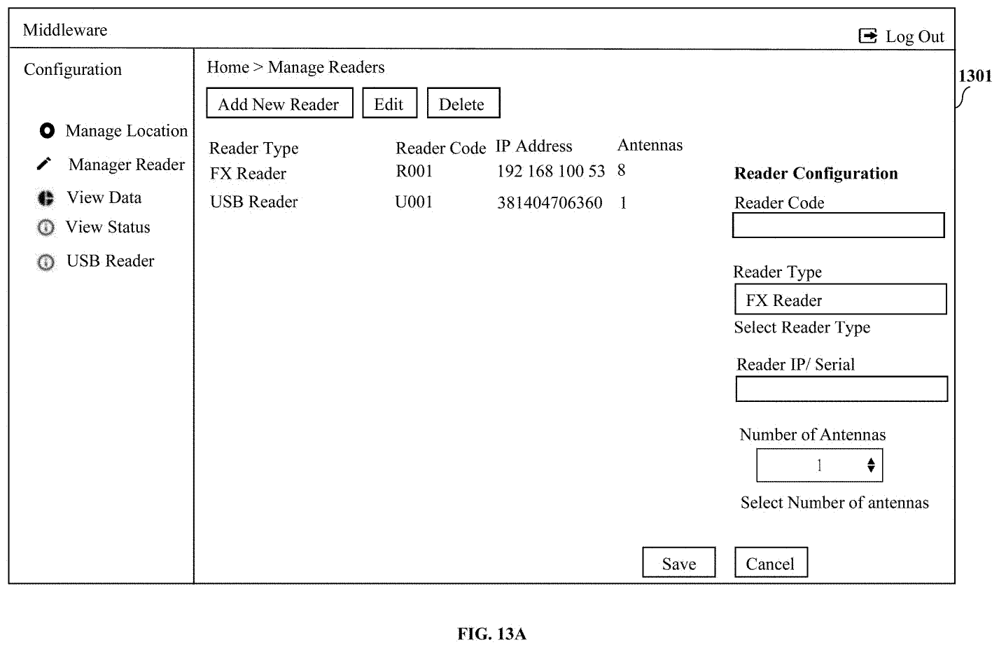

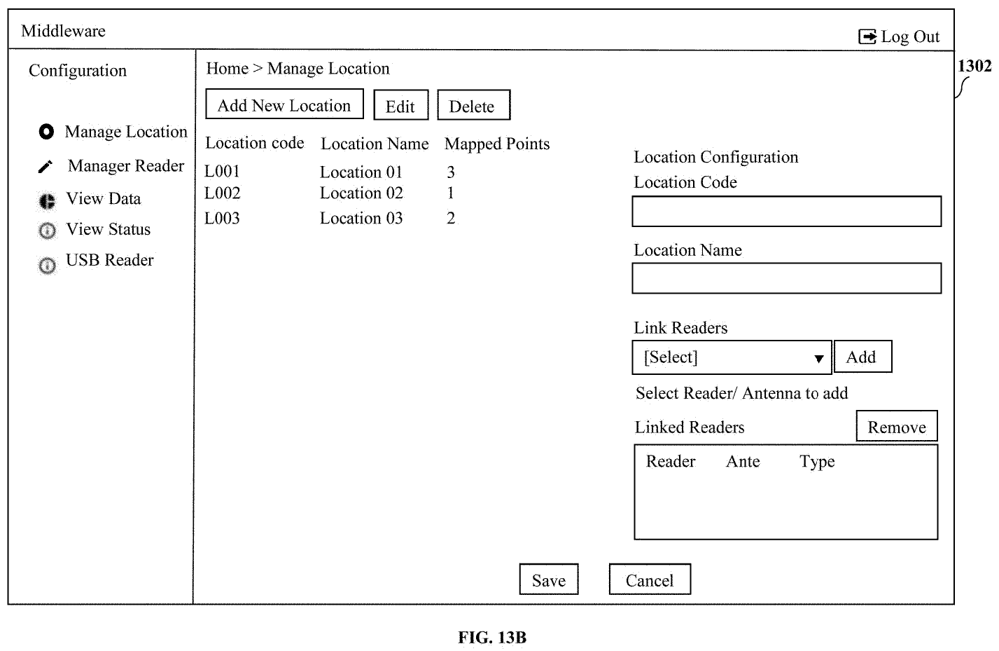

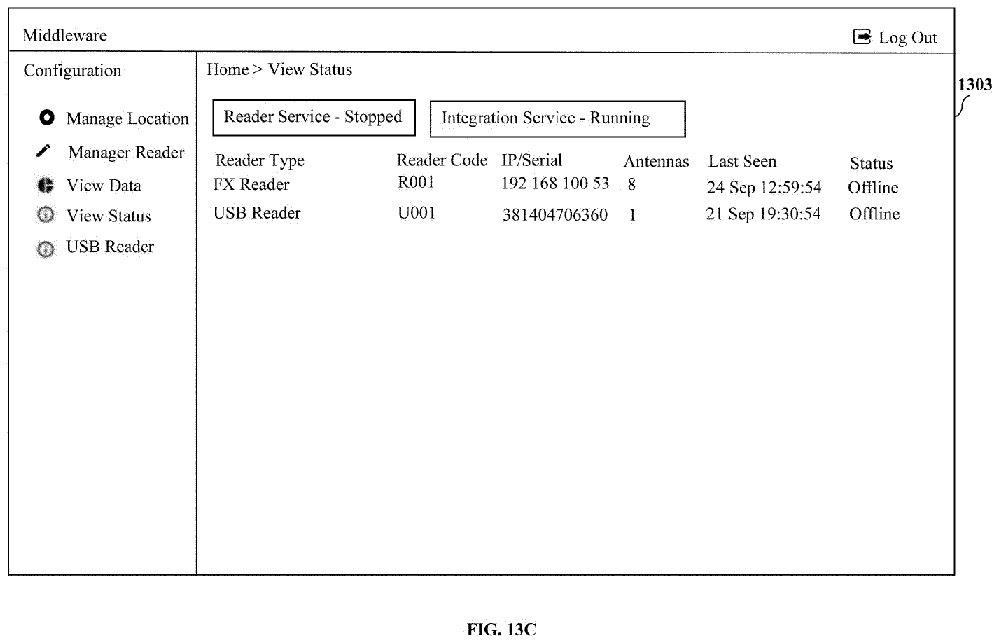

FIGS. 13A-13C exemplarily illustrate screenshots of graphical user interfaces (GUIs) 1301, 1302, and 1303 rendered by the operations management engine for managing devices implemented in the system for optimizing management of operations associated with maintenance and/or production of a machine asset, according to an embodiment herein. As disclosed in the detailed description of FIG. 4, the middleware executes data connectivity and device management functions of the operations management engine for managing the fixed and mobile tag reader(s). The middleware allows users to define the tag readers, collect reads from the tag readers, and monitor the status of each tag reader defined in the system.

The operations management engine renders a GUI 1301 as exemplarily illustrated in FIG. 13A for managing the tag readers of the system. The operations management engine, via the GUI 1301, allows a user, for example, an administrator, to add and configure tag readers of different types, for example, fixed, mobile, and desktop tag readers, in the system. The operations management engine, via the GUI 1301, allows the user to define the type, connectivity details, and the number of antennas for a multi-antenna tag reader. The operations management engine, via the GUI 1301, also allows the user to define a location(s) for the fixed tag reader(s), that allows the tags read by the tag reader to trigger an update of the location of the tags automatically in the system. The operations management engine renders a GUI 1302 as exemplarily illustrated in FIG. 13B, for managing the locations of the tag readers and the parts of a machine asset. The operations management engine, via the GUI 1302, allows the user to define the location of each part, for example, as IN or OUT, and allows the user to define whether the IN or OUT mode is automatic or semi-automatic. The operations management engine renders a GUI 1303 as exemplarily illustrated in FIG. 13C, for monitoring the status of operations and the tag readers in the system. The operations management engine, via the GUI 1303, allows users, for example, from a network operations center (CDC) team to monitor the statuses of the operations and monitor the statuses of the tag readers via the middleware application or console. If a tag reader or antenna goes offline, the operations management engine generates and transmits a notification, for example, via electronic mail (email) to the NOC' team to investigate and resolve the outage.

FIGS. 14A-14H exemplarily illustrate graphical user interfaces (GUIs) 421a-421h rendered by the mobile application deployed on a computing device 403 implemented in the system for optimizing management of operations associated with maintenance and/or production of a machine asset, according to an embodiment herein. In an embodiment, the mobile application is configured to operate on a computing device 403, for example, a radio-frequency identification (RFID)-enabled mobile device, that runs, for example, on an Android® operating system. The computing device 403 is operably coupled to a tag reader in an online mode. The mobile application, in communication with the operations management engine, is configured to execute multiple functions, examples of which comprise user authentication, for example, via a barcode scan and username/password; generation and display of a task list; tagging of parts of the machine asset based on a job card; department transfer by scanning one or more part tags; indicating a start and an end of a job task for scanned part tags; kitting verification; deactivation of tags; querying of parts by scanning tags; etc. The mobile application renders a menu with multiple options on a GUI 421a as exemplarily illustrated in FIG. 14A, for triggering the execution of the functions of the mobile application.

To execute user authentication, in an embodiment, the mobile application renders a GUI 421b as exemplarily illustrated in FIG. 14B, for allowing a user to scan an employee identification (ID) card with the barcode having an employee identifier to log in to the mobile application. In another embodiment, the mobile application allows the user to enter enterprise resource planning (ERP) user credentials, for example, a user identifier and a password to login to the mobile application via the GUI 421b exemplarily illustrated in FIG. 14B. When the employee scans the barcode, the operations tracking system determines whether the barcode is associated with any specific user, automatically logs in the user to the mobile application, and applies the necessary pei missions and profiles. When the user logs into the mobile application, the mobile application displays a list of pending tasks, if any, on a GUI. A machine asset is associated with, a maintenance plan that has job cards and tasks in each job card. Based on what tasks are completed, the remaining tasks are considered as pending. The pending tasks lists parts for which a job is started or parts that have been transferred to the user's department. The user may click on any part in the list of pending tasks to view the details and history of the part. When the user clicks on a part in the list of pending tasks, the mobile application renders a GUI 421c as exemplarily illustrated in FIG. 14C, that displays details and history of the part for viewing by the user.

At Gate 1 or the disassembly stage in the cycle of operations exemplarily illustrated in FIG. 2A, when a machine asset, for example, an aircraft engine, is dismantled, the user attaches an unused RFID tag to each part of the machine asset, for example, using a tie-clip or by sticking the RFID tag to the part and/or a job card. The user then scans a barcode on the job card and the barcode on the RFID tag to link both the barcodes in any order. When the job card is scanned, in an embodiment, the mobile application renders a GUI 421d that displays job information or work scope information as exemplarily illustrated in FIG. 14D, and populates an RFID field on the GUI 421d when the barcode of the RFID tag is scanned, In an embodiment, the mobile application prompts the user to confirm the link between the barcodes with a “Yes/No” option, and when the user confirms the linking, the mobile application stores the linked information on the tracking application server. To execute a parts transfer between departments, specialized process controllers are configured to transfer the parts between departments as per the list of tasks defined in the job card. Each controller scans the list of parts and in an embodiment, selects the location or department to which each part is being delivered on the GUI 421e rendered by the mobile application as exemplarily illustrated in FIG. 14E. The tracking application server updates the locations of the scanned parts to the location selected by the controller. The mobile application adds all transactions to the history of the movement of the parts, which can be queried at any time from the tracking application server. If a part is already assigned to a department, then the mobile application does not update the history data.

To execute kitting verification, when the user selects a machine asset or a module of the machine asset from the list, in an embodiment, the mobile application renders the list of parts that need to be present at kitting on a GUI 421f as exemplarily illustrated in FIG. 14F. The mobile application allows the user to mark the parts kitted via the GUI 421f. On viewing the list of parts that need to be present at kitting on the GUI 421f, the user proceeds to scan all the parts for the machine asset or module. The mobile application marks all parts as red initially and turns the parts to green when the tags corresponding to the parts in the list are scanned, thereby marking the parts as kitted. The mobile application, therefore, allows the user to review the missing parts and click on each missing part to view the status or history of the missing part from a single GUI 421f.

To execute tag deactivation, the parts that are being assembled into a module or a machine asset follow a process of physical removal of their corresponding tags. In an embodiment, the tags are collected in a location and scanned together to mark all of them as assembled, deactivated, or delinked on a GUI 421g rendered by the mobile application as exemplarily illustrated in FIG. 14G. In another embodiment, the tags are scanned one by one as the corresponding parts are assembled to mark the parts as assembled, deactivated, or delinked on the GUI 421g. In an embodiment, the mobile application allows a user to search or query parts information via a GUI 421h as exemplarily illustrated in FIG. 14H. The mobile terminal allows the user to scan the tag on any part or parts to view the complete information of the parts available in the operations tracking system. The mobile application allows the user to click on a part from a list of scanned parts displayed on the GUI to view the complete history and status of each part.

FIGS. 15A-15M exemplarily illustrate screenshots of visibility dashboards 1501-1513 rendered by the operations management engine for conveying predictable and actionable insights of the analytics performed for optimizing management of operations associated with maintenance and/or production of a machine asset, according to an embodiment herein. The operations management engine generates and renders multiple visibility dashboards 1501-1513 for conveying predictable and actionable insights of the analytics performed for optimizing management of operations associated with maintenance and/or production of a machine asset. FIG. 15A exemplarily illustrates a visibility dashboard 1501 generated by the operations management engine for displaying status of a machine asset, for example, an aircraft engine, one machine asset at a time, at one of the stages or gates in the cycle of operations. The visibility dashboard 1501 exemplarily illustrated in FIG. 15A, displays the status of each machine asset at Gate 1 in the cycle of operations. The status of the machine asset comprises the number of pre-inspection cards tagged compared to the pre-inspection cards available by module. When a user clicks on each machine asset displayed on the visibility dashboard 1501 exemplarily illustrated in FIG. 15A, the operations management engine renders a visibility dashboard 1502 exemplarily illustrated in FIG. 15B, comprising a detailed status of the modules of the corresponding machine asset.

FIG. 15C exemplarily illustrates a visibility dashboard 1503 generated by the operations management engine for displaying status of a machine asset, for example, an aircraft engine, at Gate 2 in the cycle of operations. The visibility dashboard 1503 exemplarily illustrated in FIG. 15C, displays the status of the machine asset based on the number of job cards and tasks versus percentage completion or what is completed by module and by the machine asset. When a user clicks on each machine asset displayed on the visibility dashboard 1503 exemplarily illustrated in FIG. 15C, the operations management engine renders a visibility dashboard 1504 exemplarily illustrated in FIG. 15D, comprising a detailed status of the modules of the corresponding machine asset by task.

FIG. 15E exemplarily illustrates a visibility dashboard 1505 generated by the operations management engine for displaying status of a machine asset, for example, an aircraft engine, at Gate 3 in the cycle of operations. The visibility dashboard 1505 exemplarily illustrated in. FIG. 15E, displays the status of the machine asset based on the pre-inspection card deactivated by module and by the machine asset. FIG. 15F exemplarily illustrates a visibility dashboard 1506 generated by the operations management engine for displaying performance of each department in the cycle of operations with respect to ontime processing, delayed processing by period, for example, weekly, monthly, etc., and by the machine asset. The visibility dashboard 1506 exemplarily illustrated in FIG. 15F, displays the task deviation against the departments. FIG. 15G exemplarily illustrates a visibility dashboard 1507 generated by the operations management engine for displaying kitting readiness in the cycle of operations similar to Gate 3, along with external repair order status and new issues from stores to indicate completion percentage. FIG. 15H exemplarily illustrates a visibility dashboard 1508 generated by the operations management engine for distribution of the parts of the machine asset by department and by engine. FIG. 15I exemplarily illustrates a visibility dashboard 1509 generated by the operations management engine for displaying activities of each department, for example, the number of cards processed in last 24 hours, the number of cards not yet started and delayed, number of cards delayed after starting, etc. The visibility dashboard 1509 exemplarily illustrated in FIG. 15I, displays the task delay versus the department.

FIGS. 15J-15K exemplarily illustrate visibility dashboards 1510 and 1511 respectively, generated by the operations management engine for rendering a cumulative visualization for yearly maintenance data and labor hours. FIG. 15L exemplarily illustrates a visibility dashboard 1512 generated by the operations management engine for rendering a statistical classification of the cumulative person-hour spread task-wise. FIG. 15M exemplarily illustrates a visibility dashboard 1513 generated by the operations management engine for rendering a statistical classification of the cumulative person-hour spread module-wise.

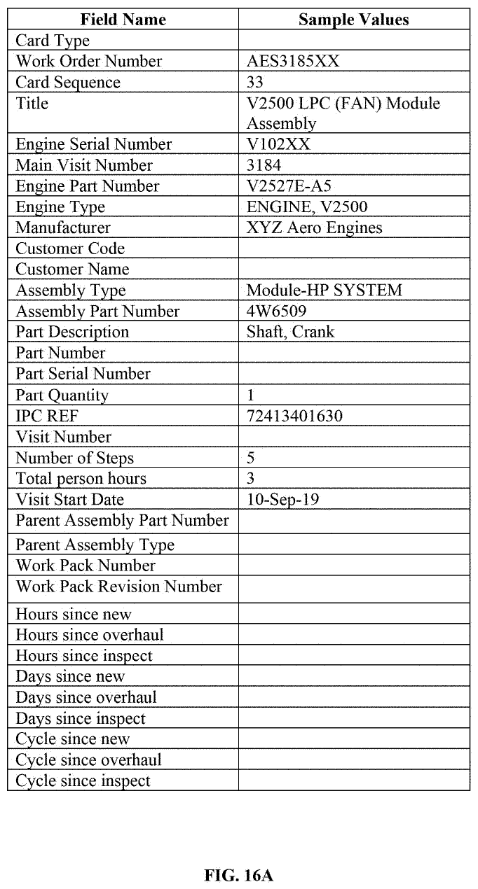

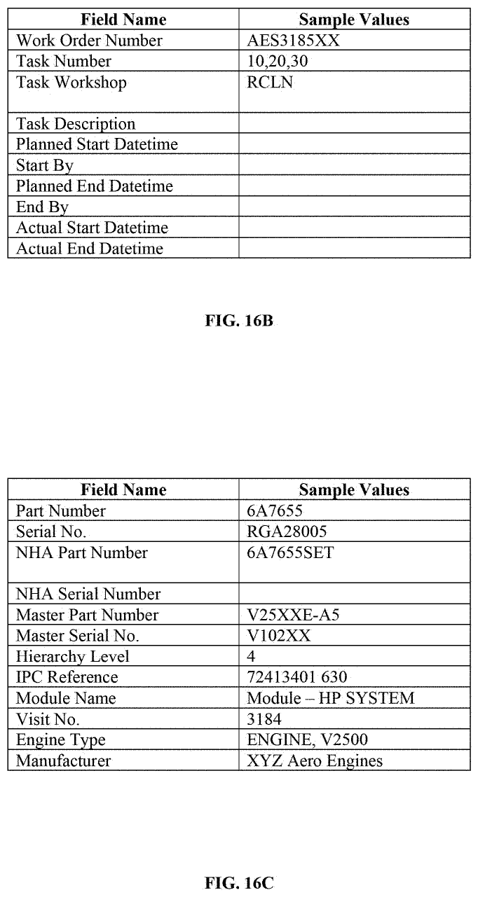

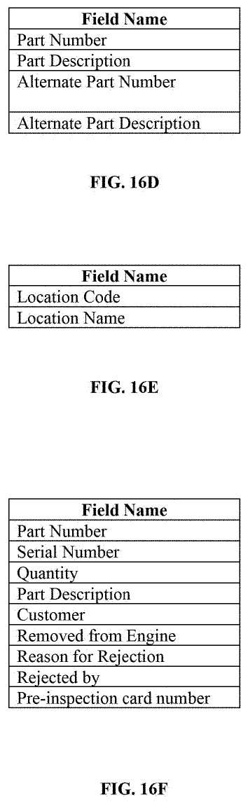

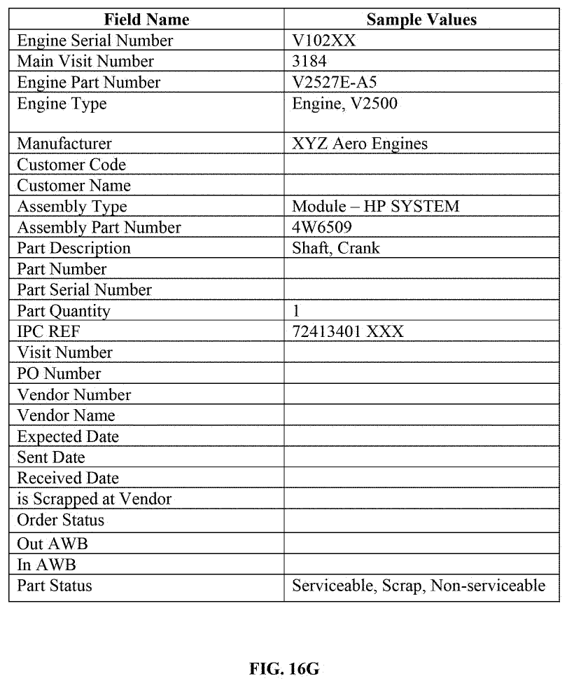

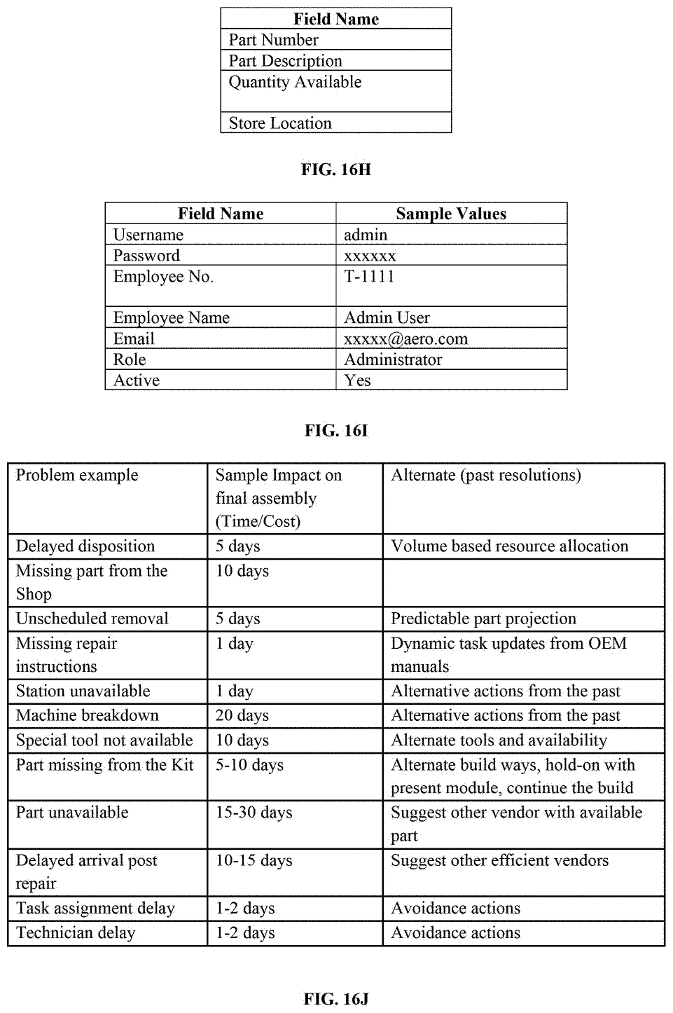

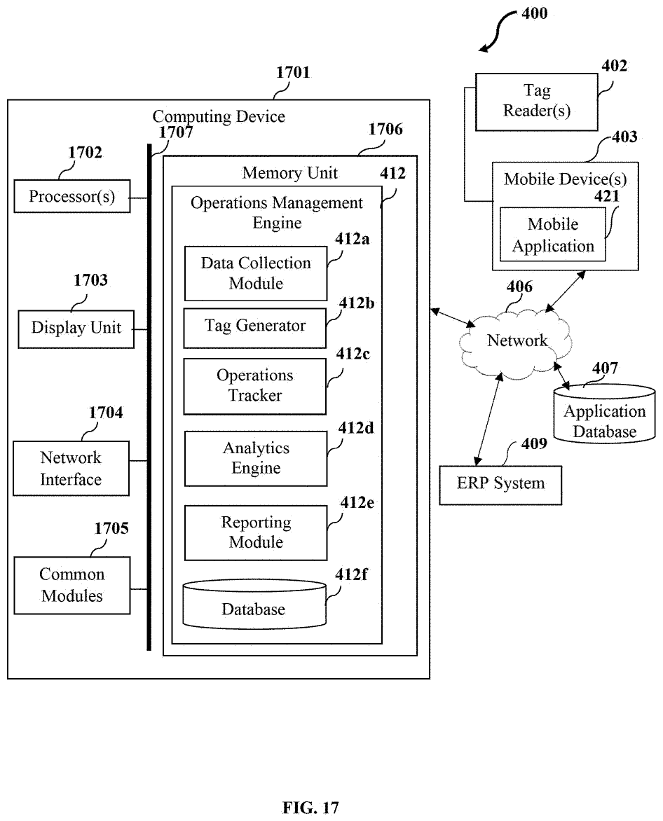

FIG. 16A-16I exemplarily illustrate tabular representations of data imported and processed by the operations management engine, in communication with a customer enterprise resource planning (ERP) system, according to an embodiment herein. The tracking application server of the operations tracking system communicates with the customer ERP system for receiving various data sets. For example, the tracking application server receives information of job cards comprising task-related details created against a visit number as illustrated in FIG. 16A, from the ERP system, and stores the information of the job cards in the application database for retrieval and generation of reports. The job cards comprise information of all types of jobs, for example, routine, non-routine, repair order, scrap order, etc. The determination of job cards and the tasks in the job card, is part of the initial loading of the work scope and choosing of a maintenance template. Additional tasks can be loaded ad-hoc based on additional findings during the repair or inspection process. In another example, the tracking application server receives task details against job cards as illustrated in FIG. 16B, from the ERP system, and stores the task details in the application database for retrieval and generation of reports. In another example, the tracking application server receives unit configuration information by serial number as illustrated in FIG. 16C, from the ERP system, and stores the unit configuration information in the application database for retrieval and generation of reports. In another example, the tracking application server receives parts details by part number as illustrated in FIG. 16D, from the ERP system, and stores the parts details in the application database for retrieval and generation of reports In another example, the tracking, application server receives a list of locations/departments defined in the ERP system as illustrated in FIG. 16E and stores the list of locations/departments in the application database for retrieval and generation of reports. In another example, the tracking application server receives information on scrap items as illustrated in FIG. 16F and stores the information on the scrap items in the application database for retrieval and generation of reports. In another example, the tracking application server receives external repair order (RO) details and status based on the part number or the serial number as illustrated in FIG. 16G, and stores the external RO details in the application database for retrieval and generation of reports. In another example, the tracking application server receives inventory information against a part number as illustrated in FIG. 16H and stores the inventory information in the application database for retrieval and generation of reports. In another example, the tracking application server communicates with the ERP system for receiving user information as illustrated in FIG. 16I, for logging into the operations tracking system.

FIG. 16J exemplarily illustrates a tabular representation of data processed by the AI & ML engine of the operations management engine, according to an embodiment herein. In an embodiment, the AI & ML engine is configured as an AI & ML-based business management module that extracts analysis data from the shop module, the stores module, the service-level agreement (SLA)/key performance indicator (KM) module, and the cost module to form correlations and carry out impact calculations from past actions as illustrated in FIG. 6J. The AI & ML engine performs a data-based analysis of each module and part of the machine asset that is processed, utilization of resources for tasks, and analysis of patterns and deviation if any. The AI & ML engine receives data about part state, repair done on the part, and movement of the part between various repair shops from the shop module. The AI & ML engine receives a quantification on what is spent in direct labor hours, repairs, materials, consumables as well as indirect costs such as costs related to administration, sales, marketing, other overheads, facility maintenance, etc., related to facility from the cost module. The AI & ML engine also receives performance data of a particular shop, for example, what part and work were assigned to the shop, how much time was taken by the shop to perform the activities, when the part moved out of the shop after repair, etc., from the SLA/KPI module. The AI & ML engine also receives information about what part and material were ordered for a particular machine asset repair, what parts went out for specialized repairs, etc., from the stores module. The stores module keeps track of all material transactions, for example, in terms of material ordered/received. Consider an example where an aircraft engine coming from an operator ‘X’ operating “A320” in “Short Haul/short flight leg” in the “Middle East” region having done “8000-1000 cycles” undergoes a similar deterioration trend due to high temp/desert climate. The analysis data received by the AI & ML engine is the raw data received from the shops related, for example, to repairs done, materials used, cost from material, and time involved. The AI & ML engine correlates this analysis data to the total cost of repair, which also impacts the final cost of repair. The AI & ML engine collects the analysis data from past machine assets already processed and uses the analysis data to create a model to predict the costs of the next machine asset. The AI & ML engine executes AI & ML-based algorithms that receive multiple parameters as input to identify patterns that contribute to certain action or repairs or scrapping of parts. The AI & ML-based algorithm predicts the cost based on an incoming machine asset's initial condition and based on past machine asset's repair history. The AI & ML engine executes AI & ML-based algorithms for predicting time and cost required to process an incoming machine asset based on time and cost that was required to process previous machine assets.

FIG. 17 illustrates an architectural block diagram of an exemplary implementation of the system 400 for optimizing management of operations associated with maintenance and/or production of a machine asset, according to an embodiment herein. In an embodiment, the operations management engine 412 is deployed in a computing device 1701 as exemplarily illustrated in FIG. 17. The computing device 1701 is a computer system programmable using high-level computer programming languages. The computing device 1701 is an electronic device, for example, one or more of a personal computer a tablet computing device, a mobile computer, a portable computing device, a laptop, a workstation, a server, a portable electronic device, a network enabled computing device, an interactive network enabled communication device, any other suitable computing equipment, combinations of multiple pieces of computing equipment, etc. In an exemplary implementation of the system 400 disclosed herein, the computing device 1701 is configured as the tracking application server 408 exemplarily illustrated in FIGS. 4-5. In an embodiment, the operations management engine 412 is implemented in the computing device 1701 using programmed and purposeful hardware. In an embodiment, the operations management engine 412 is a computer-embeddable system that optimizes management of operations associated with maintenance and/or production of a machine asset.

The operations management engine 412 in the computing device 1701 communicates with multiple devices, servers, and subsystems, for example, the tag readers 402, the application database 407, the wireless communication-enabled mobile device(s) 403, and the enterprise resource planning (ERP) system 409 via the network 406, for example, a short-range network or a long-range network. The network 406 is, for example, one of the internet, an intranet, a wired network, a wireless network, a communication network that implements Bluetooth® of Bluetooth Sig, Inc., a network that implements Wi-Fi® of Wi-Fi Alliance Corporation, an ultra-wideband (UWB) communication network, a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internee connection network, an infrared communication network, etc., or a network formed from any combination of these networks. In another embodiment, the operations management engine 412 is implemented in a cloud computing environment. As used herein, “cloud computing environment” refers to a processing environment comprising configurable computing physical and logical resources, for example, networks, servers, storage media, virtual machines, applications, services, etc., and data distributed over the network 406. The cloud computing environment provides an on-demand network access to a shared pool of the configurable computing physical and logical resources. In an embodiment, the operations management engine 412 is a cloud computing-based platform implemented as a service for optimizing management of operations associated with maintenance and/or production of a machine asset. In another embodiment, the operations management engine 412 is implemented as an on-premise platform comprising on-premise software installed and run on client systems on the premises of a facility, for example, a maintenance, repair, and overhaul (MRO) facility.

As illustrated in FIG. 17. the computing device 1701 comprises a non-transitory, computer-readable storage medium, for example, a memory unit 1706 for storing computer program instructions defined by modules, for example, 412a, 412b, 412c, 412d, 412e, etc., of the operations management engine 412. As used herein, “non-transitory, computer-readable storage medium” refers to all computer-readable media that contain and store computer programs and data. Examples of the computer-readable media comprise hard drives, solid state drives, optical discs or magnetic disks, memory chips, a read-only memory (ROM), a register memory, a processor cache, a random-access memory (RAM), etc. The computing device 1701 further comprises at least one processor 1702 operably and communicatively coupled to the memory unit 1706 for executing the computer program instructions defined by the modules, for example, 412a, 412b, 412c, 412d, 412e, etc., of the operations management engine 412. In an embodiment, the processor(s) 1702 is in operable communication with the tag readers 402 and other devices, servers, and subsystems of the system 400. The memory unit 1706 is used for storing program instructions, applications, and data. In an embodiment, the memory unit 1706 is a random-access memory (RAM) or another type of dynamic storage device that stores information and instructions for execution by the processor 1702. The memory unit 1706 also stores temporary variables and other intermediate information used during execution of the instructions by the processor 1702. In an embodiment, the computing device 1701 further comprises a read only memory (ROM) or other types of static storage devices that store static information and instructions for execution by the processor 1702. In an embodiment, the modules, for example, 412a, 412b, 412c, 412d, 412e, 412f, etc., of the operations management engine 412 are stored in the memory unit 1706.

The processor(s) 1702 is configured to execute the computer program instructions defined by the modules, for example, 412a, 412b, 412c, 412d, 412e, etc., of the operations management engine 412 for optimizing management of operations associated with maintenance and/or production of a machine asset. The modules, for example, 412a, 412b, 412c, 412d, 412e, etc., of the operations management engine 412, when loaded into the memory unit 1706 and executed by the processor 1702, transform the computing device 1701 into a specially-programmed, special purpose computing device configured to implement the functionality disclosed herein. The processor 1702 refers to any one or more microprocessors, central processing unit (CPU) devices, finite state machines, computers, microcontrollers, digital signal processors, logic, a logic device, an application specific integrated circuit (ASIC), a field-programmable gate array (FPGA), a chip, etc., or any combination thereof, capable of executing computer programs or a series of commands, instructions, or state hansitions. In an embodiment, the processor 1702 is implemented as a processor set comprising, for example, a programmed microprocessor and a math or graphics co-processor. The operations management engine 412 is not limited to employing the processor 1702. In an embodiment, the operations management engine 412 employs a controller or a microcontroller. The processor 1702 executes the modules, for example, 412a, 412b, 412c, 412d, 412e, etc., of the operations management engine 412. In another embodiment, multiple processors are implemented at different stages in the cycle of maintenance and/or production operations for executing the modules, for example, 412a, 412b, 412c, 412d, 412e, etc., of the operations management engine 412.

As illustrated in FIG. 17, the computing device 1701 further comprises a data bus 1707, a display unit 1703, a network interface 1704, and common modules 1705. The data bus 1707 permits communications between the modules, for example, 1702, 1703, 1704, 1705, and 1706 of the computing device 1701. The display unit 1703, via graphical user interfaces (GUIs), displays information, images, display interfaces, user interface elements such as checkboxes, input text fields, etc., for example, for allowing a user to enter user profile information for creation of users, define permissions, access parts information, pending task information, machine asset status information, etc., for allowing the user to customize information to be displayed in reports. The display unit 1703, via the GUIs, also displays the analytics reports generated by the operations management engine 412. The GUIs comprise, for example, online web interfaces, web-based downloadable application interfaces, mobile-based downloadable application interfaces, etc.

The network interface 1704 enables connection of the computing device 1701 to the network 406. In an embodiment, the network interface 1704 is provided as an interface card also referred to as a line card. The network interface 1704 is, for example, one or more of infrared interfaces, interfaces implementing Wi-Fi® of Wi-Fi Alliance Corporation, universal serial bus interfaces, FireWire® interfaces of Apple Inc., Ethernet interfaces, frame relay interfaces, cable interfaces, digital subscriber line interfaces, token ring interfaces, peripheral controller interconnect interfaces, local area network interfaces, wide area network interfaces, interfaces using serial protocols, interfaces using parallel protocols, Ethernet communication interfaces, asynchronous transfer mode interfaces, high speed serial interfaces, fiber distributed data interfaces, interfaces based on transmission control protocol (TCP)/internet protocol (IP), interfaces based on wireless communications technology such as satellite technology, radio frequency technology, near field communication, etc. The common modules 1705 of the computing device 1701 comprise, for example, input/output (I/O) controllers, input devices, output devices, fixed media drives such as hard drives, removable media drives for receiving removable media, etc. Computer applications and programs are used for operating the computing device 1701. The programs are loaded onto fixed media drives and into the memory unit 1706 via the removable media drives. In an embodiment, the computer applications and programs are loaded into the memory unit 1706 directly via the network 406.

In an exemplary implementation of the system 400 illustrated in FIG. 17, the operations management engine 412 comprises a data collection module 412a, a tag generator 412b, an operations tracker 412c, an analytics engine 412d, a reporting module 412e, and optionally a database 412f, stored in the memory unit 1706 and executed by the processor 1702 in the computing device 1701. The data collection module 412a receives work scope information comprising parts information of one or more of multiple parts of the machine asset in a work order from multiple data sources, for example, original equipment manufacturer (OEM) manuals, templates, checklists, enterprise resource planning (ERP) systems, documentation, and user definitions and configurations entered via the GUIs rendered by the operations management engine 412 on the wireless communication-enabled mobile device 403. In an embodiment, the data collection module 412a stores the work scope information and other information received from the ERP system 409 in the database 412f. Each of the parts is linked to an order identifier of the work order. The tag generator 412b generates a reusable tag, for example, a radio-frequency identification (RFID) tag or a Bluetooth low energy (BLE) tag, linked to the order identifier for each part defined in the work scope information and assigns the reusable tag to each part. The operations tracker 412c, in communication with one or more of the tag readers 402, dynamically tracks each of the parts, tasks performed on each part, and turnaround time through each of the stages of the cycle of operations in real time using the corresponding reusable tag linked to the order identifier and the work scope information, and generates operational data therefrom. The operational data comprises, for example, a status of each part, type of tasks and operations performed, time of initiation and completion of the tasks, task execution time, person-hours, part history information, part induction information, part movement information, transactional information, machine asset data, schedules, plans, and audit logs. In an embodiment, the operations tracker 412c stores the operational data in the database 412f.

The analytics engine 412d performs analytics on the operational data associated with each of the parts using artificial intelligence. In an embodiment, the analytics engine 412d is configured as an artificial intelligence (AI) & machine learning (ML) engine 417 for performing analytics on the operational data as disclosed in the detailed description of FIG. 5 and FIGS. 6A-6B. In an embodiment, in performing the analytics on the operational data associated with each part, the analytics engine 412d calculates shop operational efficiency and shop profitability based on induction type using spend data extracted from the application database 407 as disclosed in the detailed descriptions of FIG. 5 and FIGS. 6A-6B. In another embodiment, in performing the analytics on the operational data associated with each part, the analytics engine 412d forecasts projections of multiple operational elements and generates predictable and actionable insights for each of the operational elements using artificial intelligence as disclosed in the detailed descriptions of FIG. 5 and FIGS. 6A-6B. The operational elements comprise, for example: (a) requirements for the parts; (b) productivity savings; (c) completion time; (d) work scope; (e) machine asset performance; and (f) prescriptive cost impact. In another embodiment, in performing the analytics on the operational data associated with each part, the analytics engine 412d forecasts exhaust gas temperature gain for any incoming machine asset as disclosed in the detailed descriptions of FIG. 5 and FIGS. 6A-6B.

The reporting module 412e dynamically generates and renders one or more analytics reports accessible through one or more of multiple visualization components across the cycle of operations to convey predictable and actionable insights of the analytics for optimizing the management of the operations with enhanced visibility as illustrated in FIGS. 12A-12J and FIGS. 15A-I5M. The visualization components comprise, for example, real-time dashboards and notifications. One or more of the analytics reports accessible through the visualization components comprise at least one of: (a) parts and tag information by date and user for the machine asset by a machine identifier; (b) a task status summary and estimated dates of completion per assembly, per sub-assembly, and per work order of the machine asset by the machine identifier; (c) transactions on each part by a part identifier; (d) a department-wise summary of transactions and completion of the work order within specified dates; (e) number of person-hours and work orders processed by department within specified dates and specific visits; (f) machine asset status configured to indicate a number of pre-inspection cards tagged compared to pre-inspection cards available by module; (g) machine asset status based on a number of job cards and tasks versus percentage completion by module and by the machine asset; (h) machine asset status based on a pre-inspection card deactivated by module and by the machine asset; (i) ontime processing and delayed processing by period and by the machine asset; (j) external repair order status and new issues from stores to indicate completion percentage: (k) parts distribution by department and by the machine asset; (l) number of job cards processed and deployed across predefined planned time intervals; (m) yearly maintenance and/or production data and labor hours; and (n) statistical classification of a cumulative person-hour spread task-wise and part-wise. In an embodiment, the tag generator 412b, in communication with the mobile application 421 deployed on the wireless communication-enabled mobile device 403, deactivates the reusable tag of each part indicating a completion of the cycle of operations. In an embodiment, the operations tracker 412c monitors and renders status of the operations and status of the tag readers 402 to resolve outages, delays, and bottlenecks in the system 400.

In an embodiment, the operations tracker 412c facilitates transfer of the parts between the stages in the cycle of operations in accordance with a list of the tasks defined in job cards and updates locations of the parts during the transfer between the stages in the application database 407. In an embodiment, the operations tracker 412c tracks movement of multiple parts comprising incoming parts and outgoing parts in stores and determines requirements and availability of the parts. In an embodiment, the operations tracker 412c determines and renders pending tasks across the cycle of operations; (b) renders a list of parts required for the operations; and (c) systematically renders the work scope information, on the wireless communication-enabled mobile device 403. The processor 1702 retrieves instructions defined by the data collection module 412a, the tag generator 412b, the operations tracker 412c, the analytics engine 412d, and the reporting module 412e of the operations management engine 412 from the memory unit 1706 for performing respective functions disclosed above.

The data collection module 412a, the tag generator 412b, the operations tracker 412c, the analytics engine 412d, and the reporting module 412e of the operations management engine 412 are disclosed above as software executed by the processor 1702. In an embodiment, the modules, for example, 412a, 412b, 412c, 412d, 412e, etc., of the operations management engine 412 are implemented completely in hardware. En another embodiment, the modules, for example, 412a, 412b, 412c, 412d, 412e, etc., of the operations management engine 412 are implemented by logic circuits to carry out their respective functions disclosed above. In another embodiment, the operations management engine 412 is also implemented as a combination of hardware and software and one or more processors, for example, 1702, that are used to implement the modules, for example, 412a, 412b, 412c, 412d, 412e, etc., of the operations management engine 412.

For purposes of illustration, the detailed description refers to the modules, for example, 412a, 412b, 412c, 412d, 412e, 412f, etc., of the operations management engine 412 being run locally on a single computing device 1701; however the scope of the system 400 and the method disclosed herein is not limited to the modules, for example, 412a, 412b, 412c, 412d, 412e, 412f, etc., of the operations management engine 412 being run locally on a single computing device 1701 via the operating system and the processor 1702, but may be extended to run remotely over the network 406 by employing a web browser and a remote server, a mobile phone, or other electronic devices. In an embodiment, one or more portions of the system 400 disclosed herein are distributed across one or more computer systems (not shown) coupled to the network 406.

The non-transitory, computer-readable storage medium disclosed herein stores computer program instructions executable by the processor 1702 for optimizing management of operations associated with maintenance and/or production of a machine asset. The computer program instructions implement the processes of various embodiments disclosed above and perform additional steps that may be required and contemplated for optimizing management of operations associated with maintenance and/or production of a machine asset. When the computer program instructions are executed by the processor 1702, the computer program instructions cause the processor 1702 to perform the steps of the method for optimizing management of operations associated with maintenance and/or production of a machine asset as disclosed in the detailed descriptions of FIGS. 1-16J. In an embodiment, a single piece of computer program code comprising computer program instructions performs one or more steps of the method disclosed in the detailed descriptions of FIGS. 1-16J. The processor 1702 retrieves these computer program instructions and executes them.

A module, or an engine, or a unit, as used herein, refers to any combination of hardware, software, and/or firmware. As an example, a module, or an engine, or a unit includes hardware, such as a microcontroller, associated with a non-transitory, computer-readable storage medium to store computer program codes adapted to be executed by the microcontroller. Therefore, references to a module, or an engine, or a unit, in an embodiment, refer to the hardware that is specifically configured to recognize and/or execute the computer program codes to be held on a non-transitory, computer-readable storage medium. In an embodiment, the computer program codes comprising computer readable and executable instructions are implemented in any programming language, for example, C, C++, C #, Java®, JavaScript®, Fortran, Ruby, Perl®, Python®, Visual Basic®, hypertext preprocessor (PHP), Microsoft® .NET, Objective-C®, etc. In another embodiment, other object-oriented, functional, scripting, and/or logical programming languages are also used. In an embodiment, the computer program codes or software programs are stored on or in one or more mediums as object code. In another embodiment, the term “module” or “engine” or “unit” refers to the combination of the microcontroller and the non-transitory, computer-readable storage medium. Often module or engine or unit boundaries that are illustrated as separate commonly vary and potentially overlap. For example, a module or an engine or a unit may share hardware, software, firmware, or a combination thereof, while potentially retaining some independent hardware, software, or firmware. In various embodiments, a module or an engine or a unit includes any suitable logic.

In an embodiment, the system disclosed herein is configured as a proactive management reporting system. The system disclosed herein integrates between data, devices, subsystems, users, and processes. The system disclosed herein enhances capacity of maintenance and production operations through improved utilization. The system disclosed herein executes aggregate part movement through alerts and triggers; facilitates reduction in shop floor daily review time; improves operating margins based on average turnaround times; facilitates person-hour savings on tasks and parts movement; provides access of operational data and reports to every user in the value-chain; generates dashboard reports for viewing progress of job cards in the facility; provides advance information on parts for a job to a parts kitting team; aligns operational efficiency with changing job:requirements; executes improved planning with accurate, reliable, real-time data; optimizes resource management and scheduling; builds coherence in complex shop floor operations; and provides access to availability and stock levels of critical and expensive spare parts.

It is apparent in different embodiments that the various methods, algorithms, and computer-readable programs disclosed herein are implemented on non-transitory, computer-readable storage media appropriately programmed for computing devices. The non-transitory, computer-readable storage media participate in providing data, for example, instructions that are read by a computer, a processor, or a similar device. In different embodiments, the “non-transitory, computer-readable storage media” also refer to a single medium or multiple media, for example, a centralized database, a distributed database, and/or associated caches and servers that store one or more sets of instructions that are read by a computer, a processor, or a similar device. The “non-transitory, computer-readable storage media” also refer to any medium capable of storing or encoding a set of instructions for execution by a computer, a processor, or a similar device and that causes a computer, a processor, or a similar device to perform any one or more of the steps of the methods disclosed herein. In an embodiment, the computer programs that implement the methods and algorithms disclosed herein are stored and transmitted using a variety of media, for example, the computer-readable media in various manners. In an embodiment, hard-wired circuitry or custom hardware is used in place of, or in combination with, software instructions for implementing the processes of various embodiments. Therefore, the embodiments are not limited to any specific combination of hardware and software. In another embodiment, various aspects of the embodiments disclosed herein are implemented in a non-programmed environment comprising documents created, for example, in a hypertext markup language (HTML), an extensible markup language (XML), or other format that render aspects of a GUI or perform other functions, when viewed in a visual area or a window of a browser program. Various aspects of the embodiments disclosed herein are implemented as programmed elements, or non-programmed elements, or any suitable combination thereof.

Where databases are described such as the application database 407 and the enterprise resource planning (ERP) database 410c illustrated in FIGS. 4-5, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. In an embodiment, object methods or behaviors of a database are used to implement various processes such as those disclosed herein, In another embodiment, the databases are, in a known manner, stored locally or remotely from a device that accesses data in such a database. In embodiments where there are multiple databases, the databases are integrated to communicate with each other for enabling simultaneous updates of data linked across the databases, when there are any updates to the data in one of the databases.

The embodiments disclosed herein are configured to operate in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors that are adapted to communicate with the computers. In an embodiment, each of the computers is equipped with a network communication device, for example, a network interface card, a modem, or other network connection device suitable for connecting to a network. Each of the computers and the devices executes an operating system. While the operating system may differ depending on the type of computer, the operating system provides the appropriate communications protocols to establish communication links with the network. Any number and type of machines may be in communication with the computers. The embodiments disclosed herein are not limited to a particular computer system platform, processor, operating system, or network.

The foregoing examples and illustrative implementations of various embodiments have been provided merely for explanation and are in no way to be construed as limiting of the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be executed and changes may be made thereto, without departing from the scope and spirit of the embodiments disclosed herein.

What is claimed is:

1. A system for optimizing management of operations associated with maintenance and/or production of a machine asset; the system comprising:
a plurality of tag readers operable at a plurality of stages defined in a cycle of the operations associated with the maintenance and/or the production of the machine asset;
at least one processor in operable communication with the tag readers;
a non-transitory, computer-readable storage medium operably and communicatively coupled to the at least one processor and configured to store computer program instructions executable by the at least one processor; and
an operations management engine configured to define the computer program instructions, which when executed by the at least one processor, cause the at least one processor to:
receive work scope information comprising parts information of one or more of a plurality of parts of the machine asset in a work order from a plurality of data sources, wherein each of the one or more of the parts is linked to an order identifier of the work order;
generate a reusable tag linked to the order identifier for each of the one or more of the parts defined in the work scope information and assign the reusable tag to the each of the one or more of the parts;
dynamically track, in communication with one or more of the tag readers, the each of the one or more of the parts, tasks performed on the each of the one or more of the parts, and turnaround time through each of the stages of the cycle of the operations in real time using the corresponding reusable tag linked to the order identifier and the work scope information, and generate operational data therefrom;
perform analytics on the operational data associated with the each of the one or more of the parts using artificial intelligence; and
dynamically generate and render one or more analytics reports accessible through one or more of a plurality of visualization components across the cycle of the operations to convey predictable and actionable insights of the analytics for optimizing the management of the operations with enhanced visibility.

2. The system of claim 1, wherein the reusable tag is one of a radio-frequency identification tag and a wireless beacon tag, free of the work scope information.

3. The system of claim 1, wherein one or more of the computer program instructions, which when executed by the at least one processor, further cause the at least one processor to deactivate the reusable tag of the each of the parts indicating a completion of the cycle of the operations, in communication with a client application deployed on a computing device, wherein the computing device is operably coupled to the tag readers.

4. The system of claim 1, wherein the operational data comprises a status of the each of the one or more of the parts, type of tasks and operations performed, time of initiation and completion of the tasks, task execution time, person-hours, part history information, part induction information, part movement information, transactional information, machine asset data, schedules, plans, and audit logs.

5. The system of claim 1, wherein one or more of the computer program instructions, which when executed by the at least one processor, further cause the at least one processor to monitor and render status of the operations and status of the tag readers to resolve outages, delays, and bottlenecks in the system.

6. The system of claim 1, wherein one or more of the computer program instructions, which when executed by the at least one processor, further cause the at least one processor to facilitate transfer of the parts between the stages in the cycle of the operations in accordance with a list of the tasks defined in job cards and update locations of the parts during the transfer between the stages in at least one database operably coupled to the operations management engine.

7. The system of claim 1, wherein the visualization components comprise real-time dashboards and notifications, and wherein one or more of the analytics reports accessible through the visualization components comprise at least one of:
(a) parts and tag information by date and user for the machine asset by a machine identifier;
(b) a task status summary and estimated dates of completion per assembly, per sub-assembly, and per work order of the machine asset by the machine identifier;
(c) transactions on the each of the one or more of the parts by a part identifier;
(d) a department-wise summary of transactions and completion of the work order within specified dates;
(e) number of person-hours and work orders processed by department within specified dates and specific visits;
(f) machine asset status configured to indicate a number of pre-inspection cards tagged compared to pre-inspection cards available by module;
(g) machine asset status based on a number of job cards and tasks versus percentage completion by module and by the machine asset;
(h) machine asset status based on a pre-inspection card deactivated by module and by the machine asset;
(i) ontime processing and delayed processing by period and by the machine asset;
(j) external repair order status and, new issues from stores to indicate completion percentage;
(k) parts distribution by department and by the machine asset;
(l) number of job cards processed and deployed across predefined planned time intervals;
(m) yearly maintenance and/or production data and labor hours; and
(n) statistical classification of a cumulative person-hour spread task-wise and part-wise.

8. The system of claim 1, wherein one or more of the computer program instructions, which when executed by the at least one processor, further cause the at least one processor to track movement of the plurality of parts comprising incoming parts and outgoing parts in stores and determine requirements and availability of the parts.

9. The system of claim 1, wherein, in performing the analytics on the operational data associated with the each of the one or more of the parts, one or more of the computer program instructions, which when executed by the at least one processor, cause the at least one processor to calculate shop operational efficiency and shop profitability based on induction type using spend data extracted from a database operably coupled to the operations management engine.

10. The system of claim 1, wherein, in performing the analytics on the operational data associated with the each of the one or more of the parts, one or more of the computer program instructions, which when executed by the at least one processor, cause the at least one processor to forecast projections of a plurality of operational elements and generate predictable and actionable insights for each of the operational elements using artificial intelligence, wherein the operational elements comprise (a) requirements for the parts; (b) productivity savings; (c) completion time; (d) work scope; (e) machine asset performance; and (f) prescriptive cost impact.

11. The system of claim 1, wherein, in performing the analytics on the operational data associated with the each of the one or more of the parts, one or more of the computer program instructions, which when executed by the at least one processor, cause the at least one processor to forecast exhaust gas temperature gain for any incoming machine asset.

12. The system of claim 1, wherein one or more of the computer program instructions, which when executed by the at least one processor, further cause the at least one processor to one of (a) determine and render pending tasks across the cycle of the operations; (b) render a list of parts required for the operations; and (c) systematically render the work scope information, on a computing device.

13. The system of claim 1, further comprising a client application deployed on a computing device and configured to operate with the operations management engine for executing one or more of a plurality of operations management functions, wherein the operations management functions comprise user authentication, generation and display of a list of tasks, tagging of the parts of the machine asset based on the work order, transfer of the parts between departments, indicating a start and an end of each of the tasks for scanned part tags, kitting verification, deactivation of each reusable tag, and querying of the parts, wherein the computing device is in operable communication with the tag readers.

14. The system of claim 1, further comprising a middleware application configured to operate with the operations management engine for executing one or more of a plurality of device management functions, wherein the device management functions comprise managing the tag readers, managing locations of the tag readers, managing locations of the parts of the machine asset, and monitoring a network status of each of the tag readers.

15. The system of claim 1, wherein the plurality of data sources comprises original equipment manufacturer manuals, templates, checklists, enterprise resource planning systems, documentation, and user definitions and configurations entered via graphical user interfaces rendered by the operations management engine on a computing device.

16. The system of claim 1, wherein the operations associated with the maintenance of the machine asset comprise maintenance planning, scheduling, induction, disassembly, cleaning, non-destructive testing, inspection, repair, specialized processing, parts ordering, parts receiving, kitting, re-assembling, testing, and shipping of the machine asset, and wherein the operations associated with the production of the machine asset comprise production planning, parts ordering, parts receiving, kitting, equipping and erection, testing, and shipping of the machine asset.

17. A method for optimizing management of operations associated with maintenance and/or production of a machine asset, the method comprising:
receiving, by an operations management engine, work scope information comprising parts information of one or more of a plurality of parts of the machine asset in a work order from a plurality of data sources, wherein each of the one or more of the parts is linked to an order identifier of the work order;
generating, by the operations management engine, a reusable tag linked to the order identifier for each of the one or more of the parts defined in the work scope information and assign the reusable tag to the each of the one or more of the parts;
dynamically tracking, by the operations management engine in communication with one or more of a plurality of tag readers, the each of the one or more of the parts, tasks performed on the each of the one or more of the parts, and turnaround time through each of a plurality of stages of a cycle of the operations associated with the maintenance and/or the production of the machine asset in real time using the corresponding reusable tag linked to the order identifier and the work scope information, and generating operational data therefrom;
performing analytics on the operational data associated with the each of the one or more of the parts by the operations management engine using artificial intelligence; and
dynamically generating and rendering one or more analytics reports accessible through one or more of a plurality of visualization components across the cycle of the operations by the operations management engine to convey predictable and actionable insights of the analytics for optimizing the management of the operations with enhanced visibility.

18. The method of claim 17, wherein the reusable tag is one of a radio-frequency identification tag and a wireless beacon tag, free of the work scope information.

19. The method of claim 17, further comprising deactivating the reusable tag of the each of the parts by the operations management engine, in communication with a client application deployed on a computing device, indicating a completion of the cycle of the operations, wherein the computing device is operably coupled to the tag readers.

20. The method of claim 17, wherein the operational data comprises a status of the each of the one or more of the parts, type of tasks and operations performed, time of initiation and completion of the tasks, task execution time, person-hours, part history information, part induction information, part movement information, transactional information, machine asset data, schedules, plans, and audit logs.

21. The method of claim 17, further comprising monitoring and rendering status of the operations and status of the tag readers by the operations management engine to resolve outages, delays, and bottlenecks in the system.

22. The method of claim 17, further comprising facilitating, by the operations management engine, transfer of the parts between the stages in the cycle of the operations in accordance with a list of the tasks defined in job cards and updating locations of the parts during the transfer between the stages in at least one database operably coupled to the operations management engine.

23. The method of claim 17, wherein the visualization components comprise real-time dashboards and notifications, and wherein one or more of the analytics reports accessible through the visualization components comprise at least one of:
(a) parts and tag information by date and user for the machine asset by a machine identifier;
(b) a task status summary and estimated dates of completion per assembly, per sub-assembly, and per work order of the machine asset by the machine identifier;
(c) transactions on the each of the one or more of the parts by a part identifier;
(d) a department-wise summary of transactions and completion of the work order within specified dates;
(e) number of person-hours and work orders processed by department within specified dates and specific visits;
(f) machine asset status configured to indicate a number of pre-inspection cards tagged compared to pre-inspection cards available by module;
(g) machine asset status based on a number of job cards and tasks versus percentage completion by module and by the machine asset;
(h) machine asset status based on a pre-inspection card deactivated by module and by the machine asset;
(i) ontime processing and delayed processing by period and by the machine asset;
(j) external repair order status and, new issues from stores to indicate completion percentage;
(k) parts distribution by department and by the machine asset;
(l) number of job cards processed and deployed across predefined planned time intervals;
(m) yearly maintenance and/or production data and labor hours; and
(n) statistical classification of a cumulative person-hour spread task-wise and part-wise.

24. The method of claim 17, further comprising tracking movement of the plurality of parts comprising incoming parts and outgoing parts in stores and determining requirements and availability of the parts by the operations management engine.

25. The method of claim 17, wherein the analytics on the operational data associated with the each of the one or more of the parts comprises calculating shop operational efficiency and shop profitability based on induction type using spend data extracted from a database operably coupled to the operations management engine.

26. The method of claim 17, wherein the analytics on the operational data associated with the each of the one or more of the parts comprises forecasting projections of a plurality of operational elements and generating predictable and actionable insights for each of the operational elements using artificial intelligence, wherein the operational elements comprise (a) requirements for the parts: (b) productivity savings; (c) completion time; (d) work scope; (e) machine asset performance; and (f) prescriptive cost impact.

27. The method of claim 17, wherein the analytics on the operational data associated with the each of the one or more of the parts comprises forecasting exhaust gas temperature gain for any incoming machine asset.

28. The method of claim 17, further comprising:
(a) determining and rendering pending tasks across the cycle of the operations by the operations management engine:
(b) rendering a list of parts required for the operations by the operations management engine; and
(c) systematically rendering the work scope information on a computing device by the operations management engine.

29. The method of claim 17, further comprising executing one or more of a plurality of operations management functions by a client application deployed on a computing device and configured to operate with the operations management engine, wherein the operations management functions comprise user authentication, generation and display of a list of tasks, tagging of the parts of the machine asset based on the work order, transfer of the parts between departments, indicating a start and an end of each of the tasks for scanned part tags, kitting verification, deactivation of each reusable tag, and querying of the parts, wherein the computing, device is in operable communication with the tag readers.

30. The method of claim 17, further comprising executing one or more of a plurality of device management functions by a middleware application configured to operate with the operations management, engine, wherein the device management functions comprise managing the tag readers, managing, locations of the tag readers, managing locations of the parts of the machine asset, and monitoring a network status of each of the tag readers.

31. The method of claim 17, wherein the plurality of data sources comprises original equipment manufacturer manuals, templates, checklists, enterprise resource planning systems, documentation, and user definitions and configurations entered via graphical user interfaces rendered by the operations management engine on a computing device.

32. The method of claim 17, wherein the operations associated with the maintenance of the machine asset comprise maintenance planning, scheduling, induction, disassembly, cleaning, non-destructive testing, inspection, repair, specialized processing, parts ordering, parts receiving, kitting, re-assembling, testing, and shipping of the machine asset, and wherein the operations associated with the production of the machine asset comprise production planning, parts ordering, parts receiving, kitting, equipping and erection, testing, and shipping of the machine asset.
